(19) United States
(12) Patent Application Publication
(10) Pub. No.: US 2006/0154642 A1
(43) Pub. Date: Jul. 13, 2006

(54) Medication & health, environmental, and security monitoring, alert, intervention, information and network system with associated and supporting apparatuses

(76) Inventor: Robert F. Scannell JR., Lebanon, NJ (US)

Correspondence Address: Kenneth P. Glynn, 24 Mine Street, Flemington, NJ, 08822, US

(21) Appl. No.: 11/218,948

(22) Filed: Sep. 2, 2005

Related U.S. Application Data
(63) Continuation-in-part of application No. 11/062,039, filed on Feb. 18, 2005.
(60) Provisional application No. 60/545,939, filed on Feb. 20, 2004.
(60) Provisional application No. 60/560,908, filed on Apr. 10, 2004.
(60) Provisional application No. 60/607,961, filed on Sep. 8, 2004.

(51) Int. Cl. H04M 11/04

(52) U.S. Cl. 455/404.1

(57) ABSTRACT

Systems and apparatuses include devices, biosensors, environmental sensors, security related sensors, networked products, communications processors and components, alert and information components, processors, and software to support: 1) facilitating medication regimen and patient/user health administration, dosage control, tracking, compliance, information inquiry and presentation, reminder and notification; 2) providing monitoring, information, ordering, and intervention; 3) presenting the option of leveraging the preventative care, alert and notification components with other components to facilitate user or occupant well being, along with living, work area and dwelling environmental or security safety; and 4) enhancing the dwelling, living or work area with products that may be networked to support the widespread acceptance of these systems and apparatuses. The systems include a) processing, centralizing and communicating device commands and/or programs, e.g. a multifunctional device controller; b) device administration; c) patient/user information; d) dwelling environmental safety; e) security breach information; f) centralized and remote apparatus and system activations through primary component or at least one backup.

### REFERENCES TO RELATED APPLICATIONS

This application is based on and claims priority on U.S. Provisional Patent Application No. 60/607,961, entitled, “Medication & health, environmental, and security monitoring, alert, intervention, information, network system” and filed on Sep. 8, 2004. This present application is a continuation-in-part of copending U.S. utility patent application by the same inventor herein filed on Feb. 18, 2005, entitled MULTIFUNCTION-ADAPTABLE, MULTICOMPONENT DEVICES, having an Attorney Docket No. RFS-105A and a Ser. No. of 11/062,039, claiming priority on U.S. Provisional Patent Application No. 60/545,939, entitled, “Lighting Fixture, Switch Assembly and Enclosure With Interconnecting, Interchangeable and Modular Components” and filed on Feb. 20, 2004. Further, this present application is also a continuation-in-part of copending U.S. utility patent application by the same inventor herein filed on Apr. 7, 2005, entitled MULTIFUNCTION-CAPABLE HEALTH RELATED DEVICES, having an Attorney Docket No. RFS-106C and a Ser. No. of 11/101,066, claiming priority on U.S. Provisional Patent Application No. 60/560,908, entitled, “Multi-utility fixtures, enclosures, pedestals, and bases with interchangeable, modular, integrated and/or networked components” and filed on Apr. 10, 2004.

### FIELD OF THE INVENTION

The present invention relates generally to the fields of medication administration, healthcare monitoring and intervention, and dwelling, environmental safety, security and networked apparatuses and systems. More particularly, it relates to at least one or more of the following: a) systems that may comprise wireless, wired (and)/or hosted communications monitoring and intervention components to facilitate preventative care and/or patient care while minimizing the costs for medical and/or healthcare personnel; b) systems that may leverage present invention preventative care, alert and notification components with other present invention embodiments to facilitate dwelling environmental safety and security; and c) apparatuses that support the preceding and user well being, convenience and safety to provide for widespread acceptance of the preceding. In addition, the present invention also relates to pricing methods, means and services to support said widespread acceptance of the innovations described herein and associated embodiments.

### INFORMATION DISCLOSURE STATEMENT

United States Patent Application Publication No. US 2005/0101841 A9 describes a healthcare network is provided for sharing information concerning the health of a user with at least one outside source, the network including a biosensor associated with the user that generates a biosensor signal containing the information; and a personal data control means including receiving means for receiving the biosensor signal, input means for receiving a privacy input from the user, and output means for generating a response signal based on the biosensor signal and privacy input. The network also includes a data allocation and processing module including means for receiving the response signal, and means for generating and directing an output signal to the at least one outside source, wherein the module is responsive to the response signal, and wherein the availability of the information to the at least one outside source is responsive to the privacy input.

United States Patent Application Publication No. US 2005/0002407 A1 describes a method and apparatus delivering voice/data services within a piconet operating over a limited range or over a WLAN communicating with 3GPP devices by reformatting data into IP format before delivering to the WLAN. The service is short message service (SMS). Upon receipt of an SMS message, relevant routing information is retrieved. A PDGW address for the SMS message is identified and is sent to the PDGW address which identifies the WLAN user equipment (UE) for receiving the SMS and reformats the SMS message into IP format (text or encapsulation) for delivering to the UE. A protocol architecture is provided for SMS delivery over WLANs, in particular, for UMTS/CDMA based SMS over WLAN through two alternative mechanisms, i.e., SMS tunneling and SMS proxy, for protocols for the delivery of SMS across the WLAN. The invention enhances standard 802.11 in the context of UMTS and CDMA 2000; as well as other scenarios.

United States Patent Application Publication No. US 2004/0235416 A1 describes an apparatus, and an associated method, for facilitating personalization of a weather band radio that receives SAME messages broadcast by the NWR system. Alphanumeric indicators of locations are displayed upon a user display element. And, a listener of the radio enters, by way of a user input actuator, selection of selected geographical areas, identified by the alphanumeric indicators. The selected alphanumeric location is used to form a six-digit location code defined by the Federal Information Processing Standards (FIPS). And, the code so-formed is used by the weather band radio, selectably to alert weather anomalies broadcast by the NWR system within the selected geographical area of interest.

United States Patent Application Publication No. US 2004/0181404 A1 describes this device uses a communication link to obtain audio weather information then uses a voice recognition means to convert the audio weather information into text, then converts this text information into display information. This device uses a means selecting means to evaluate the text and determine what text is to be displayed. This device uses a display to display weather information. This device displays weather information and, can play aloud the transmitted broadcast.

United States Patent Application Publication No. US 2004/0135699 A1 describes in accordance with embodiments of the present invention, a method for alerting a quiescent person, may include recording a personal alert message, receiving an alarm over a wireless communications link, and, in response to the alarm, playing the personal alert message. In accordance with other embodiments of the present invention, a device for alerting a quiescent person may include an audio input to record a personal alert message, a memory to store the personal alert message, an audio output to play the personal alert message, a wireless receiver to receive an alarm, a power supply and a processor, coupled to the audio input, the audio output, the memory, the wireless receiver and the power supply. The processor may be adaptively configured to receive an alert signal from the wireless receiver, and in response to the alert signal, send a play signal to play the personal alert message.

United States Patent Application Publication No. US 2004/0100376 A1 describes a wireless healthcare monitoring system and method are provided. At least one UWB biosensor transmitter is assigned to at least one individual to be remotely monitored. The biosensor transmitter includes a biosensor disposed to detect a health condition of a user and generate a corresponding biosensor reading. The reading is converted by the biosensor transmitter to an ultra wideband (UWB) biosensor signal transmitted by the biosensor transmitter. A UWB receiver disposed remote from and within range of the transmitter receives and converts the UWB biosensor signal to a signal containing information from the biosensor reading. A processor in communication with the UWB receiver processes and displays the converted signal as a readable output indicating a health condition of the user detected by the biosensor.

United States Patent Application Publication No. US 2004/0030531 A1 describes an automated system and method for monitoring and supporting and actor in an environment, such as a daily living environment. The system includes at least one sensor, at last one effector and a controller adapted to provide monitoring, situation assessment, response planning, and plan execution functions. In one preferred embodiment, the controller provides a layered architecture allowing multiple modules to interact and perform and desired monitoring and support functions.

United States Patent Application Publication No. US 2004/0003073 A1 describes a control server, or similar central processor, manages the distribution of data (including audio and video), voice, and control signals among a plurality of devices connected via a wired and/or wireless communications network. The devices include audio/visual devices (such as televisions, monitors, PDAs, notepads, notebooks, MP3, portable stereo, etc.) as well as household appliances (such as, lighting ovens, alarm clocks, etc.). The control server supports video/audio serving, telephony, messaging, file sharing, internetworking, and security. A portable controller allows a user to access and control the network devices from any location within a controlled residential and/or non-residential environment, including its surrounding areas. The controllers are enhanced to support location-awareness and user-awareness functionality.

United States Patent Application Publication No. US 2003/0179090 A1 describes environmental condition detector with audible alarm and voice identifier. Due to the presence of various environmental condition detectors in the home and business such as smoke detectors, carbon monoxide detectors, natural gas detectors, etc., each having individual but similar sounding alarm patterns, it can be difficult for occupants of such dwellings to immediately determine the specific type of environmental condition that exists during an alarm condition. The present invention comprises an environmental condition detector using both tonal pattern alarms and pre-recorded voice messages to indicate information about the environmental condition being sensed. Single-station battery-powered and 120 VAC detectors are described as are multiple-station interconnected 120 VAC powered detectors. The pre-recorded voice messages describe the type of environmental condition detected or the location of the environmental condition detector sensing the condition, or both, in addition to the tonal pattern alarm Provisions are made for multi-lingual pre-recorded voice messages.

United States Patent Application Publication No. US 2003/0098790 A1 describes an apparatus for the detection of enunciation of hazardous conditions within an environment comprises at least two detection circuits positioned to sense ambient conditions within a home or business environment. One of the detection circuits senses the presence of smoke, and the other detection circuit senses the presence of carbon monoxide. The apparatus also comprises an alarm circuit which is responsive to each of the detection circuits for generating at least one alarm pattern, and preferably a separate alarm pattern for each different sensed condition. A voice synthesizer circuit is also included, and is responsive to each of the detection circuits for generating at least one voice message. As with the alarm patterns, the voice synthesizer preferably generates separate voice messages for each separate detected condition. The apparatus advantageously also contains an interleaving control circuit. This interleaving control circuit interleaves the alarm patterns and voice messages in a predetermined sequence to reduce confusion in an emergency situation. A method for the detection and enunciation of multiple hazardous condition within an environment is also presented, and comprises the steps of: (a) sensing ambient conditions within the environment to detect at least two hazardous conditions; (b) generating an alarm pattern and a voice message in response to sensing the hazardous conditions; (c) interleaving the alarm pattern and the voice message; and (d) enunciating these interleaved alarm patterns and voice.

United States Patent Application Publication No. US 2003/0076369 A1 describes in a system and method for the display, or presentation, of electronic information in an ambient, or pre-attentive, form, a centralized server converts textual or quantitative data into a form suitable for remotely located non-textual ambient displays, or objects. The conversion, or translation, of the information occurs in response to a set of rules which may be fixed at the server, or otherwise modifiable by a user of the display, for example via Web-based interface, or at the display itself. The translated data, referred to herein as “ambient data” is in compressed, encoded form, so as to optimize the efficiency of its periodic transmission of such data to multiple remotely located recipient displays. In one example, the display comprises an analog-type gauge having a hand that varies in angular or linear offset, or multiple hands that independently vary in angular or linear offset, in response to the received ambient data. In another example, the transmission of data from the information server to the ambient displays occurs via a one-way or two-way wireless network.

United States Patent Application Publication No. US 2002/0171670 A1 describes a personalized data delivery system for dynamically integrating viewer-specified data with visual content includes an input port for receiving a visual content signal, an output port for displaying enhanced visual content on a display screen, and an interface operatively coupled to the input port and the output port. The personalized data delivery system may also include an input/output port for receiving data from a data content source other than the visual content signal and/or for sending requests for viewer specified data to the data content source. Parameters for the selection and display of data can be customized by the viewer. The interface includes at least one processor being responsive to one or more viewer personalization parameters and operative to integrate at least a portion of the received data with the visual content signal in accordance with the personalization parameters. Memory included in the interface and coupled to the processor at least temporarily stores the personalization parameters.

### SUMMARY OF THE INVENTION

The present invention is a system and related apparatuses that include devices, biosensors, environmental sensors, security related sensors, networked products, communications processors and components, a variety of alert and information components, processors, and software to support at least one or more of the following: 1) facilitating medication regimen and patient/user health administration, dosage control, tracking, compliance, information inquiry and presentation, reminder and notification; 2) providing monitoring, information, ordering, and intervention means in conjunction with the devices and software through components and systems that may be available in standalone or integrated forms; 3) presenting the option of leveraging the preventative care, alert and notification components with other present invention components to facilitate user and/or occupant well being, along with living, work area and dwelling environmental and/or security safety; and 4) enhancing the dwelling, living or work area with products that may be networked to support the widespread acceptance of all present invention innovations described herein and their associated embodiments. The integration and networked means associated with the preceding may support the following: a) processing, centralizing and communicating device commands and/or programs; b) device administration; c) patient/user information; d) dwelling environmental safety; e) security breach information; and/or t) centralized and remote apparatus and system activations through at least one primary component and/or at least one backup embodiment. The intent for the embodiments is to provide the following: 1) economical and efficient care; 2) safety; 3) information dissemination; 4) response; and 5) a compelling means to support widespread acceptance of the present invention and its associated embodiments.

One of the primary utilities of the present invention system is to provide an economical and highly reliable means for and/or through third parties and/or remote components regarding the following: 1) medication administration, compliance, ordering, patient health monitoring, patient medical and vital information inquiry and presentation (different criteria and content used pending on inquiry source—family, case worker, nurse, doctor, etc.); 2) medical device metrics, device operations and programming; and 3) exception reporting, notification and intervention. Another key utility of the present invention system is to broaden the use of some of the invention components to function in conjunction with dwelling or facility environmental safety and security and to facilitate patient and/or occupant safety in the event of a medical and/or environmental and/or security emergency.

Another primary utility of the present invention system is to provide unique products with networking means to enhance a work, living, and/or dwelling area to contribute optimal utilities when networked and interacting with other present invention components to support widespread system acceptance. One of the keys to achieving the widespread acceptance of the present invention embodiments, especially in a networked means, is offering the embodiments in conjunction with at least one associated apparatus that provides a compelling framework and value that utilizes existing infrastructure whereby the present invention embodiment, when coupled with the associated apparatus at a relatively low incremental cost, offers a new utility and a bridge for more utilities, applications, and a means for the widespread acceptance of the present invention system described herein and its associated embodiments.

There are a number of components of this system that are also individual systems and apparatuses and represent invention species unto themselves, yet they support significant utilities for the overall present invention system. The separate present invention components are: a) biosensors with transceivers that utilize a ZigBee wireless protocol and/or other wireless means and protocols; b) a Wi Fi communications backbone network and/or power line network, such as, but not limited to HomePlug™ that may utilize ZigBee-based clusters, other mesh networks, or other wireless networks and associated devices and software and account for hybrid network routers such as a Wi Fi ZigBee router; c) reliable, networked, and programmable timer (and)/or timer and controller apparatuses and systems that comprise and enable economical and unique utilities and configurations, include unique software modes and features that provide and enable a variety of utilities, and are available in a variety of embodiments, from standalone configurations to integrated routers to appliances to lighting fixtures; d) networked answering machines or apparatuses that are utilized in conjunction with other present invention embodiments; e) networked and programmable weather instruments; f) networked personal communicator and/or remote control embodiments that provide greater utility in conjunction with many of the present invention innovations described herein; g) a networked storage (and)/or storage and retrieval apparatuses and system(s) in a variety of embodiments; h) remote controlled electrical plugs and receptacles, power cords, power strips, and extension cords that may comprise multi-addressable plug receptacle switches and other related embodiments, as well as ZigBee light bulb sockets and enclosures that provide unique features in conjunction with other present invention embodiments; i) a digital picture frame with programmable automatic network, screen, and display software utilities; j) a bar code reader with various alignment components and alignment means; k) a prescription label with at least one bar code and/or OCR alignment component for the associated scanner or reader; l) a sharps dispenser material tracking system; m) web server software programs that read content streams such as, for example, RSS feeds and activate a variety of programs such as messaging and/or push-based networked device command programs based on predetermined or personalized conditions associated with said RSS content; n) an environmental and security sensor and alert system that may comprise present invention integrated wireless and/or wired components such as, but not limited to, network addressable programmable voice messaging and speaker components, network addressable sensor alert components with wired and/or wireless communications means that may or may not have voice messaging components, programmable alarm circuits, at least one network or sub-network device or system controller, network addressable visual alert components, network addressable processors with programs for playing certain voice messages and/or activating the emission of certain audible and/or visual and/or vibratory and/or data communications notification means pending on the type(s) and/or location(s) of the sensor activations, wireless carrier and/or internet and/or facility provider messaging services to receive the notifications, and appliances and/or enclosures and/or fixtures, such as, but not limited to, lighting fixtures, emergency or first aid kits, radios, alarm clocks, radio alarm clocks which are adapted for supporting at least one of the preceding present invention medical, environmental and/or security sensor and alert system and web content components.

Another component of the present invention system and apparatuses is to support third party engagement through (a) server(s) and/or associated server-based services (which may include, but are not limited to, intra, inter, and/or extranet, as well as hosting and/or messaging capabilities). The present invention environmental and security sensor, alert and response system is incorporated herein (though it may also exist as a standalone system), because many of its system components may be utilized to support patient and/or occupant safety and it may also be integrated with like third party services. The present invention third party services may also include a variety of advertising, marketing, and media mediums to support economy and widespread use. Another present invention utility associated with remote server capabilities and services is a pricing method for present invention components, devices and/or systems to facilitate their integration with the present invention remote and web server services, advertising and other third party web-based services and advertising.

### BRIEF DESCRIPTION OF DRAWINGS

The present invention should be more fully understood when the specification herein is taken in conjunction with the drawings appended hereto wherein:

FIG. 1 is an illustration depicting some of the present invention embodiments in communications modes;

FIGS. 2A through 2F illustrate a present invention main device display text sequence regarding a medication regimen;

FIG. 3 shows a side view of a present invention medication tracking and aid dispenser;

FIG. 4 is an illustration of a present invention main device mounted embodiment with a bar code reader, portable electronic health and medical record and communications components;

FIG. 5 is another illustration of the present invention main device portable embodiment with pill compartments and another bar code embodiment;

FIG. 6 is an illustration of a sample present invention network with multi-utility devices (including a present invention light fixture and digital picture frame) and sample network management components;

FIG. 7 is a side view of a present invention high gain antenna and lamp harp mount and support system;

FIG. 8 is a top view of the present invention embodiment depicted in FIG. 7;

FIG. 9 is a side view of another present invention high gain antenna and lamp harp mount and support system embodiment;

FIG. 10 is an illustration of a present invention main device mounted embodiment with a portable electronic health and medical record and communications components;

FIG. 11 is a sample illustration of present invention environmental, security and medical monitoring and alert system apparatuses;

FIGS. 12A through 12D illustrate a present invention bottle cap top communications and alert embodiment that comprises an adhesive and securing means;

FIGS. 13A through 13D show another present invention bottle cap top communications and alert embodiment;

FIG. 14 is a side view of a present invention programmable voice recording, messaging, amplifier, speaker and communications component with a present invention lamp harp mount and support system;

FIG. 15 is a side view of a present invention programmable voice recording, messaging, amplifier, speaker and communications component with another present invention lamp harp mount and support system embodiment;

FIG. 16 is an illustration of the present invention pedestal module system;

FIGS. 17A, 17B and 17C are illustrations of some various views of the present invention modular components associated with the FIG. 16 sample present invention configuration embodiment;

FIGS. 18 A and 18B show disassembled and assembled views of an air freshener; and FIGS. 19A through 19D show the wick and cartridge and combined unit including the air freshener.

### DETAILED DESCRIPTION

There are many systems, devices and services available to facilitate medication administration, patient monitoring, intervention and the exchange of medication and patient information. Much of these innovations exist as standalone components or systems. With said systems, uneconomical and inefficient duplicity result when the user has the need for utilizing multiple devices that incorporate like processing, communications, and reporting capabilities. On the other extreme, current innovations also exist for similar components to be part of an entire system without the capability of functioning as standalone components. As a system, these components may support economy of use, but may not be as affordable as users and/or health care constituents desire. For example, an integrated multi-functional telemedicine system may only be economically justified by in-home patients requiring daily comprehensive and/or nursing service care. The telemedicine systems also require staffing support which may also prove to be uneconomical and may not be reimbursed by insurance providers.

In addition, systems and/or devices that facilitate more economical medicine and health aid administration do not support user-friendly and/or appropriate ergonomic interfaces for patients requiring the interfaces (for example, a senior patient who may not be accustomed to a PDA, or who may not have or has no desire to have a PC).

There are a variety of medical devices or device aids that are economical and associated with optional accessories for facilitating care and feedback information. For example, a blood glucose meter may come with an alert function that is initiated when a reading is outside of a parameter range. In addition, PC software and an adapter interface may be utilized with the glucose meter for receiving, processing, storing and presenting meter readings for the end user. Though these aids are helpful, they may not be as beneficial to senior individuals who may not use a PC or others who may require more assistance. Often, family members, who are interested in the proper well being of their relatives and have a desire to help, are limited in providing care due to proximity, economic and/or time constraints.

Many of the capabilities associated with alert, notification and intervention systems exist as standalone functions and do not have the capabilities to be integrated with other types of alert, notification, and intervention systems. In addition, these systems do not have or support embodiments that are user friendly for facilitating appropriate action in the event of an emergency. Other prior art systems range from environmental sensors such as smoke, carbon monoxide, natural gas, propane and other toxic elements, to security sensors such as motion, electrical contact, and vibration detectors. The preceding systems may account for detectors or circuits with voicing capabilities pertaining to the type of environmental hazard. One system accounts for detectors with voicing capabilities that enunciate the type and location of the environmental hazard and may be integrated in a system through a hard-wired means with limited wireless capabilities. Although they are better than systems with detectors that emit various chirps or sirens, they are limited in not accounting for at least one or more of the following: distributed components, in whole or in part, to facilitate desired action(s); broader integrated programs, applications, functions and capabilities; option to utilize a variety of wired and/or wireless communications mediums (though this filing states the preferred mediums); information dissemination and access to facilitate appropriate action(s) for a variety of constituents; and/or not having the option for being integrated with other alert, notification and intervention systems to deliver the best economy and utility for many constituents. Finally, many useful standalone systems do not gain sufficient or widespread acceptance, because they comprise standalone embodiments that do not provide a means to offer other utilities to support the widespread acceptance, such as enhancing a living or work area.

It is an object of this present invention to provide an economical and encompassing system to support broad use. A primary focus is to comprise more economical and user-friendly means to facilitate medication and health regimens and to intervene when the regimens or user health measures are outside of desired ranges for, but not limited to, in-home, assisted living users, and users at a variety of other facilities and/or institutions. The primary reasons are twofold: 1) to support economical remote party administration and intervention in medication and medical device aid and intervention; and 2) to support economical third party medication regimen and patient health inquiry from a variety of constituents, as allowed with appropriate consent.

It is another object of this present invention to provide the means to alert and inform the users and pertinent constituents, as well as others who may not utilize the medication and health aid components, when the environmental and/or security conditions of their dwelling have been breached.

Finally, it is another object of this invention to support widespread use of the innovations described herein, by providing utilities that enhance the work, living, and/or dwelling area and support an economical incremental means for enabling the user to acquire the present invention innovations described herein and their associated embodiments. The purpose for integrating environmental, security and other non-medical innovations, which may function as part of (a) separate present invention system(s), into an overall encompassing present invention is to utilize the economy, networking and integration means of the innovations and their associated embodiments to provide for more compelling present invention system utilities and usefulness.

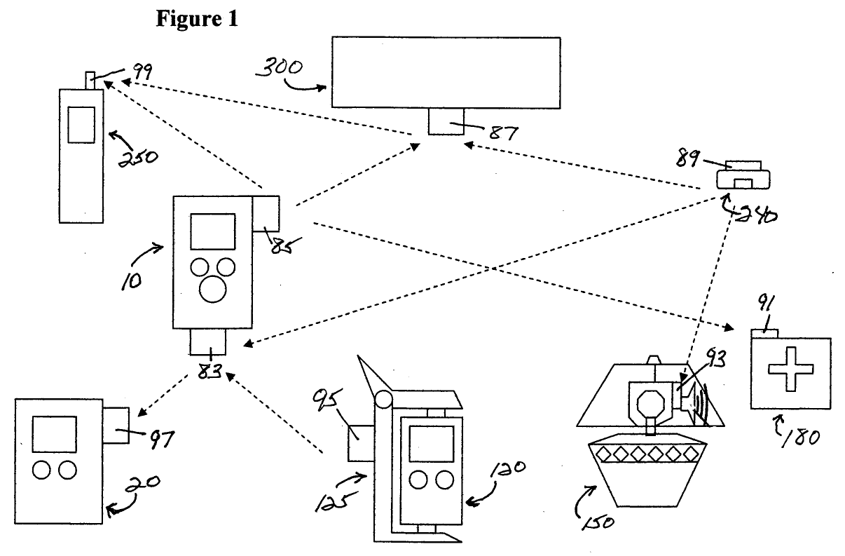

As depicted in the FIG. 1 illustration that includes communications arrows, the present invention may comprise, among other present invention embodiments described herein, the following components:
a main device 10
a medical device 20
unit communications components 83, 85, 87, 89, 91, 93, 95, 97 and 99
a blood glucose meter 120
a device holder/interface 125
an environmental (such as smoke) detector 240
environmental and/or security system distributed components such as a first aid kit 180 and a lamp alert device 150
a cell phone embodiment of a personal communicator 250
a remote server 300

The components, namely, a main device 10, medical device 20, unit communications components 83, 85, 87, 95 and 97, blood glucose meter 120, and a device holder/interface 125, may be a medication and health system embodiment, along with a personal communicator 250 and a remote server 300. The environmental and security system embodiment may comprise a main device 10, unit communications components 83, 85, 89, 91 and 93, a detector 240, a first aid kit 180, a lamp alert device 150, a personal communicator 250, and a remote server 300. The environmental and security system and components will be covered further in this filing narrative, along with the personal communicator 250 and the remote server 300. The first aid kit 180 and lamp alert device 150 may also be accounted for in the medication and health system embodiment. All of the aforesaid FIG. 1 components and unit communications components could be combined into a single cooperative system.

Medication and Health System:

The medical and health application embodiments of the present invention account for a system that comprises: a main device and/or at least one or more medical device components or apparatuses and/or interfaces and/or biosensors (with associated substrates) along with wired and/or wireless interfaces and components where the components may be available as integrated and/or standalone units. As integrated components, they may be integrated with the main device where the main device may provide the means for, at minimum, a communications capability and/or communications interface and/or a central processing and/or a central reporting capability. As standalone components, they may be initially purchased as such and subsequently integrated with a main device having, at minimum, the preceding capabilities. The present invention may also comprise a server-based (onsite and/or remote) component(s) to support the following: 1) remote party administration and intervention in medication and medical device use, as well as medical device programming; 2) authorized third party medication regimen and patient health inquiry, regimen prescription downloading and ordering; and 3) a variety of reporting and information presentation capabilities.

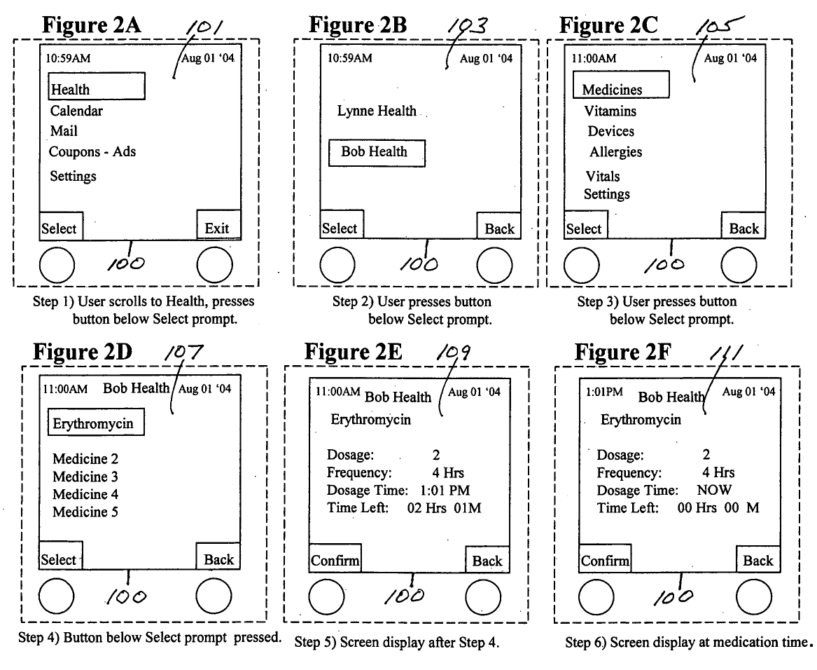

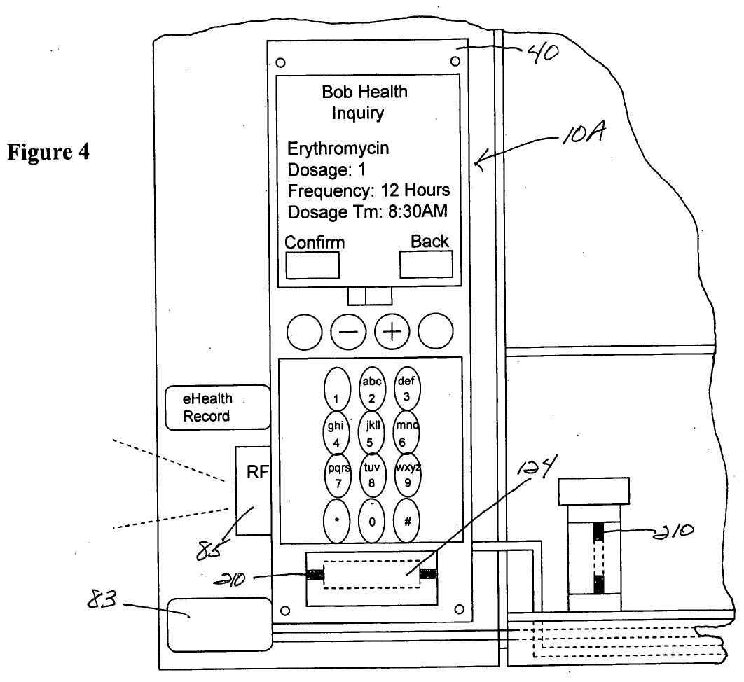

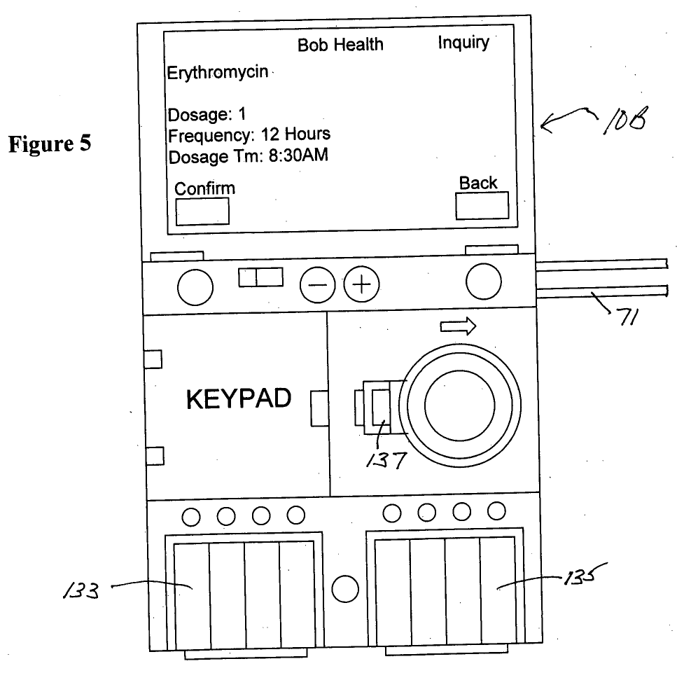

With reference to the illustrations, a main device 10 of FIG. 1, this is also the main device to be used in conjunction with FIGS. 2A through 2F, 4, 5, and 10, and need not be repeated in every Figure. This main device may account for the following: facilitating medication administration, supporting third party communications and comprising one or more means to support connectivity for a medication aid device and/or medical device 20 (FIG. 1) monitoring and/or device control functions. Main device 10 may be in stationary (mounted) form main device10A (FIG. 4) or in portable form main device 10B (FIG. 5) or and support code scanning/reader/input (such as, but not limited to, bar code, RFID and/or OCR) functionality.

The main device of the present invention discussed above and below may include of the following components:
four categories of input components: wired and/or wireless (including RFID), coded/scanned information (for bar code, RFID and/or OCR), and/or button activated.
four categories of output components: wired and/or wireless transmission and connectivity, audible and/or visual output means
processing, device driver and menu-driven software to facilitate user interaction; medication administration and ordering; medication device information, functionality, operation, and inquiry; and alert, notification, reporting and communications functions
device adapters to support connectivity to a main device docking station 40 and medical devices and/or medical device interfaces (wired and/or wireless) such as, but not limited to, a portable storage device that may include patient information and program backup, a blood meter, a blood pressure device, an infusion device, a biometric device, an oxygen tank or concentrator, medication dispensers and/or holders and/or scale devices, sharps container information and system, and/or at least one biosensor.
optional integrated components such as, but not limited to, a bar code reader and/or pill compartments and associated timer and components.
   Input Components:

The four types of input components are wired, wireless, scanned/coded or button-activated. They may exist in separate or combined forms.

The wired input application component may consist of a communications interface cord, cable (such as, but not limited to, a USB—Universal Serial Bus cable), circuit or device connectors (that may support standard communications and electronics protocols and interfaces). The input sources may be, but not limited to, medical and/or medical aid devices; and/or communications devices such as a modem or Ethernet interface to link with a variety of wired network mediums; a personal, pocket, tablet or PDA computer; an external memory device; a Digital Satellite Receiver; a cable box unit; and/or electrical circuit connections to motion detectors, line-of-sight optical detectors, infra-red coded readers, lock box components, sharps dispenser components, and/or medication dispensers/holders components such as, but not limited to, lids, latches and/or springs.

The wireless input embodiment may be associated with general radio spectrum frequencies for low spectrum RF devices, higher spectrum Wi Fi devices, UWB (ultra wide band) devices, mesh networked devices, cellular devices, RFID receivers, AM and FM band frequencies, digital satellite radio, high definition radio, instant messaging devices, and other wireless messaging devices and networks. The devices may be adapted for various platforms and/or protocols such as, but not limited to, Blue Tooth, Wi Fi platforms, UWB, ZigBee, and/or proprietary closed standards-based wireless protocols. This embodiment component may be in the form of, but not limited to, a network transmitter and receiver card and/or chip set, processor and device interface with the appropriate software and/or firmware. Another wireless input component may be an infra-red assembly.

The scanned/coded input application may consist of a scanner or receiver such as, but not limited to, a bar code reader, radio frequency identification device (RFID) reader (in a passive or active embodiment), and/or Optical Character Recognition scanner/reader. The scanning function may be associated with, but not limited to, reading medication or vitamin label information, or receiving RFID information from a variety of embodiments such as, but not limited to, tag cap, vial, and container medication information, as well as reading other RIFD tags that may present exceptions to medication regimens or patient welfare, from accounting for cigarette packages with RFID tags to tracking patients and/or care providers with RFID tags.

The button-activated input utilizes either keypad or display button. The four preceding components, along with other input means such as, for example, a touch screen display, as well as voice input and recognition means, may be embodied in (and)/or interfaced to the main device 10.

Output Components:

The four types of output components are wired, wireless, visual and audible. These components may also exist in separate or combined forms.

The wired output application component may consist of a communications interface cord, cable (such as, but not limited to, a USB—Universal Serial Bus cable), circuit or device connectors (that may support standard and/or proprietary and/or private communications and electronics protocols and interfaces). The output sources may be, but not limited to, medical and/or medical aid devices; communications devices such as a modem or Ethernet interface; a personal, pocket, tablet or PDA computer; an external memory device; a cable box unit, and/or electrical circuit connections to lock box components, sharps dispenser components, and/or medication dispensers/holders components such as, but not limited to, lids, latches and/or springs. The wired output application may also be associated with remote alert devices and distributed components which will be covered further in the narrative associated with the present invention environmental, security and health sensor and alert system.

The wireless output application component may be associated with most of the same or similar devices related to the wireless input application component. The wireless output application may also be associated with remote (WAN, LAN and/or Home Area Network (HAN) based) messaging and alert devices and distributed components which will be covered further in the narrative associated with the present invention environmental, security and health sensor and alert system

The visual output application component may be, but is not limited to, a display on the main device; a display on a television, cell phone, computer, router and a variety of portable devices associated with the patient or third parties; a lighting element such as, but not limited to, a bulb or LED on the main device or on other embodiments such as, but not limited to, on medical or medicine devices that are connected (hardwired, circuit means, wired or wireless communications means) to the main device or even on a cabinet door that is associated with a medicine cabinet. Visual output could also include anything that may be seen to perceive intelligence, a signal, message, warning or alert, from the mundane (printouts) to the absurd (a pop-up flag), without exceeding the scope of the present invention.

The audible output application component may be in a variety of embodiments such as, but is not limited to, a chirping device (or similar sound emitting device), (a) programmed phone call(s), a speaker apparatus which may be connected to main device 10 and/or remote from main device 10 (such as, but not limited to, the devices covered further in the narrative as a present invention lamp alert device and other present invention distributed components as well as speakers associated with a home entertainment system), and/or programmed reminder message(s)/alert to the patient and/or alert messaging to third parties.

As noted, the preceding output components may be embodied in the main device or interfaced to the main device, e.g. main device 10, and/or interfaced to other devices associated with the main device.

Software:

The main device accounts for processing, device driver, administration and menu-driven software to facilitate user interaction, medication administration, prescription information, medication ordering, medication device information and functionality, device diagnostics, inquiry; and alert, notification, reporting, intervention and communications functions.

The processing software function comprises programs that may be initiated by data from primarily input sources and time/date parameters. Data from input sources may be, but is not limited to, scanned bar code information from a prescription label, a glucose level reading from a blood sugar meter, transmitted gas mix exception levels from an oxygen concentrator, and/or transmitted prescription information from a pharmacist or physician. Time/date parameters may be based on two types of metrics: time/date clock and time cycles or intervals.

Device driver software is primarily for controlling external device functions. Examples of said functions may be, but not limited to, activating a circuit lead to unlatch a lid on a medication holder associated with a pill dosage compartment and/or activating a bar code scanner that may be mounted to the inside of a medicine cabinet, where upon the opening of the cabinet door activates a circuit switch that is connected to said bar code reader where said circuit activation may originate from a motion detector inside the cabinet facing the cabinet door.

The menu-driven software provides the user interface means for the following main functions: medication administration, medication device information and functionality, device diagnostics, inquiry; and alert, notification, reporting, intervention and communications functionality. This software may be in the form of text/list-based menu driven functionality, icon-based drop-down menu and/or pop-up functionality, as well as voice recognition software.

FIGS. 2A through 2E depict sample sequences associated with the present invention menu-driven software with display screen 1100 in each of the Figures.

FIG. 2A illustrates a sample main menu display 101 showing time, date, the words, “Health”, “Calendar”, “Mail”, “Coupons-Ads”, and “Settings” in the main portion of the display, and the words, “Select” and “Exit” on the lower left and lower right, respectively, portions of the display. Upon depressing a scrolling button on the main device 10, the words, such as but not limited to, “Directory”, “Games”, “Questionnaire” and “Other” may also appear on the display. Pending on the expansion module associated with the main device 10, a “Phone” text may also appear on the display.

Upon depressing a button below the “Select” term when the cursor is over the word, “Health”, the user names associated with the present invention system appear on the display, such as, “Lynne Health” and “Bob Health”, as depicted in FIG. 2B display 103. After depressing the button below the “Select” term when the cursor is over the word, “Bob Health”, the following words may appear on the display below the header, “Bob Health”, “Medicines”, “Vitamins”, “Devices”, “Allergies” and “Settings”, as illustrated in FIG. 2C display 105.

FIG. 2D illustrates the display readings upon depressing the button below the word, “Select” when the cursor is over the word, “Medicines”. The display 107 shows the fields, “Erythromicyn” , “Medicine 2”, “Medicine 3”, “Medicine 4”, and “Medicine 5” may appear on the display under the header, “Bob Health”. Scrolling may enable the user to see more medicines.

FIG. 2E depicts the display 109 with the readings of“Erythromicyn”, “Dosage: 2”, “Frequency: 4 Hrs”, “Dosage Time: 1:01PM”, “Time Left: 02:01” which are activated after depressing the button below the word, “Select” from the preceding screen display 107 (FIG. 2D).

FIG. 2E display 109 also depicts the words, “Confirm” and “Back” on the respective lower left and lower right portions of the display. The “Confirm” prompt is associated with the confirmation of the user taking a medication. Even though the user may have 2 hours and 1 minute left before the next dosage, the “Confirm” prompt may appear. An alternative prompt associated with a medication dosage that is not due may be “Next” for purposes of scrolling to the next medication readout. Should the user depress the button under the “Confirm” prompt, the main device may emit a warning sequence of two chirps and display a text question such as, “Did you take erythromicyn?” along with the prompts “Yes” and “No” at the lower left and lower right portions of the display. Separate questionnaire and activation sequences may take place pending on the medication, dosage and dosage time associated with the medication.

FIG. 2F depicts a display 111 illustrating a sequence when it is time for a dosage. The terms, “Dosage Time: NOWY” and “Time Left: 00:00”, along with “Confirm” and “Back” on the respective lower left and lower right portions of the display may appear with this type of sequence. Upon depressing the button below the term, “Confirm”, the next screen may display, at minimum, the term, “Take erythromicyn pill 1” with a “Confirm” or similar prompt on the lower left portion of the display. Upon depressing the button below the confirm prompt, the screen may display, at minimum, the term, “Take erythromicyn pill 2” with a “Confirm” or similar prompt on the lower left portion of the display. Upon depressing the button below the term, “Confirm”, the next screen may display the sequence illustrated in FIG. 2 E, with two exceptions. The exceptions may be displayed as “Dosage Time: 5:02PM” and “Time Left: 4:00”.

In some of the embodiments of the present invention system, there is at least one program that displays a certain screen sequence based on a set of one or more identifiers. These identifiers may be, but not limited to a date and/or time metric, a dosage time metric, and/or an email originating and/or subject header and/or attachment name or code, as well as instant messaging content identifiers and other forms of content identifiers. Other forms of content identifier embodiments may be web server based, such as server software programs that read content streams, such as, but not limited to, RSS feeds. Said web-based content identifier programs may be integrated with device platforms, such as the present invention main device wherein said main device may receive commands and/or associated content packets from said web server associated with said content identifier programs.

One example of the use of the preceding invention embodiments is a program that displays a text message, “Call Doctor for Results” and emits one or more chirps on a cycled interval that may indicate that the display is in a message board mode based on a preprogrammed time and or date. Another variation of this message board function may be displaying an email or text message that includes the test results based on a program that screens one or more of the following identifiers: email originator, subject, message text words, and/or attachment file name, where the program is based on the activation of an interval cycled program that enables the device to automatically call out and log on to a server for messages. With the latter identifier of an attachment file name, an attachment may be opened and displayed, upon the appropriate matching with other identifiers.

Another example of this embodiment may be displaying a digital photo, given that the display (such as, but not limited to, a LCD), driver and program supports the functionality when an email or message is received with the appropriate identifiers. An application for the present invention embodiment is automatically displaying a digital picture of, for example, a user's grandchild that may have been taken at the beach and sent or forwarded to the main device email or network address. Another embodiment of this present invention device is to display an accompanying email message or play an audio portion of the message, if the device comprises appropriate software, such as the type provided by Real Networks, Inc., and audio components.

This example may be enabled through a number of present invention embodiments, one said embodiment may comprise the following components: a communications interface and component such as, but not limited to, a modem, Wi Fi card or broadband interface; a communications program such as, but not limited to, email; a timer or clock cycle program (pending on the communications interface); a screening (identifier) program; at least one device driver program; and at least one executable program. The automatic networking component associated with the embodiment described herein accounts for, but is not limited to, utilizing a modem as the communications interface. In this configuration, the user may designate a cycle interval in which the main device modem may dial out to the user's internet service provider portal or the present invention server. Upon the modem accessing either portal, and transferring associated login, password and cookie information, the main device 10 program may launch the email access, screening, opening and displaying function based on the execution of prescriptive identifiers and tables associated with the function.

The purpose for incorporating the digital picture function as an option to this type of present invention embodiment is to account for uses for engaging user interaction, enjoyment and use of the system. Other incentives for the use of this system may be, but are not limited to, advertising, coupons, games, questionnaires, and/or news reports, as well as personalized content, which may be adapted to the main device display, networked peripheral displays and other mediums associated with the patient or system user or associates related to the patient/system user.

Another example of the present invention identifier program embodiment is utilizing a dosage time identifier. In this application, the main device display may include the prompt, “Dosage Time: Now”, upon the activation of a dosage time identifier program which accounts for displaying the preceding message associated with a certain medication at a specified time and/or dosage interval. The dosage time identifier program may have a number of other functions, such as, but not limited to, playing a voice message when it is time for a certain medication and the type and dosage for the medication and/or activating a light bulb component that may be on a pill box compartment or prescription bottle cap associated with the medication.

Device Adapters, Interfaces and Functionality:

The present invention accounts for similar menu functionality when the user utilizes the medical device (“Device”) and “Vitamins” menu sequences. For example, the “Device” sequence may account for a prompt and/or alert such as “Usage Time: NOW” for alerting the user to utilize the device.

The “Device” portion of the program may also bring added functionality to the main device 10, depending on the type of device and/or device module that may be connected to main device 10. For example, a user, device and device interaction sequence may take place with the following components: a blood glucose meter 120 (FIG. 1), a cradle and/or holder and/or/interface 125 (FIG. 1—which may also be standalone, wired and/or wireless), a main device 10 (FIG. 1), and unit communications components 83 and 85 (FIG. 1).

A user may remove the meter 120 from the interface 125 upon being alerted and prompted by a display on main device 10 that may have included at least the following text, “Usage Time:Now”. The preceding message and/or at least one form of alerts may also appear or be accounted for in other present invention embodiments of meter 120 and/or cradle 125. Upon the disconnection of meter 120 from cradle 125, a program may be initiated either on meter 120, and/or cradle 125, and/or main device 10. The activation of the program may be initiated from an electrical contact to at least one processor which was the result of the loss of connection of at least one component between devices 120 and 125. This program may perform one or more of the following functions: track the time and/or time and date from an associated processor clock in which device 120 was disconnected from device 125; and initiate a counter/counting/timer program upon the device disconnection. The counter program may have a pre-programmed interval cycle (it may also be optioned for a user-defined interval) for marking the threshold of time between the disengagement of the meter 120 from cradle 125 to the connection of the meter 120 to cradle 125. The counter program may have a series of steps and/or functions associated with time benchmarks subsequent from the passing of the threshold level. For example, in one type of configuration embodiment, a counter program (that may be residing on at least one processor in, but not limited to being in, cradle 125) may comprise a command to perform a communication function to notify an entity or person listed in a communications directory in main device 10 and transmit a message via the communications components such as, but not limited to a text message, email, and/or voice message indicating to call the user or patient of the present invention to remind them to take a blood sugar reading.

Another embodiment of the preceding configuration may comprise a data communication and function from meter 120 to cradle 125 and a threshold and execution program for transmitting metrics such as analyte information and a time and date stamp associated with the analyte reading, comparing the metrics against a target, and executing commands in the event that the information is outside of the target measure or range. Though there are devices that communicate information from the meter device through means such as an infra-red medium, the present invention offers greater utility by comprising at least one program that compares the analyte and time reading against a certain target or range, and alerts and/or notifies (a) third party(ies) in the event a certain threshold is met and/or exceeded. The application associated with transmitting the date and time stamp along with the analyte reading is to confirm that the analyte reading took place between the cycle of time in which the meter 120 was removed from and inserted back into the cradle 125. The execution, alert and communication function may utilize one or more of the components and capabilities noted in the preceding paragraph to support economy of resource use and the capability for a centralized inquiry and reporting function.

The preceding functionality applies to other present invention components, such as, but not limited to, other forms of biosensors and associated devices, processors, chip sets, programs, substrates, interfaces and wired/wireless communications capabilities. The preceding will be covered in greater detail herein.

Another embodiment of this present invention blood meter 120 configuration is a meter with the functions and components of cradle 125 integrated into the meter as one system. More specifically, the meter may have a timer, alert, exception execution program and communications function integrated as one system. The purpose for such a configuration may be to support the functionality of the preceding system in a more compact and portable arrangement. The communications component(s) associated with such a system may be in the form(s) of a variety of wired and/or wireless components, such as, but not limited to a modem or digital interface connected to a cell phone (and)/or smart phone (and)/or PDA, (and)/or a Wi Fi card, and/or a Zigbee or Bluetooth chip set for local wireless network functionality.

This integrated embodiment may also be available with at least one device option for operating all functions as a standalone system or selecting certain functions as an integrated system. For example, the analyte and/or target comparison and/or communications function(s) of the standalone meter 120 may be optioned to be performed through a remote or directly connected main device 10 and/or another main device such as a personal computer, a larger centralized computer or server or reporting service or web site. Said device option may be operated by the user through a software interface and/or a dip switch interface.

The interface 125 may also be available with at least one device option for operating all functions as a standalone meter 120 and interface 125 system or selecting certain functions as part of a larger integrated system. For example, the analyte and/or target comparison processing and/or communications function(s) of this standalone system embodiment may be optioned to be performed through a remote or directly connected main device 10 and/or another main device such as a personal computer, a larger centralized computer or server associated with a reporting and monitoring service or web site or the equivalent of any one or more of the foregoing. The interface 125 may also exist as a limited function embodiment as a peripheral attachment of main device 10. In such a configuration, main device 10 may comprise the processing and communications capabilities.

Another utility derived from the preceding integrated medical and main device functionality of the present invention is the device interaction capability that may put less onus on the user for system interaction as the user desires. For example, should the user be prompted through the display associated with man device 10 with the following “Device” sequence menu prompt excerpt, “Usage Time: NOW”, the user may remove the device 120 from the cradle 125, take a blood sample and reading, and insert device 120 back into cradle 125, and may not have to press the button below the “Confirm” prompt, because the system may be integrated sufficiently to not require that level of interaction.

As noted further in the narrative, main device 10 may offer a variety of additional functionalities pending on the medical and/or medical aid and other types of alert devices associated with the device 10.

Integrated and/or Networked Components:

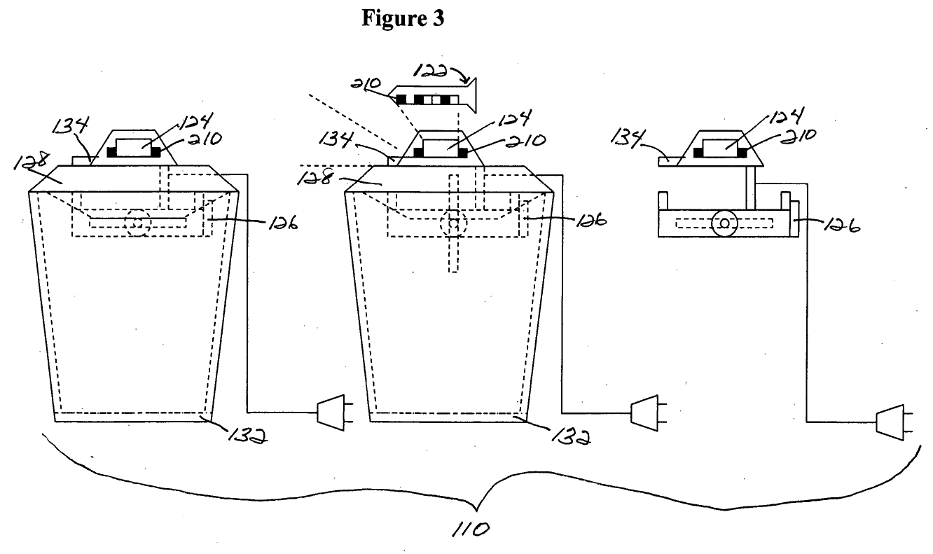

Another present invention embodiment that may enhance main device 10 medicine administration functionality is a dispenser material tracking and medication aid system 110 shown in FIG. 3. This system 110 is comprised of a code reader, such as, but not limited to, a bar code reader 124 (FIGS. 3, 4, and 5) RFID tag reader, and/or an Optical Character Recognition Reader (OCR); at least one line of sight scanner 126 (FIG. 3); a dispenser cover 128 (FIG. 3) which may come in a variety of embodiments; a dispenser container and/or a dispenser container enclosure 132 (FIG. 3); at least one communications component 134 (FIG. 3) and a variety of materials, containers, components, packaging and/or vials 122 (FIG. 3) that have a coding means for enabling a coding reader and/or scanner to register the coded information. The preceding invention components and associated components described herein are comprised of materials suitable for supporting each component's respective structures and functions. The readers 124, RFID and OCR, scanner 126, and other related signal or scanning embodiments described herein are comprised of metallic, processor, hard plastic composites, electrically conducting and precious mineral materials. The dispenser cover may be comprised of a moldable plastic composite and may comprise a metallic or durable plastic mounting plate and locking component (locking component may not be in all embodiments), and metallic and electrically conducting components associated with the invention embodiments described herein. The dispenser container and/or dispenser container enclosures may be comprised of a moldable plastic composite, as well as metallic or durable plastic locking mechanisms pending on the type of present invention embodiment. The vial may be comprised of a moldable and partially translucent plastic composite. The system 110 is a part of other embodiments of the present invention that may be associated with or part of, in whole or in part, a health records recording and reporting system and service, a notification and alert system and service, and a health management and health management provider system and service.

The dispenser material tracking system has many embodiments and supports many applications, such as, but not limited to, from document shredding to toxic material dispensing to residential, institutional, and/or long term medical care. A significant benefit that has been and will continue to be addressed in this invention narrative and illustration is for aiding many types of patients and people in administering a variety of medications. One form, of many forms that may be accommodated by the present invention, is a disposable syringe.

In one present invention embodiment, again referring to FIG. 3, a disposable syringe container or vial 122, may support accounting for information by having the means, such as, for example, a surface area to accommodate a bar code or character label or a means for accommodating a RFID tag. A code reader 124, RFID, and/or OCR that may be integrated or interconnected with a recording function and the optional or integrated operation of opening a closed aperture on a dispenser cover 128 or the side of a dispenser container or dispenser container enclosure 132 along with at least one communications component 134 are other invention embodiments associated with vial 122.

One embodiment of vial 122 comprises a bar code plate surface and/or label. The bar code may contain information such as, but not limited to, the type of medication and dosage amounts and frequency. The bar code reader 124 may be secured on the top of the dispenser cover facing in front of a recessed aperture. The aperture may have a door and door like mechanism that may be closed. The reader 124 processor may be connected to an electrical circuit contact, amongst other contacts, where upon confirmation of an accurate read, an electrical connection is made over the circuit which results in activating a mechanism, such as, but not limited to, to pull a latch (that may be connected to a spring mechanism) for opening the aperture door. The reader processor or interconnected processor may also have a date and time function and be interconnected to a memory means for recording the scanned information and date and time of the scanning. In addition, the reader processor and/or memory means may be linked to a communications interface and/or chip, such as, but not limited to, a ZigBee chip set, for communicating the information to a main device 10, and/or third party devices and/or a service.

One of the intentions of the system 110, along with the other present invention devices, is to provide the end user and other constituents a tracking means for taking a prescribed medication in a manner that conforms with the process of taking the medication. Given that a user may have a medical condition requiring an injection of a medication through the means of a disposable syringe, and the syringe is disposed in a container solely for said purpose, the placement of the reader 124, RFID, and/or OCR on or around the container provides minimal interference with the existing process. The two interference points of having the vial scanned (with a bar code reader—with a RFID tag reader it is less of an interference factor) and discarding the vial in the dispenser upon the opening of the aperture door are mitigated in comparison to the benefits derived for said points. In one embodiment, the vial may be dropped in a recessed aperture; however, it is recommended that the user should ensure that the aperture door is opened and the vial is dropped into the dispenser. In instances where a bar code or RFID tag is not supported for an injectable or subcutaneous application, a line of sight scanner 126 facing the aperture of the container for, at minimum, capturing the disposal of each disposable needle or application and the time and date of the disposal adds value for the user or service that desires a more accurate and unencumbered tracking means.

The benefits of providing a tracking function to support administering medicine allow the user, care provider, and/or relative to know, at minimum, when the last dosage may have been taken. Given that the information is recorded, the present invention, as noted, has a number of embodiments for processing and presenting the recorded information.

One embodiment comprises a processor with a program for processing the medication type, the dosage, and frequency information by the reader 124, RFID, and/or OCR and date and time associated with the activation of the reader 124, RFID and/or OCR for capturing the vial barcode, RFID tag, and/or character information. A sample program may be to register the following in a field of characters: a variable, A, when the code identifying a drug, such as beta seron, is scanned by the reader; a number that is equal to the dosage amount number scanned by the reader; another number that is equal to the hourly interval number scanned by the reader; and another number that is equal to the day counter interval scanned by the reader. The processor may have a program for each unique medication. Additional information, which may be coded and associated with a different program, may be the package number, quantity count, and expiration date associated with the package that the medicine may be associated with. Given the preceding information, the present invention may comprise a program that has a counter, alert, reminder and/or ordering function associated with the medication package that may be activated when a program counter quantity reaches a certain threshold.

A sample present invention program for administering a drug such as beta serone may be program A that may consist of the following program lines and logic flows. The medication program and logic flows become activated each instance the reader 124, RFID, and/or OCR scans the coded medication information associated with the medication. Line 10 may assign character values for each respective code value scanned by the reader 124, RFID, and/or OCR such as, U=12 (for assigning the value 12, which may equate to the drug, beta serone, for medication character U), V=01 (for assigning the value 01 for dosage character V), W=00 (for assigning the value 00 for hourly character W), and X=02 (for assigning the value 02 for the day counter character X). Line 20 records the run date that program A was activated and assigns the date character D with the run date, for example, D=040220, for the date of Feb. 20, 2004. Line 30 records the run time that program A was activated and assigns the time character T with the run time, for example, T=0830, for the time of 8:30 AM. Line 40 may have an IF THEN statement for setting program flows based on dosage information such as, IF V=01, line 60, for running a program flow that starts at line 60 if the value of V is 01. If the value of V is not 01, then the program defaults to the next line 50, which may be a GO TO statement for running a program flow that starts at, for example, line 200, such as, GO TO 200. Line 60 may set a counter value of 1 for a variable Y such as, Y=Y+1, for the purpose of supporting the logic for measuring an over dose condition. Line 65 measures for the overdose condition, such as, IF Y>V, GO TO 300. Line 300 may initiate a program or series of programs and alert actions associated with the overdose condition. Line 70 may deliver a command to restart the program A on line 90 when the date and time is Feb. 22, 2004 at 8:30 AM, such as RESTART line 90 IF D=line 20+X AND T=line 30+W. Line 80 may be a program STOP command. The program A may be initiated when the user administers another dosage and utilizes the activation of reader 124 and/or 126 as part of the medication administration process. The program A may also be initiated based on a date and time RESTART command such as the command associated with line 90. Line 90 may be a DISPLAY command such as, DISPLAY “BETA SERONE OVERDUE BY” AND T=T-line 30 AND S=D-line 20+X to display the following on a display, such as, for example a LCD that may be interconnected (through a variety of means) to the program processor: BETA SERONE OVERDUE BY 1 HR 45M & 0 DAYS to notify the reader of the LCD display that the user may be over due in taking a beta serone medication by one hour and forty-five minutes and zero days. Line 100 may be an AUDIO command to activate an audio device that may be defined as CHMRP that is interconnected to a program processor, such as AUDIO CHIRP, which may activate the device and/or device processor that may have a program or electrical circuit that activates a chirp sound from the audio device. The remaining program lines in this program set that is associated with a one dosage medication (V=01) may account for other alert commands such as EMAIL, TEXT (message), PAGE and/or CALL an individual (BOB CELL) from a names directory, and/or group of individuals (FAMILY 1) from a list directory with a particular message which may reside on a primary processor or interconnected processor (MESSAGE 1). An example of such a command program may be on line 110 such as, IF T=line 30+W+01, CALL BOB CELL. Another set of commands may comprise a counter and loop function such as: line 140 may be, COUNT T@15M; line 150 may be, CALL KATHY CELL; line 160 may be, CALL FAMILY 1; and line 170 may be, GO TO 140. This latter set of present invention program functions may be associated with a reminder and medical health alert system.

The preceding program illustration is one example of the various present invention programs, such as, but not limited to, inquiry and ordering programs and related invention component and services embodiments that may be associated with the present invention. In yet another present invention embodiment, said main device, comprising a browser, may comprise a program to retrieve a program application from a web server to facilitate the administration of a medication that has a bar code format unique from said main device's administration programs.

A related invention embodiment accounts for incorporating the preceding medical application dispenser material tracking system into a portable system, such as, but not limited to, a travel case and/or dispenser container and/or enclosure with the associated scanner device with at least one processor, memory and a combination of, but not limited to, all or some of the following components in a standalone (one device such as a portable main device 10) or interconnected form (such as being comprised in a handheld system such as a main device 10 comprising the invention embodiments disclosed herein): display; alert capability(ies) (various audio and/or silent means); communications capability; and external device linkage (such as, but not limited to, a USB connection). The portable system components may be comprised of materials suitable for their respective structures and functions such as, but not limited to, a hard moldable plastic composite for the vial container portion of the travel kit. The handheld reader and program processing device may be comprised of metallic, processor-based, hard plastic composites, electrically conducting and precious mineral materials.

Another present invention embodiment expands upon the invention coding embodiments and accounts for the coding on all medicine and vitamin containers and packets (in comparison to utilizing prescription bar coding for hospital use). The purpose of this invention embodiment is to provide greater utility to the administration and management of taking medicine and vitamins. When coupled with a variety of invention device and device hardware and software components along with invention services or methods associated with these embodiments, in whole or in part, the present invention coding embodiment provides multiple utilities and benefits in health and preventative health care.

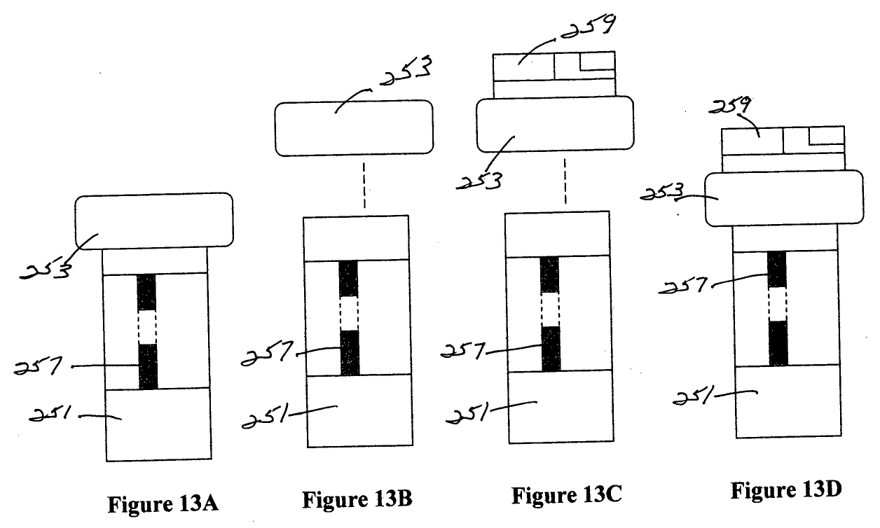

One coding system embodiment is to utilize bar coding (from a variety of coding sets or standards) and bar code labels on the medicine or vitamin container that comprise information similar to the previously disclosed information herein. This invention embodiment may account for other information, such as, but not limited to, an expiration date. An embodiment that may be separate or be within this embodiment is a bar code label or imprint that consists of at least two information fields. One field of information is the bar code sequence. The other field of information may be a scan guide, such as scan guide 210 (FIGS. 3, 4, 10 and 12) and scan guide 257 (FIGS. 13A through 13D). The scan guide is a means for providing the user an indicator for aligning the appropriate bar code label in front of the scanner. An invention embodiment example of the guide may comprise a color marking or Braille block in a circular, spherical, rectangular, square or octagonal form with the words, SCAN or similar type, printed or raised in the mark. The scan guide may also account for at least one line or imprint that is on the opposite side or on one or more sides of a container to support the optimal means for aligning the container bar code with the bar code scanner. The scan guide may be a color mark that is distinguishably prominent from the other colors on the label yet it does not impede one from reading the print on a label when the color mark bisects or runs through label print. An example of the color mark may be a yellow line that is wide enough for the user to notice and may be at a width comparable to the bar code width that is on the opposite side or quadrant corner of the container. The invention embodiment reader, e.g. reader 124 (FIGS. 3 and 4), may also have a line and/or Braille mark to facilitate the user with aligning the bottle label mark along with the reader mark. An example of the deployment of the bottle label mark may take place at a local pharmacy where the pharmacy receives a mostly blank prescription label with a line mark (as shown) running down its center. Upon filling a prescription, the prescription label is printed with the requisite information. The labels described herein are comprised of primarily paper and adhesive (such as, but not limited to glue) composites. Part of this information may also be printed in bar code form either on the same label, pending on the size of the container that the label will be placed on, or on a separate label that is used solely for bar coding. Said invention embodiment mark may also be associated with other containers such as syringe vials and non-medical products, such as, but not limited to, from packaged goods to cans to containers with toxic chemicals.

Other invention embodiments utilize the coding information on a character label (for OCR) or RFID tag.

Another set of invention embodiments accounts for devices and associated equipment that facilitate the use of capturing the coded information through a means that supports the process for administering the medication and vitamins. An example of the embodiment is main device 10A illustrated in FIG. 4, where a reader 124, RFID, and/or OCR; reader mount and/or other associated equipment and/or components that may be mounted and/or adhered to, but not limited to, a cabinet door or connected to the equipment that is on the door, preferably the inside of the door. As the user removes a medicine or vitamin container or packet from the shelf of the cabinet, the user may scan the container in front of (as associated with a bar code or OCR reader) or near (as associated with a RFID tag reader) the reader 124, RFID, and/or OCR.

The reader 124, RFID, and/or OCR may be connected to a processor that may have a variety of programs such as those noted in this narrative, but not limited to the programs noted in this narrative, or may be connected to a set of processors with the programs. As previously stated, it is important to note that the reference regarding processor and electrical connections, throughout this narrative and present invention text described herein, may account for wired and/or wireless connections. A present invention embodiment of the processor linkage may be not only a cabinet display, such as previously noted, but not limited to, a LED display or LCD, with text, icons and/or a color scheme to remind the user of taking other vitamins or medications, but the reminder information may also be displayed, but not limited to, on a television, computer, PDA, or cell phone screen (which may belong to the user and/or (a) party(ies) associated with the user or a trigger condition, pending on the criticality of the information).

Another present invention embodiment for facilitating the process for medication regimen is a main device 10 as described herein that incorporates at least one or more of the following: a pill box container 135 (FIG. 5), and/or another scanning means 137 embodiment (FIG. 5).

The pill box container may comprise at least one or more pill compartments and may also contain a means for informing the user about the relevance of each respective compartment and/or the medication regimen sequence associated with each compartment. This means may range from, but is not limited to, accounting for basic day or time of day markings, to comprising a light bulb or LED in proximity to each compartment which is activated at the appropriate regimen time, to comprising a locking means for all compartments and locking the compartments except for the compartment associated with the appropriate medication regimen sequence, to opening a latch associated with the appropriate compartment based on a present invention embodiment of having a spring loaded latch or door associated with each compartment.

The present invention scanning means 137 embodiment (FIG. 5) may comprise the following: a recessed aperture with a depth and width for accommodating a variety of prescription, medication and/or vitamin bottles, an aperture bottom which rotates and may have alignment markings to facilitate the placement of a bottle, a rotating mechanism and/or means such as a motor for rotating the aperture bottom, a scanning component (such as, but not limited to, an infrared bar code scanning component), and at least one program software component for enabling the scanning, capturing and execution of present invention device functions associated with the scanning of the coded information.

FIG. 5 is an illustration of this main device 10B embodiment, though it may be available in a variety of other embodiments. It may comprise all of the forms of input, output, processing, and communications components as previously described in the text.

The pill box container 135 may be made of a durable moldable plastic composite with associated low cost plastic compartments and low cost plastic or metallic compartment assemblies, pending on the level of functionality, such as, but not limited to, hinged or spring loaded compartment lids, latches or doors. It may be removed from the main device 10B through a variety of means, such as sliding out of the main device 10B frame or docking connection. FIG. 5 also depicts a docking release button to facilitate this function. It may also comprise electrical contacts that are connected to a main device 10B circuit which is connected to a main device 10B processor for enabling pill box compartment level functions as previously described herein. It may also comprise data communications contacts with similar terminations as described in the preceding to facilitate higher level functionality such as interactive utility (for functions like medication regimen confirmation).

The scanning means 137 may be integrated in the main device 10B frame, or it may be an adjunct device to main device 10B. It may be comprised primarily from a low cost moldable plastic composite for its outer and inner sides, its top and bottom portions and associated fasteners; and a combination of electrically conducting, metallic and plastic materials for its motor apparatus and infra-red (IR) reader/detector and amplifier.

The scanning means 137 IR detector may be in an on-state and its associated software program and motor may be initialized upon the placement of a prescription bottle in the recessed aperture and on its inner bottom planar surface. Upon this action, the detector may initialize a software program to cause the activation of the device motor to rotate the inner bottom plane and cause the capture of coded information (such as bar code) upon the alignment of the information with the reader. The bottle label, inner bottom plane, and reader portion may all utilize the present invention alignment marks to further facilitate the efficiency of capturing the appropriate coded information.

The purpose for another present invention embodiment of a code reader as described herein is to account for a variety of users and for providing the best utility for the users.

The embodiments of the main device described herein may be comprised of, but not limited to being comprised of, the following: a double side circuit board; a 120V/6V power transformer; a 120V 1A fuse; a 5V 1A voltage regulator with shutdown capability; a 1A power bridge rectifier; a 3V lithium coin cell battery backup component; a microcontroller (high end is preferable to accommodate present invention and future invention robust functionality); a crystal oscillator; associated connectors and cabling as appropriate per configuration; a key sealed touchpad; associated communications interfaces, chip sets (as described throughout the narrative), transformers, other magnetics, antenna, High Frequency passive elements, and sockets, as appropriate for the respective communications means; resistors and capacitors for the preceding; and an IR transceiver for the applicable medical device and/or scanner adjunct.

Another invention embodiment is to provide the means for the system 110 and its associated systems described herein to account for user interaction and health care provider personnel record keeping. For example, a program associated with reader 124, RFID, and/or OCR may request user or care provider practitioner confirmation that the medication or vitamin was taken. The request may be initiated by an audio (such as, but not limited to a chirp) and/or visual (such as, but not limited to a text message) prompt. The user or care provider practitioner confirmation may be registered by, as previously noted, having the user or practitioner press a button that may be located on a panel comprising one or more buttons that may reside above, below, and/or on the side of a display screen that may reside on or near the reader (which may be located on, but not limited to, a cabinet door mount). The button may be highlighted by a field that may be seen on the display alongside the button. The user input means may also be, but not limited to, speech recognition or voice command based input prompts. The user input means may also be comprised in a variety of networked device embodiments which may range from a present invention interactive and networked battery-powered button, ZigBee transceiver and light assembly that may be adhered to a medicine bottle cap to a present invention interactive and networked first aid kit that may also be in a variety of embodiments, such as, but not limited to, comprising an integrated battery-powered ZigBee transceiver and assembly that includes a processor, wherein said processor is connected to a circuit that terminates into an input button assembly and a circuit that supports a light bulb assembly.

The means for prompting user input also provides user and/or associated health care providers with greater utility in tracking practitioner and patient care. For example, at minimum, the practitioner may have a bar code label on a badge or wallet card identifying the name of the practitioner as a means for registering the practitioner information with the drug administration program for a number of uses such as, but not limited to, record and quality administration purposes. The user or patient may also have the form of identification. The purposes for the information may vary pending on the location (at one's residence versus an elder care facility) and circumstances and thus may present other applicable present invention embodiments such as the means to provide a medicine lock box that may not be accessed by anyone other than an authorized card holder or a health provider from a remote facility via a server, communications and processor link to the lock box.

The uses and services associated with the present invention medical and health systems and components described herein may also be considered as invention embodiments where the information may be utilized or incorporated, in whole or in part, with existing or new services from a variety of health services, pharmaceutical, and information technology industry entities such as, but not limited to, a web site health and/or health care provider or institutional health and/or medical provider. The services may be, but not limited to, alert, notification, medical home care administration, and/or monitoring services or in medication ordering services, programs or functions. In addition, the services, in whole or in part, may also be associated with environmental safety and/or security services system providers and systems such as the present invention environmental and security sensor and alert system(s).

Other Medical Devices, Biosensors, Wireless and Wired Mediums:

Another group of present invention medical and health embodiments that may work in conjunction with the main device 10 are various types of infusion and/or medication drip devices.

One application that may utilize the exception and/or threshold and execution program embodiments of the present invention system is related to hospice care pain management. For example, in-home care terminally ill patients require physician approval and third party intervention for increasing pain killer medication (such as morphine) dosage. There are obvious reasons for this current practice; however, there are costly inefficiencies associated with this practice.

The present invention system may be adapted for providing more rapid care to the terminally ill patient while removing inefficiencies with the current practice. The components that provide the means for the preceding benefits are the following: a main device 10; at least one communications component and program; at least one program and processor with at least one counter function and dosage and frequency threshold; an interface (including wired and/or wireless communications) to a medication drip/infusion device; and a medication drip/infusion device.

An example of the use of the present invention embodiment is described herein. A patient may have access to administering a morphine drip by depressing a button which is connected to a gauge and/or processor that measures a medication amount to be released based on predetermined and patient input. The processor may communicate the information to another processor and/or initiate a program counter and logic flow that results in either releasing a certain amount of medication intravenously or blocking the medication release because preset dosage and frequency parameters may have been exceeded. This processor functionality may take place in a present invention standalone medication device or a device integrated with main device 10. A communications function may take place in association with this application under the following conditions: the counter program may reach a setting to notify a physician or service when a threshold amount of dosages have been taken over a certain period of time and/or there are a particular amount of dosages left within a certain period of remaining time and communicate the information via a wired and/or wireless means; the program blocks a medication release; and/or there is a device malfunction such as the medication drip dispenser does not send a signal acknowledging that a medication amount has been released. Other related present invention embodiments associated with said main device and/or a remote server may range from comprising networked stents that release pharmaceutical agents that may emit a low frequency communications signal upon the release of said agent, wherein said signal may be received by a compatible receiver wherein said receiver may be comprised in a battery powered wearable pendant that may comprise a processor and ZigBee transceiver chip set, where upon the receipt of said signal, said processor activates a program that communicates a message over said ZigBee chipset to the present invention main device, to comprising networked valvular prostheses that may be comprised of electro-active polymers that may be triggered upon the transmission of a signal that may originate from a web server to said main device to said ZigBee pendant to said radio frequency receiver that is connected to a circuit which is connected to said electro-active polymer configuration.

Another invention embodiment that provides greater utility through a main device 10 is utilizing the device in conjunction with at least one biosensor and a biosensor transmitter. In this application, a biosensor may be measuring an analyte level such as blood sugar and communicating the data from a biosensor transmitter to a reliable and secure wireless transceiver, such as, but not limited to, a ZigBee transceiver for a clear throughput transmission over a low cost protocol network or subnetwork, such as ZigBee, to a ZigBee transceiver which may be connected to at least one processor on a main device 10. The latter is an affordable and efficient network means for supporting wireless medical applications, especially for in-home and assisted living patient care, as well as hospital and institutional care via the preferred present invention embodiments of either a ZigBee-based network or a hybrid Wi Fi and ZigBee network. For example a ZigBee protocol data frame may support 104 bytes of application-defined information, such as an analyte reading and other identifying information. The reading may be communicated from the biosensor processor to the ZigBee transmitter chip set. The biosensor/ZigBee transmitter may send the ZigBee packet frame to the main device 10 ZigBee transceiver chip set which recognizes the receipt of information from the biosensor via the ZigBee device address protocol, and processes the analyte information in the respective program associated with the biosensor device and/or biosensor transmitter device address. The processing of the information accounts for comparing the analyte information against a target and communicating commands associated with the program target level. One example of the commands may be to communicate a medication dosage back to an infusion device which may utilize ZigBee, Bluetooth, Wi Fi, ultra wideband (UWB) or other wireless and/or associated protocol means related to the patient and biosensor. Another command may be to dial out (if a modem is a communications component) a certain alert and notification to a third party or present invention remote server for contacting a variety of constituents, if a certain abnormal analyte reading was registered. Another command may be a reporting function to a service, the present invention remote server or the present invention USB connected medical health record previously noted in this narrative.

The significance of the preceding example of the present invention biosensor and ZigBee-based monitoring, communications and intervention system presents many benefits for users/patients residing at home, assisted living, hospitals, as well as other institutional facilities and their respective constituents and care givers.

The benefits will become apparent in the context of the following narrative as well as the overall present invention system described herein.

The present invention provides the means to support biosensors and detect analytes in a variety of forms for the purpose of communicating metrics or (a) triggered event or catalytic readings that may be associated with the biosensors and agents coupled with the biosensors to a main device 10 and/or other present invention component or entity for desired actions.

Biosensor innovations, applications and deployments have grown significantly in a relatively brief period of time, from the use of the devices in hospitals and other patient care facilities to assisted living and home use. Coupled with transmitters, especially a ZigBee or ZigBee-based transmitter as claimed in the present invention described herein, they may provide greater utility in numerous embodiments, such as, but not limited to, from implantable components to non-invasive embodiments, to disposable devices, to material(s) of clothing (especially those materials comprising absorbent articles for detection of analytes in bodily waste, such as, absorbent articles that may be or be comprised in embodiments, but not limited to said embodiments, of diapers, undergarments, panty liners, training pants, bed pads, training pads, sanitary napkins, tampons, colostomy bags or pouches, undergarments, undergarment pads, briefs, brief pads, inter or intralabial apparatuses or devices, incontinence pads, and/or breast pads), to other wearable articles, to a variety of other items that may be in contact with the body (from cotton swabs to bandages, bandage wraps, casts and/or slings), to components that remain at a certain distance from the body (from measuring analytes from one's breath to detection and/or marker strips on containers), to components used in more complex diagnostic devices. They may also be coupled or bonded with other chemical agents or membranes for a variety of applications.

There are a variety of published papers, measurement methods, fabrication methods and biosensor products that support the preceding biosensor forms and applications.

The present invention is adaptable to support the biosensors noted herein and, again, is not limited to accommodating solely those forms. For example, in relation to a disposable item, the biosensor sampling component, means or processor lead/circuit may be in the disposable item and connected to the processor, power, and transmitter components which may reside outside of the disposable element. In this embodiment, an undergarment or diaper may include the biosensor disposable component and the component may be disconnected from an electro-chemical circuit lead that may be connected to a belt or pouch which may also contain the other biosensor and communications components, such as ZigBee-based components.

For the purpose of the present invention described herein, a biosensor is a device that collects data about a biological or physiological process. Such a device collects data by translating a biochemical interaction with a device agent into a physical signal. Its usual purpose is to enable detection of substances in body fluids, water, and air by producing either discrete or continuous digital electronic signals that are proportional to an individual or group of targeted analyte(s) or related group of analytes. In the context of the present invention described herein, an analyte may be an atom, ion, molecule, macromolecule, organelle, cell, protein, enzyme, antibody, antigen, mineral, acid, DNA or RNA fragments, and/or a pharmaceutical agent(s) or derivative(s) thereof that is being measured.

The benefits of utilizing biosensors over a network which includes low cost and reliable wireless means and/or in conjunction with the economical and user friendly components or interfaces of the present invention, coupled with the monitoring, reporting and intervention means of the system, may support a widespread acceptance of such a system. The applications of the components along with future biosensor breakthroughs are quite broad.

The biosensor and present invention components may be used for detecting, monitoring, treating and/or intervening on, but not limited to, the following: (a) a variety of diseases or conditions caused by the diseases such as, but not limited to:

heart disease, through detecting and measuring myoglobin, troponins, fatty acid binding protein, etc., or detecting an enzyme to enable notification and intervention regarding a potential cardiovascular problem; or cardiovascular and respiratory health (accounting for pre- and post-heart attack detection/monitoring, oxygenation, respirations, stroke detection/monitoring/intervention, pneumonia detection, sleep apnea detection)

renal disease, through measuring blood or urine samples for, for example, in-home or dialysis patients

diabetes, for example, as noted in other parts of this narrative, blood glucose levels

(b) a variety of infections or conditions caused by the infections such as, but not limited to:

urinary tract infection; bacterial infections through analytes such as, for example ESBL enzymes (for drug-resistant bacteria), yeast infections, ear infections, influenza, etc.

(c) a variety of cancers, such as detecting risk factors for cervical cancer by monitoring human papilloma virus from a pap smear, or bladder cancer through markers in urine such as a nuclear matrix protein called BLCA-4 which is in bladder cancer cells, or detecting prostate cancer through analytes in body fluids such as urine

(d) tracking the effectiveness of a pharmaceutical agent such as an antibiotic

(e) tracking stress through saliva sampling for cortisol or serotonin levels.

Some of the biosensors and related components associated with the preceding applications are available through firms or entities such as i-Stat Corporation, Motorola, Matritech, Affymetrix, Biacore International AB, Thermo BioStar, Inc. (for fertility monitoring and ovulation detection), Roche Diagnostics, and Johnson & Johnson, to name a few.

In support of providing an economical and effective means for facilitating reliable and widespread patient care, it is a preferred embodiment of the present invention system to utilize a ZigBee-based wireless communications network with the associated software and communications components for most of the biosensor systems associated with the present invention.

ZigBee is an open wireless network software layer protocol based on the IEEE 802.15.4 standard and is intended to support networking of a variety of devices, from lights to wireless smoke and CO2 detectors, to wireless home security, to utility metering. The network utilities associated with the preceding devices support similar data communications applications and networked infrastructure needs for the medical devices and/or interfaces described herein for controlling the devices and obtaining device status.

The ZigBee embodiment associated with some of the medical devices and/or respective interfaces of the present invention supports the functionality of sending a short burst of information if a trigger event occurs, such as an analyte reading or timer interval falling outside of a parameter range or a daily set of transmissions associated with device readings. This functionality also supports a key component for widespread acceptance of the present invention, which is economy. Many of the device interfaces associated with the present invention are designed for low power consumption, simplicity, low cost, and communicating small amounts of data, such as, but not limited to, meter readings, the type of meter, and the identification of the individual associated with the meter reading. These attributes match with a ZigBee network Reduced Function Device (RFD). For medical device wireless interfaces requiring additional functionality, the ZigBee standard accommodates such functionality through a Full Function Device (FFD). The FFD may also operate as a router and an overall network coordinator. In functioning as network infrastructure components, they may support a variety of network topologies, such as star, cluster tree, and mesh.

ZigBee, being designed for the hostile RF environments that routinely exist in mainstream commercial and industrial applications, supports the critical need for reliable communications associated with medical device and/or biosensor information. It incorporates an IEEE 802.15.4 defined CSMA-CA (carrier-sense medium-access with collision avoidance) protocol that reduces the probability of interfering with other users and automatic retransmission of data ensures robustness. Utilizing Direct Sequence Spread Spectrum with features including collision avoidance, receiver energy detection, link quality indication, clear channel assessment, acknowledgement, security, support for guaranteed time slots and packet freshness; ZigBee offers biosensor and medical device manufacturers and users a highly reliable, standards-based solution.

ZigBee-compliant products operate in unlicensed bands worldwide, including 2.4 GHz (global), 902 to 928 MHz (Americas), and 868 MHz (Europe). Raw data throughput rates of 250 Kbps can be achieved at 2.4 GHz (16 channels), 40 Kbps at 915 MHz (10 channels), and 20 Kbps at 868 MHz (1 channel). The transmission distance between a set of ZigBee devices may range from 10 to 75 m, pending on power output and environmental characteristics. The preceding range may be enhanced with repeaters. In addition, devices, as part of a variety of network topologies, may communicate through network nodes. A ZigBee network can support 264 nodes. The networks may also be linked through network coordinators to support extremely large networks. The present invention initial user targets of in-home, assisted living, hospital and institutional care facilities may be supported through the network size capacities.

ZigBee utilizes the four basic frame types defined in 802.15.4: data, acknowledgement (ACK), media access control (MAC) command, and beacon.

The data frame, as previously noted, may include up to 104 bytes. The frame is numbered to ensure the tracking of all packets. It also accounts for a frame-check sequence structure to ensure that packets are received without error. The present invention embodiments described herein may be designed around data packets comprising 20 bytes. This data load is recommended for use in a node that may comprise 30 like ZigBee transceivers.

Another key structure for the 802.15.4 standard is the acknowledgement (ACK) frame. It supports providing feedback from the receiver to the sender to confirm whether the packet was received without error. A ZigBee-compliant device takes advantage of specified “quiet time” between frames to send a short packet immediately after the data-packet transmission.

The MAC command frame supports the mechanism for remote control and configuration of nodes. It may be used to configure individual clients' command frames no matter how large the network.

The beacon frame helps support long battery life by waking up client devices, which listen for their address at differing cycles and go back to sleep if they don't receive it. Beacons are important for mesh and cluster-tree networks for keeping node synchronization without requiring the nodes to consume battery energy by listening for long periods of time. ZigBee networks may also comprise non-beacon functionality.

Security and data integrity are key components of ZigBee technology. ZigBee components such as access control lists, packet freshness timers and 128-bit encryption based on the NIST Certified Advanced Encryption Standard help protect data transmission. It leverages the security model of the IEEE 802.15.4 MAC sublayer which accounts for the preceding through four security services: access control (maintaining a list of trusted devices within the network; data encryption; frame integrity (to protect against modification by parties without cryptographic keys; and sequential freshness to reject data frames that have been replayed.

ZigBee devices may utilize low power consumption and may be battery operated with alkaline batteries.

ZigBee chip sets are available from Ember, Motorola and Atmel. The ZigBee Aliance (zigbee.org), an organization that promotes and supports the ZigBee standard, has over one hundred members.

Another set of invention embodiments that may utilize a wireless protocol such as ZigBee, very effectively and economically in conjunction with the present invention main device is associated with an oxygen device such as an oxygen tank or oxygen concentrator with its associated gauge and/or meter. The components associated with this invention embodiment account for the following: a main device; at least one communications component and program; at least one program and processor with at least one gas mix and gas level threshold; an interface (including wired and/or wireless communication) to a tank gauge or meter and/or concentrator gauge or meter; and a tank gauge or meter and/or concentrator gauge or meter and associated equipment.

In this present invention oxygen device embodiment, a meter processor may be measuring a concentrator gas mix and/or level or an oxygen tank gas level and communicating the data to a ZigBee transceiver chip set on either a low periodic and/or parameter exception basis which may transmit the data to a main device 10 chip set which is connected to at least one processor on the main device 10. Upon main device 10's receipt of and recognition of the ZigBee transmission from the oxygen device ZigBee transmission via the originating address code in the ZigBee frame, the main device 10 ZigBee chip set relays the oxygen meter information to the main device 10 microcontroller. The processing of the information may account for comparing the gas mix or level information against a target and executing a command set program associated with the comparison result. One example of the commands may be to communicate a reorder of oxygen to a present invention main and/or remote server. The server, upon receipt of the oxygen reorder message from a certain user's main device 10 (where the message may comprise appropriate and associated login and user member information) may generate an order to the supplier/service entity which supports the user or user member health plan.

### Other Networked Embodiments

ZigBee or similar reliable, coded wireless embodiments may be comprised in other present invention embodiments (as noted in previous provisional patent filings) to enhance the living area in which the patient or user resides or works and support additional utilities, such as, for example, security functions. For example, decorative present invention multi-utility enclosures such as, but not limited to, vases, urns, appliances, fixtures, bases, stands, and/or pedestals may comprise a present invention system of integrated modules such as, for example, a motion detector, a controller processor and timer, an electric air freshener, and/or a ZigBee chip set and associated components, or other wireless communications components, whereas upon the opening of an entryway door, the motion detector may activate a motion detector circuit lead that may connect to a controller circuit lead which may activate a preset program (from a table of programs) to turn on an air freshener and/or transmit, for example, (a) ZigBee frame(s) to activate a certain light or set of lights. The controller program may activate a timer circuit lead that may connect to an air freshener circuit lead and the lead may remain in an on state for a preset period of time. The ZigBee transmitting function circuit connection may be shut off by the timer circuit upon the timer processor's receipt of an acknowledgement from the remote light ZigBee chip set that the frame was received where the acknowledgement is received by, for example, the pedestal ZigBee chip set module and the acknowledgement is relayed to the controller processor. Upon the conclusion of the timer interval associated with the air freshener and/or remote light(s), the controller processor may shut off the timer circuit lead electrical signal powering the air freshener, thus causing the freshener to shut off. Upon the conclusion of the timer interval associated with the transmission connection to the ZigBee chip set, the connection may be activated for receiving a signal from the timer.

One of the purposes for the acknowledgement relay and timer circuit disconnect is to support a remote light staying on for a certain period of time, as governed by the timer program, in the event that another family member or pet activates the motion detector where the activation may have caused the transmission of a ZigBee packet to activate the light switch where the activation may shut off the light before it is desired to do so. Another means for removing the latter potential problem is accounting for a present invention intelligent light processor that upon receiving a coded wireless command set (such as a ZigBee frame) may send the instruction to a processor that governs light operation where upon the receipt of an instruction frame command to turn on the light, compares the command with the state of the light circuit connection by having the circuit connection having a lead and associated components terminating into the processor. In the event that the light circuit connection is in an on-state, the light processor does not change the state of the light circuit. Should the light circuit connection be in an off-state, then the command set would activate the processor to activate the light circuit relay lead to turn on the light.

Another means for activating multiple functions in place of or in conjunction with a motion detector module in the preceding present invention is a personal communicator receiver module. The module may be in a variety of embodiments such as, but not limited to, a personal wireless car key receiver, a Bluetooth receiver, an infra-red receiver, an RFID reader, a ZigBee receiver, a UWB receiver, a cellular network receiver, and/or a Wi Fi receiver. The module may receive transmissions from a variety of personal communicator embodiments, in part or in whole, such as, but not limited to, a cell phone, a smart phone, an RFID tag, a PDA, a pocket PC, a wireless key, a smart card, a wearable item such as a piece of jewelry, ring, watch or pendant with a wireless data communications means, such as, but not limited to, a RFID chip set and transmitter, and power means. The receiver module may be integrated with the other present invention modules of the present invention multi-utility enclosure and may be supported by associated enclosure apertures and framing, powering, communications, circuitry and securing means. The receiver module may also comprise a data communications means and/or interface to the present invention controller or timer program processor. Upon the receipt of at least one data packet where the packet may identify a certain individual and may originate from, for example, that individual's personal communicator transmitter to the present invention's module receiver to the present invention's controller or timer module processor, the processor may activate a program that comprises the activation of one or more modules associated with the individual's interests, profile or transmitted command(s). The activated modules may be within the enclosure or remote from the enclosure. The activations may range from those noted in the preceding paragraphs to room temperature settings, to present invention wall outlet plugs for activating, for example, lamps or electric air fresheners, to kitchen appliance activation to air ionizer settings and activations to networked, automated, movable shelving, closet conveyor, and/or carousel settings, positions and/or rotations. In addition, the personal communicator transmission may also include at least one data packet that may enable the activation of a security or medical or environmental mode program which supports another utility for the modules as described in the following paragraphs. The communications means that supports the multi-utility enclosure and external apparatus utilities may be ZigBee, UWB, Bluetooth or other wireless data means, as well as wired means such as HomePlug or Ethernet compatible networking, or a combination of the preceding. The preferable wireless embodiments for the preceding invention embodiments are ZigBee and RFID-based configurations.

The security or alert utility for the present invention multi-utility enclosure configuration described in the preceding paragraph provides additional benefits for a variety of users. The apparatus which enhances a living or work space area during certain periods of the day or evening as previously described, may also serve a dual purpose as a security or alert enhancement. In a security function mode, the motion detector module, upon the detection of motion, may activate a circuit connection to the controller and timer module processor, where the connection may activate a preset program (from a table of programs), which in this example mode, is a security mode program, where the program executes the controller processor to transmit, for example, a ZigBee network chip set address or set of addresses over a data circuit connection from the controller processor module to the ZigBee wireless communication module. The ZigBee network address(es) may be associated with ZigBee communications receivers that are connected to alarm or alert data circuits or circuits that may activate an alarm, alert or processor function associated with the receipt of the signal.

Another mode embodiment associated with the present invention utilizes a mode command to generate a specific program. This mode command is especially useful for communicating necessary action from a Home Area Network communications device in the event of an emergency, where the mode function may support an optimal (and)/or backup communications means. For example, a present invention wearable alert apparatus, such as, but not limited to, a pendant, may comprise at least one button and communications processor and transmission means where the transmission originating from the pendant may comprise a series of destination addresses and content data packet, where the data packet may contain a medical mode command, where one destination or primary address may be to a main device 10, which upon receipt, processes and generates a series of outputs to support a desired response, and another address may be a backup address which may be to, for example, a multi-utility enclosure (such as, but not limited to, a pedestal) communications module and timer and controller module which may receive, process and generate another series of outputs that may utilize some or alternate devices or instructions to support the backup actions in the event that the primary source or apparatuses associated with the primary source encounter an operational problem. The mode command application may also apply to an environmental and alert apparatus or system.

The administration and setting of(a) preset program(s) that may be associated with either security or medical or environmental or other mode functions may be administered by four means: 1) a local communication means by a user through a variety of devices, such as the variety of previously described present invention personal communicators or remote controls; 2) a remote means through a remote server which may receive input from a variety of sources with appropriate security and authentication logins; 3) through a timer program, as described further in the narrative; or 4) through an administration/keypad interface.

The following narrative section and associated illustrations will describe this decorative present invention security and environment enhancing embodiment in more detail. The purpose in covering the apparatus in more detail in this section, which has accounted for mostly medication and health monitoring and alert system narrative, is to support the use of the apparatus in the system to support the acceptance and use of sensor monitoring and alert systems while minimizing intrusive effects, by enhancing a patient's or user's living area with functionality such as, but not limited to, emanating a fragrant scent. Further in the narrative, another application will be illustrated to support the added utility benefits of the sensor system apparatus.

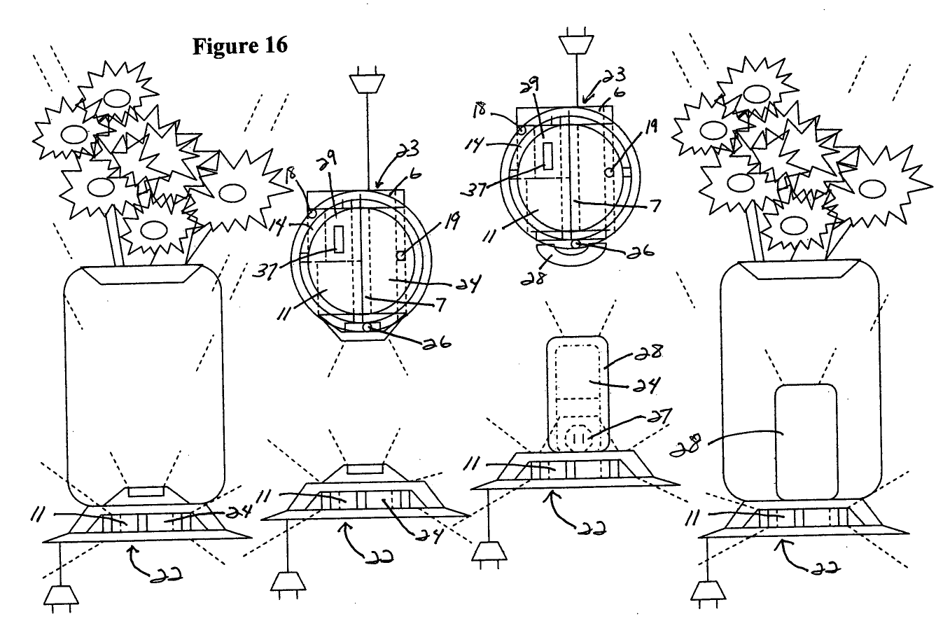

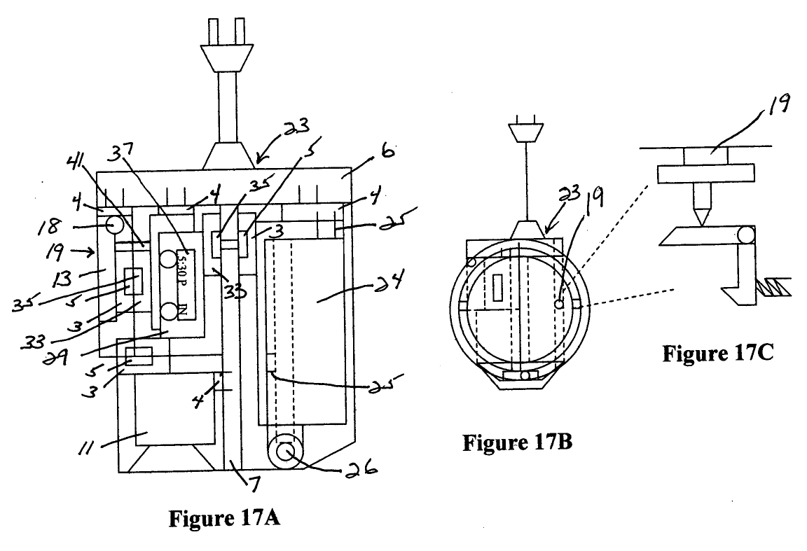

One present invention system embodiment that may support sensor and alert system acceptance and enhance a living and/or work area with the modularity and integration characteristics described herein is a chemical and chemical dispenser component such as, but not limited to, an electric air freshener component and/or module 24 (FIGS. 16 and 17). This module 24 may be connected within or to a multi-utility enclosure system, such as, for example, a pedestal embodiment with other module components to comprise new invention systems, such as, but not limited to, a multi-utility enclosure flower vase pedestal 22 (FIGS. 16 and 17). This system may utilize, among a variety of other modules, a motion detector component and circuit functionality along with a processor controller and timer module and circuit. One application associated with one form of this embodiment is an example of a motion detector triggering a communication to activate lights upon an entry way door being opened. In addition to the lights being turned on upon the opening of the door (given that a preset program supporting the function is activated), a timer function may be activated as a result of an electric signal connection originating from the motion detector module, transmitting over the circuit termination between a motion detector module 11 (FIGS. 16 and 17) and a controller and timer module 29 (FIGS. 16 and 17) to the controller module processor. The activation of the timer module may cause the activation of a timer and a circuit connection from the timer to an air freshener dispenser heating unit, where the heating unit may be activated by an electric current originating from the timer and traveling over a circuit and circuit connecting interface between the timer module and the electric air freshener module. The activation and operation of an air freshener heating unit would cause the emission of an aromatic scent from an essential oil residing in a container (which is also modular, interchangeable and interconnecting with the air freshener electrical and heating housing component) and emanating out of the container through a vapor permeable plastic composite conduit such as, but not limited to, a wick that resides along the bottom portion of and protrudes upwardly out of the container through a top portion of the air freshener module. The heating unit may be on for a designated period of time, governed by the timer module, at a designated diffusion setting, which may be set manually (by accessing the underside of pedestal 22 or through a top portion aperture of pedestal 22). Other invention embodiments may account for a controller processor and air freshener connector that may comprise circuit leads that account for diffuser settings whereby the diffusion level may be activated or changed through the processor controller. The processor controller may also change a different scent emanation by integrating with components capable of said functionality.

The relevance of performing the preceding functions through modular components associated with a pedestal may have a variety of significances when the pedestal may be associated with supporting a-vase that contains silk or some form of artificial flowers or fresh flowers. For example, a vase may contain silk roses, and the pedestal associated with the vase may have an aromatic dispenser module emanating a rose scent, in addition to other modules and associated functions. These functions, when performed through an integrated modular means as described in the previous example, provide even greater utility and benefits to the user, such as, from extending the life of the air freshener essential oil to serving as a security entry way sentry when the motion detector interacts with the controller processor in a security mode program or as a backup medical or, for example, fire alert (and)/or communications safety support device, where the embodiment comprises the associated timer and controller module program, along with the associated communications module with software enabled receiver and multi-address transmission means, such as a ZigBee chip set and associated components.

FIGS. 16 and 17 illustrate the application stated in the preceding paragraph and the following flower vase pedestal 22 modules in mostly block form: motion detector 11; timer and controller 29; communications component 14; electrical housing 23; and air freshener 24.

Flower vase pedestal 22 is comprised of the following components: an exterior housing with a variety of apertures; an interior modular frame with slots for a variety of modules and module release buttons 19; an electrical housing 23 with a back frame 6 and a center frame 7.

The exterior housing may be in a variety of shapes and designs, such as but not limited to, from a contemporary form which is depicted in FIG. 16 to a more ornate and intricately detailed form whether it may be, for example, Oriental with associated carvings or a part of a ceramic figurine. The housing comprises at least one horizontal planar surface to support a flower vase. It may also be composed of a variety of materials such as, but not limited to, inexpensive moldable plastic composites, pottery, clay and/or more expensive porcelains or woods with a variety of finishes and possible inlays (such as precious minerals or woods).

The exterior apertures support modular functionality, housing, venting and exterior design. Apertures on the front facing and side portions may support motion detector motion sensor functionality, wireless module communications, module ventilation and design. The back side consists of one aperture area to support the electrical housing back frame 6 and electrical cord connections. Top apertures may be located in four areas: the main planar surface area (for certain pedestals); the top front; the top sides; and the top back. The main planar surface may comprise apertures for the module release buttons 19 (which will be covered further in this narrative) and the timer module 29 input and output means 37. The top front apertures may be for an air freshener diffuser component and aeration, ambient sensor functionality and module ventilation. The top side apertures may be for ambient sensor functionality and module ventilation. Certain pedestals may also have top side apertures for an air freshener diser component and aeration. Certain pedestals may have a top rear side or corner component for wireless communications antennae (as needed, pending on the wireless application). The top back portion apertures may be for module ventilation. An optional aperture cover component for covering top component non-aeration apertures that are associated with modules that the user may plan on purchasing in a subsequent period may also be available for the pedestal. The underside of the exterior housing component is primarily hollow with interconnecting components such as, but not limited to, inserts, grooves and clips to accommodate the various invention module embodiments associated with the present invention.

The interior modular frame is comprised of an outer frame component with slots to accommodate modular inner chamber frames and interconnecting components such as inserts and clips to secure the frame to the underside of the exterior housing component. The outer frame component consists of a front and side portions. Preferably, there is no back or rear portion, because the open area may be used to accommodate an electrical housing 23 back frame 6. The modular inner chamber frames may be comprised of cross braces with interconnecting components such as slots for connecting to the outer frame and modules and also projected movable clipped interconnecting components for securing and releasing module components.

There are a variety of embodiments and interconnecting means for comprising and supporting the securing and releasing of modules to the variety of present invention enclosures, pedestals and bases.

An illustration of one embodiment, out of a variety of many embodiments, for a movable interconnecting component is depicted in the air freshener illustration, FIGS. 17A, B and C. FIG. 17C depicts a side view of a module release button 19 and its associated movable components. Release button 19 has a top portion that is primarily flush with the pedestal top main planar surface with recessed sides that fit within a wider aperture located on the underside of the associated exterior housing area. The button 19 has a bottom portion that resides slightly off the center of the top portion of a hinged clipped interconnecting component (the button bottom portion is on the opposite side of the hinged means). The bottom side of the hinged component that is on the opposite side of the bottom clip portion has a spring pushing against it. The spring is in a recessed holder that comprises an upper enclosure that supports the cross hinge that connects through the clipped interconnecting component. The holder is part of the inner modular frame. The operation of the components described in this paragraph will be covered in the air freshener module narrative.

The interior modular frame and its associated components such as the module slots and module release buttons 19 may be comprised of inexpensive durable and moldable plastic.

Referring now to FIG. 17A, the electrical housing 23 is comprised of two primary components: a back frame 6 and a center frame 7. The frames provide a means and configuration for electrical current to transit through the present invention modules. The frames have electrical interconnecting means and settings (such as, but not limited to, dip switch settings) to support a variety of inter and intra module electrical connections.

The back frame 6 component may be comprised of module electrical connector (primarily female plug receptors) components and a central electrical housing component with electrical connector feeds to the back frame module electrical connectors, the center frame 7 main electrical connector, and the main electrical cord or electrical cord connector. The back frame 6 may comprise at least one setting (such as a dip switch or on/off setting) for supporting (an) electrical module connection(s) in an on or off state. One of the purposes for the setting is related to the operation of an electric air freshener module (which will be explained in the air freshener portion of the narrative). The central electrical housing component comprises the electrical connector feeds to the electrical components previously cited in this paragraph. Back frame 6 may comprise a low cost durable plastic and/or rubber for the frame/housing that supports the electrical connector components, and electrical conducting materials such as copper for the electrical connectors.

The center frame 7 is comprised of most of the components and materials of back frame 6 with the exception of the receptacle/housing and connectors for the main electrical cord. In addition, frame 7 may comprise at least one aperture for supporting a module-to-module electrical and/or data connection. An example of the purpose for the aperture may be to support an electrical timer module power connection directly from the module to an electric air freshener module.

Both frames 6 and 7 may connect to the inner portion of the exterior housing and the interior modular frame through a variety of interconnecting components such as but not limited to, inserts, clips, screws and grooves. The preceding interconnecting components may also be adhered to the respective frame connections by glue or other bonding means.

The motion detector module 11 is comprised of the following components: motion sensor 1; main electronics and circuitry 2; module interfaces 3; an electrical housing interface 4; circuitry settings 5; and an exterior housing. The motion sensor 1 is comprised of sensing circuitry, conducting and connecting components and materials. Sensor 1 connects to the main circuitry component 2. The main circuitry component 2 is comprised of circuitry and circuitry connectors to circuitry settings 5, module interfaces 3 and the electrical housing interface 4 and associated circuitry, conducting and connecting materials. The module interfaces 3 may be comprised of male and/or female electrical connectors, and associated receptacles and housings. The interfaces 3 are comprised of currently available conducting, resisting and connecting circuitry materials such as, but not limited to, copper, and plastic and rubber composites. The electrical housing interface is comprised of electrical conducting and resisting materials, such as, but not limited to, copper and consists of a male plug and resistor for interfacing to the electrical housing. The motion detector circuitry settings 5 are primarily for setting on and off states for the respective detector module interfaces 3. These settings may be comprised of dip switches with a plastic outer housing and electrically conducting or resistant connectors. The module 11 exterior housing may be comprised of, but not limited to, a moldable plastic material or hard synthetic rubber composition. The exterior housing comprises interconnecting components such as, but not limited to, clips for holding the module components, especially the circuitry and connecting enclosures in place and secured from undesired external exposure. As appropriate, some of the exterior housing fastenings may be adhered to other component interconnectors by a bonding means or compound such as, but not limited to, glue.

The operation of motion detector 11 may be illustrated in the example noted in this paragraph. Upon receiving current traveling from the wall socket to the male plug of the pedestal 22 electric cord, where the cord may terminate into the back frame 6 central electrical housing component, and the current travels through the back frame 6 electrical connectors and the center frame 7 electrical connectors and may travel from frame 7 into the detector 11 electrical housing interface 4, where the current travels through the detector 11 circuitry, the detector is in an active state. Upon the opening of a front door, which is located in proximity to the pedestal 22 which comprises motion detector 11, the sensor unit 1, originates an open circuit connection from 1 to the main circuitry component 2, the connection travels out towards the module interfaces 3 and may reach the interfaces 3, pending on the circuitry settings 5 settings for continuing or breaking the circuit connection. In the configuration embodiment described herein, the circuitry settings 5 are optioned to support electrical connection solely to the controller and timer module 29, where the module comprises a processor for supporting security and/or non-security enabled functions. Given that the present invention accounts for this module in a variety of enclosures and may be interconnected, integrated and/or associated with a variety of modules, it supports additional circuitry and processor designs to support a variety of configurations and functions.

The controller and timer module 29 may comprise the following components: processor, program, main electronics and circuitry 30; timer program and circuitry 31; module interfaces 33; electrical housing interface 35; input and output means 37; data circuit 41; circuitry settings 39; and an exterior housing. The controller and timer module 29 is comprised mostly of the same circuitry and connecting materials that are comprised in the motion detector module 11. The distinctive circuitry is associated with providing data communications through data circuit 41 from the processor 30 to the communications module processor 13. In addition, the input and output means may be comprised of a variety of components and materials. One embodiment of means 37 is comprised of a planar interface that has a LED display and at least one input button and at least one program sequence or step button. The means 37 may be comprised of a translucent and durable hard plastic display component and other durable plastic and/or rubber materials. The timer program resides on a processor 30 with input and output components that are connected to the input and output means 37 and the module 29 circuitry. The circuitry settings 39 are comprised of the same materials and components of the settings 5 that are associated with the motion detector 11. The module 29 exterior housing may be comprised of, but not limited to, a moldable plastic material or hard synthetic rubber composition. The exterior housing comprises interconnecting components such as, but not limited to, clips for holding the module components, especially the circuitry and connecting enclosures in place and secured from undesired external exposure. As appropriate, some of the exterior housing fastenings may be adhered to other component interconnectors by a bonding means or compound such as, but not limited to, glue.

The processor 30 and timer program and circuitry 31 may support a prompt-based user input function of programs and sub-programs for each module device that is interconnected (either within or external to the pedestal 22) to module 29. The present invention accounts for a Set program and an Interval program.

An example of the operation of the program consists of the following for setting the operation of an air freshener module which is identified as Device 1. The display of input and output means 37 may display the time of day, such as 5:30 P above a step or sequence button that may be located on the bottom left side of the display. On the right side of the display, the characters IN may be displayed above the input button that may be located on the bottom right side of the display. Upon pressing the input button, the left side displays, ALARM. Depressing the input button associated with this prompt would enable the user to initiate a timer program for the start and stop times and days associated with activating a communications transmission to at least one alarm device upon the receipt of an electrical signal generated by the motion detector module 11. Upon pressing the step or sequence button associated with the ALARM prompt, the prompt, DEVICE 1, is displayed. Upon pressing the input button associated with the DEVICE 1 prompt, the left side displays, SET 1 (which is for the first time setting for device). The next input button depression displays, TIME. Upon the depression of the input button, the word, START, is displayed. The depression of the input button causes the word, HOUR, to display. The next character displayed is the number, 1. The user may either depress the input button to set the start hour at 1 or depress the step button to scroll through the number characters to the desired start hour. If the user desires to set the air freshener to turn on at 6:30 PM, then the user scrolls to 6 and depresses the input button. The next set of characters displayed are, MINUTE. Upon the depression of the input and step buttons in the manner described in this paragraph, the user sets the start time for 6:30 PM and the next display sequence is STOP. Upon the final input of the stop time, the next display item is, DATE. If the user desires to not set a date, the user may depress the step button for the display of, SET 2. If the user desires no other designated setting time for the air freshener, the step button may be depressed for the display of, RANDOM. If this function is not desired, the depression of the step button displays the word, INTERVAL. The purpose for the INTERVAL function is to set the duration for powering the specific device or module (DEVICE 1) that is connected to the timer module 29. The user, following the preceding logic functions stated in this paragraph, may set the power interval for one hour and fifteen minutes, by depressing the input button upon the display of the word, INTERVAL, then depressing the input button upon the display of, HOUR, then depressing the input button upon the display of, 1, then depressing the input button upon the display of, MINUTE, and finally keeping the step button depressed until the number 15 is shown on the display, the user lifts his/her finger from the step button and depresses the input button. The display then shows the characters 1 H 15M and the user depresses the input button to set the air freshener to operate for one hour and fifteen minutes upon the activation of the motion detector module in pedestal 22.

The communications module 14 is comprised of the following main components: transceiver, processor, and main electronics and circuitry 13; module interfaces 3; an electrical housing interface 4; circuitry settings 5; antenna 18; a data circuit 19; and an exterior housing. The transceiver 13 may be connected to an antenna 18 that resides within the module 14 housing or resides outside of the housing 14 and protrudes upward from a rear corner aperture of the pedestal. The antenna may be no more than three inches. The communications module 14 is comprised of the same circuitry, interface and connecting materials that are comprised in the motion detector 11 and timer 29 modules. The circuitry settings 5 are comprised of the same materials and components of the settings that are associated with the motion detector 11 and timer 29 modules. The transceiver, processor and main electronics and circuitry 13 may support and comprise, preferably, ZigBee components or other wireless protocols, such as, for example, Bluetooth or Wi FI, as well as wired communications components. The module 14 exterior housing may be comprised of, but not limited to, a moldable plastic material or hard synthetic rubber composition. The exterior housing comprises interconnecting components such as, but not limited to, clips for holding the module components, especially the circuitry and connecting enclosures in place and secured from undesired external exposure. As appropriate, some of the exterior housing fastenings may be adhered to other component interconnectors by a bonding means or compound such as, but not limited to, glue.

The module 14 transceiver, processor and main electronics and circuitry 13 connects to the module interfaces 3, the module 14 electrical housing interface 4, circuitry settings 5 and the antenna 18. The module interfaces 3 associated with the circuitry in this narrative sample configuration are connected to the controller and timer module 29 and the motion detector module 11. An open circuit connection is associated with only one module, the module 29. The module 14 electrical housing interface is connected to the back frame 6 electrical connector receptacle. The circuitry settings 5 are set for open circuit connections (since the motion detector 11 setting associated with the interface for module 14 is closed, no contact will be transferred from module 11 to module 14). The data circuit 19 is for connecting the processor 13 to the controller and timer module 29 data circuit and processor.

The operation of the communications module 14 that is associated with the present invention integrated module configuration described herein is based on the electric power source connection that transits into the module electrical housing, through the main circuitry and to the transmitter component; and a circuit connection from the timer module which is originated from the motion detector module 11.

The air freshener module 24 is comprised of the following components: main circuitry 13; module interfaces 3; an electrical housing and interface 4; circuitry settings 5; heating unit and transfer plates 25; chemical agent cartridge and vaporizer conduit 26; and an exterior housing for the electrical, circuitry and heating components. The air freshener module 24 is comprised of the same circuitry, interface and connecting materials that make up the respective like components in the other present invention modules. The circuitry settings 5 are also comprised of the same materials and components associated with the settings that reside in the other present invention modules. The heating unit and transfer plates 25 are comprised of components for supporting a small heating unit means such as, but not limited to, a coil resistance heater or a metal oxide resistance heater as well as electrically conductive material such as copper for the transfer plates. The chemical agent cartridge and vaporizer conduit 26 may be comprised of a translucent hard plastic material for the cartridge for displaying (in this illustrated invention embodiment) a liquid form agent and a vapor permeable plastic component for the conduit which may be, but not limited to, a wick. The module 24 exterior housing may be comprised of, but not limited to, a moldable plastic material or hard synthetic rubber composition. The exterior housing for the electrical, circuitry and heating components comprises interconnecting components such as, but not limited to, clips for holding the module components, especially the circuitry and connecting enclosures in place and secured from undesired external exposure. As appropriate, some of the exterior housing fastenings may be adhered to other component interconnectors by a bonding means or compound such as, but not limited to, glue.

The module 24 main circuitry 13 connects to the module interfaces 3, the module 24 electrical housing interface 4, circuitry settings 5; and the heating unit transfer plates 25. The module interfaces 3 associated with the circuitry in this narrative sample configuration connect to the controller and timer module 29. The circuitry is secured in place through the fastening and support means of the exterior housing assembly. An open circuit connection is associated with the module 29. The module 24 electrical housing interface is connected to the back frame 6 electrical connector receptacle. The back frame 6 electrical connection may have an off switch setting that is associated with module 24 for this sample configuration, because the power source for the module is generated from the controller and timer module 29. As previously noted for this respective configuration, this module 29 to module 24 connection is supported through an aperture in the electrical housing 23 center frame 7. The circuitry settings 5 are set for open circuit connections. The heating unit is connected to the transfer plates. The heat transfer plates are connected to the main circuitry 13, the electrical housing interface 4 and the heating unit. The chemical agent cartridge may be connected to the module 24 exterior housing through a variety of interconnecting means that support attachment to and detachment from the housing. The means may be male protruding edge components and female grooved slots. Additionally, the cartridge may also be held in place through the movable interconnecting means supported by module release buttons 19 and associated components. The vaporizer conduit associated with this invention embodiment 26 previously described in this narrative may reside along the bottom portion of and protrude upwardly through and out of a top aperture of the cartridge container. The conduit also passes through an aperture in the exterior housing where the housing area performs the following functions: supports an inner portion heat transfer component that may consist of parallel plates that, though concealed in the housing, surround a portion of the vaporizer conduit to facilitate evaporation; and also supports the venting and dispersion of the chemical agent through its structural form. The exterior housing, in addition to providing the structural support and connecting means for its contained components and the dispersion of the chemical agent or scent, also has a portion that connects to and may also protrude through a top exterior housing aperture of pedestal 22 as depicted in FIGS. 16 and 17.

The operation of the air freshener module 24 that is associated with the present invention integrated module configuration described herein is based on a power source connection that passes through the controller and timer module 29 and module 24 interface that is originated from the back frame 6 electrical housing connection 4 associated with timer module 29 that transits through module 29 circuitry out to the module 29 to module 24 interface upon the activation of an open circuit which may be caused by two conditions—the activation of a time and/or date set timer program and/or the activation of motion detector 11.

Upon the activation of a pre-programmed time start set program, the controller and timer 29 processor may open a circuit current for the circuit lead(s) that connect(s) to the module 29 to module 24 interface. The electrical current may transit from the module to module interface to the module 24 circuitry and through the circuitry to the heat transfer plates. The heat transfer plates serve a dual purpose of conducting electricity and heat when the latter element is caused by the activation of the heating unit from the electric current that transits the heating transfer plates and terminates into the heating unit. The heating unit emanates heat in the direction of the heating transfer plates that may reside, though concealed in the module exterior housing, alongside the chemical agent container and, as previously noted, the vaporizer conduit that protrudes from the container. Even though the heating unit shuts off upon the loss of power due to a pre-programmed stop time, the scent emanates for a longer period from the stop time and the essential oil or other form of chemical agent lasts for an extended life.

As noted, the air freshener module 24 may also be activated by motion that causes the activation of the motion detector module 11. In this scenario, the electrical connection that originates from module 11, transits through the module 11 to module 29 interface and connects to controller and timer module 29 circuitry, activates the circuit lead that activates the controller and timer 29 processor to activate the interval program and open the circuit leads associated with the module interfaces 3 that are associated with the devices and/or modules associated with the interval program. The electric current traveling over the circuit leads and transiting to the module 29 to module 24 interfaces triggers the operation of the air freshener module 24 in the manner described in the preceding paragraph.

The air freshener module 24 in pedestal 22 is one embodiment of 24 which may be part of, but not limited to, a module enclosure, housing or networked device. This module embodiment may be in other forms as a standalone or networked (with other air fresheners, modules, sensors or other components) unit. Being networked, module 24 may be linked to processors and software and/or sensors to function at different emanation levels with different scents (for example, with a multi-cartridge oil and wick module or cleanser components. For example, an ambient light sensor may interconnect to module 24 and a sunrise may activate a program to emanate a coffee scent. Another example may be a module comprising or being connected to a device comprising a timer or timer parameter where the module may release a rose scent in the morning and a lavender scent in the evening. Being networked or integrated with other components, the air freshener module may be adapted for a variety of invention embodiments. Other invention embodiments may range from a decorative enclosure that may function as a night light and adapted for an air freshener module, to a jack-o-lantern enclosure with a flickering, dimmer and/or constant illumination component that may have an air freshener component that emanates a pumpkin scent or autumn scent, to illuminated (or non-illuminated) seasonal or holiday themed containers, vases, urns or like enclosures that may emanate a pine scent or pot-pouri scent where the scents may emanate from an air freshener with a timer or networked component that may cause the activation of the freshener. Another embodiment may comprise a means for providing an alert function when, for example, but not limited to the example, an essential oil quantity, mixture or level in a vial, cartridge, or chamber may be close to a near empty level. The alert function may be activated when, for example, a certain contact is not immersed in the oil component or a certain sensor detects a different chemical composition, and the contact or sensor causes a circuit connection for an alerting function to trigger the operation of an illumination, audio (such as causing a chirping sound), and/or communications component(s).

The communication may be generated through a pin activation on a data or electrical interface embodiment that may be integrated between the air freshener module 24 and the controller and timer module 29. The pin may be connected from a circuit relay in module 24 to a receiving circuit which may terminate in the module 29 controller processor. Upon the receipt of the contact signal, the module 29 processor may generate a program that activates, for example, a ZigBee transmission which may be addressed to a main device 10. The ZigBee transmission may comprise a message indicating the freshener liquid is at a certain level. Upon the receipt and processing of the message, main device 10 may activate a program which may generate a variety of outputs, such as, but not limited to, from displaying a message on the device 10 display and emitting a message alert beep to transmitting a communication to the present invention server 300 to transmit a text message to a user's PDA or, pending on the PDA configuration, transmit a communication that may generate adding a certain scent cartridge to a PDA Shopping List program. The originating message may contain more information when integrated with a present invention embodiment of an air freshener module 24 that may comprise a processor.

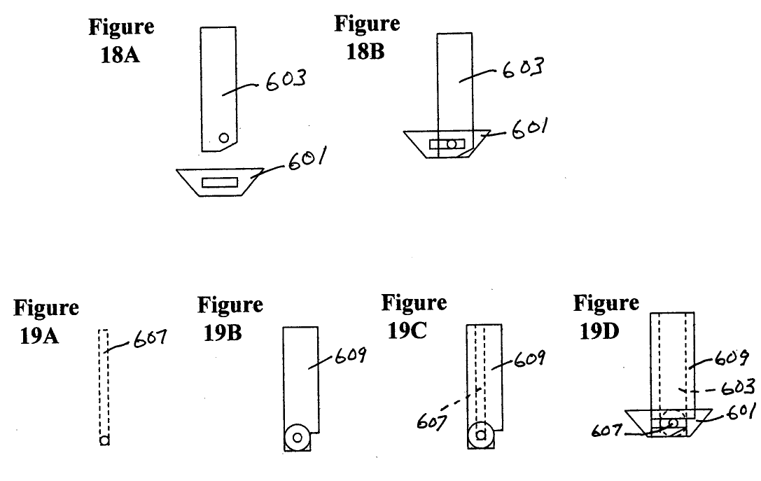

The air freshener module 24 is an embodiment of a chemical and chemical dispenser module component that may be in a variety of present invention embodiments, such as the air freshener components and enclosures described herein, as well as a present invention embodiment comprised of an insect repellant module that may be integrated or added to a fixed or portable outdoor lighting component. The dispenser modules may consist of a heating component or a spray component for diffusing the chemical agent. The active chemical agent, pending on the application, may, therefore, be functioning as any of the following: a fragrance; air freshener; deodorizer; odor eliminator; insecticide; insect repellant; herbal substance; medicinal substance; disinfectant; sanitizer; mood enhancer; aroma therapy composition; and/or a combination or like substance. It may be in liquid form, such as a volatile essential oil for an air freshener agent, which may be synthetically formed and/or naturally derived. An air freshener agent for the embodiments described herein may also be in gel or solid form. FIG. 18A and 18B show disassembled and assembled views of an air freshener exterior housing 603 and base 601; and FIGS. 19A through 19D show the wick 607 and cartridge 609 and combined unit including the air freshener housing 603 and base 601.

One of the present invention embodiments of providing the means to integrate an air freshener, motion detector, timer, communications component, as well as a security sentinel in a space-saving and electrical outlet-saving decorative enclosure such as, but not limited to, those described herein or pedestal provides a number of benefits to the end user. The convenience of having certain lights turn on along with having a pleasant, relaxing fragrance emanating from a decorative display in a non-cluttered entry way, upon the opening of a front door (especially an apartment front door, where space may be at a premium) and having the added security functionality when the preceding is in security mode or comprises a backup medical (and)/or environmental alert program, enhances the quality and safety for the end user (without having the basic concerns of having to navigate through a dimly lit apartment with bundles, a bag and/or a brief case or forgetting to extinguish a burning candle). In yet another embodiment of the pedestal and integrated module system described herein, said system may comprise a RFID tag reader that may be supported by a program that interacts with said motion detector and a ZigBee transceiver module. In one interaction, the RFID reader may activate a ZigBee transmission to a controller and timer that activates a certain mode program associated with the user who may be wearing a pendant with a RIFD chip set and transmitter, wherein said transmitter emits said RFID signal that is received by said RFID reader when said pendant is within proximity, for example, within 10 feet, of said reader. If said pendant emits a signal that comprises a data identifier that matches an identifier set residing in a memory table associated with said controller and timer mode program, the pedestal module configuration comprising a processor, memory and an RFID identifier table may also comprise a program that generates the transmission of a ZigBee packet associated with activating said mode program associated with said user. In another interaction, said activated motion detector may activate a program residing on at least one processor in said pedestal module configuration that performs an inquiry on whether the RFID reader received a RFID signal and whether said signal (if received) comprised a matching identifier. If said inquiry response comprises a null receipt or a non-match result, the associated program action may be to transmit to said controller and timer a standard motion detector activation packet, wherein said controller and timer would activate a program associated with the mode said controller and timer is engaged under at the time of the receipt of such transmission. The preceding RIFD and motion detector inquiry interaction sequence may support the convenience of a present invention system user to not have to disengage an alarm mode upon entering an alarmed entryway, if said user is wearing the appropriate RFID tag that supports said application functionality.

Pedestal 22 (FIGS. 16 and 17), like other invention enclosures, pedestals and bases described herein may have a number of embodiments to account for other various module configurations as well as accommodating existing standalone electrical (or electrical socket) fixtures or products (such as, but not limited to, night lights, bug repellents and air fresheners). For example, FIG. 16, also illustrates pedestal 22 with an electrical plug socket 27 (the pedestal may have more than one plug socket) and decorative modular and interchangeable housing 28 on its front portion (which also may have the configuration on other side or circumference portions), to accommodate, among other electrical socket fixtures or products, an air freshener or air freshener and night light combination. The electrical socket may be connected to an electrical connector which may be connected to a cord or a device controller component or a controller and timer module 29, which may also be connected with a motion detector module. The decorative modular and interchangeable housing 28 may be available in a variety of designs, patterns and colors to coordinate with vase, urn, or other vessel designs, forms, patterns or colors. The pedestal 22 may also have a circuit breaker and reset function to account for electrical loading and UL requirements.

To further enhance the living area associated with the preceding pedestal 22 description and illustration, the multi-utility enclosure embodiment modular system configuration may perform additional activations through the controller and timer module and the communications module. The embodiment of the controller and timer module program may comprise a day mode program that may be administered as a second step or sequence menu prompt, after the “ALARM” prompt, as described herein. The purpose for the day mode program is to generate certain activations upon a trigger or timer condition within a certain time range of (a) certain day(s) (and)/or twenty-four hour period. The mode program may also comprise other parameters as noted further in the narrative. The day mode program may comprise at least one or more time ranges. The program may apply to timer (and)/or motion detector-based (and)/or communications (such as, but not limited to, personal communicator or user access code or sensor-based transmissions) activations or to activations for any other apparatus, device, system or embodiment with a direct or indirect networked connection that may interact in either or both a transmit (and)/or receive communication with the present invention.

With respect to the previous apartment dwelling application and associated configurations, a motion detector module activation may generate an electrical signal over the circuit connection to the controller and timer circuit which may activate the controller processor to generate a program where the program may reference a security mode condition table or perform a similar function. If the controller module program is not in security mode, the next program sequence may be to reference whether a day mode condition program is activated or perform a similar function. If the day mode program is activated or the day mode condition is in an on-state, the controller program sequence may proceed to the program line or level associated with the activations for the day mode program. The activation may be to activate, for example, an air freshener for a certain period of time. The program generation may also be to activate a certain amount, type or location area associated with, for example, lights, appliances, (and)/or other fixtures. The program generation means may comprise transmitting, for example, ZigBee data packets to a variety of addresses or devices with, for example, ZigBee transceivers or receivers. The devices may be other multi-utility enclosures, other present invention embodiments described herein, or, in continuing with this example, ZigBee device equipped embodiments.

One group of embodiments that may be associated and activated in conjunction with the preceding is another present invention that strongly complements the overall present invention described herein—coded multi-addressable or uniquely addressable wireless communications controlled electrical switch embodiments which are comprised in, but not limited to: plug-in electrical plug receptacles; extension cords and plugs; power cords and plugs; bulb socket enclosure receptacles; batteries; and associated circuit adapters. This present invention group may also comprise wall outlet and light switch embodiments where the embodiments may be comprised in a system configured with the variety of device controllers (and)/or timers within the present invention multi-utility enclosures, routers, access points, range extenders, remote control units, personal communicators and sensor and alert systems described herein The wall outlet and light switch embodiments will be described further in the narrative in conjunction with the present invention multi-utility router, access point, and range extender description. Wireless controlled wall outlet and light switch embodiments are useful and will likely become more prevalent with technologies such as ZigBee other wireless systems and possibly powerline means. Powerline means will also be addressed further in the narrative in regards to the plug-in embodiments described herein. The present invention wireless communications electrical switch innovations that will be described over the next few paragraphs have an advantage over powerline, wall switch and light switch embodiments, because the innovations are portable and may be configured to support the least expensive means for remote and automated electrical switch activations. Even though these present invention embodiments may be adapted for utilizing a variety of wireless communications protocols (such as, but not limited to, Bluetooth), the preferred protocol for the embodiments is ZigBee.

These innovations function as uniquely addressable electrical switches for any electrically powered apparatus, fixture, appliance, component, or embodiment (including the innovations described herein) that may be plugged or screwed (applicable to bulb socket enclosure) into them. The innovations may be available in a variety of embodiments, and, additionally in or with a variety of products, services, configurations and utilities where the conjunction or integration supports other present invention embodiments. When coupled with a variety of present invention embodiments that comprise a communications component with a compatible protocol, especially, but not necessarily, a ZigBee protocol, such as, but not limited to, a pedestal 22 with the various preceding embodiments, these present invention switch embodiments provide a utility system that offers greater variety, reliability, capability and economical value than any other timer (and)/or device controller and/or sensor and alert system.

One of the preceding present invention wireless electrical switch apparatuses may be in the embodiment of a wall outlet plug-in housing and an assembly plug receptacle comprising: an outer portion standard outlet electrical plug which is connected to an inner portion main electrical circuit where the circuit terminates into a switch or junction; at least one outer portion electrical plug receptacle; an inner electrical circuit connected to the at least one receptacle and the circuit switch or junction; a wireless communications processor with the associated standard electrical and electronics components, memory and a software program and associated configuration that controls the electrical circuit switch or junction; and an antenna that is connected to the communications processor. As previously stated, the preferred communications component associated with the preceding is ZigBee.

The operation of the embodiment may be illustrated through the continuation of the pedestal 22 day mode example. Upon the program execution of transmitting one or a variety of command signals to specific ZigBee-equipped devices that are associated with the day mode program residing in the pedestal 22 controller and timer module 29, at least one of the ZigBee-equipped devices that may be receiving the signal may be the present invention wireless controlled electrical switch apparatus. The apparatus, upon receiving the transmission, sends back an acknowledgement frame to the originating pedestal 22 communications module processor, and processes the signal by activating the switch to open the circuit connection to the plug receptacle.

Said wireless controlled electrical switch apparatus may be adapted with a timer device where the embodiment may have a variety of option settings and associated circuitry and offer greater utility as described in this narrative section. Wherein said present invention embodiment may offer the user a localized interface and capability for a timer function, as well as the option and benefits and capabilities of a remotely controlled capability wherein the control may be generated from a remote control unit (and)/or a networked timer (and)/or a networked timer and controller embodiment, as well as a remote networked server. The embodiments will be covered in more detail further in the narrative.

Another similar embodiment of the preceding is accounting for a communications controlled electrical switch functionality in a portable light bulb socket. The socket enclosure innovation may comprise the following: an outer portion standard-sized grooved bulb socket electrical contact, fitting and housing that comprises heat dissipating elements; the socket electrical contact and fitting is connected to an inner portion main electrical circuit where the circuit terminates into a switch or junction; the housing comprises a bulb socket receptacle where the receptacle comprises a contact to the electrical switch circuit; an inner electrical circuit connected to the at least one receptacle and the circuit switch or junction; a wireless communications processor with the associated standard electrical and electronics components, memory and a software program and associated configuration that controls the electrical circuit switch or junction; and an antenna that is connected to the communications processor in the heat dissipation housing where the housing may be comprised of, but not necessarily, a durable plastic composite with associated securing, fastening (and)/or bonding means similar to what has been described in the present invention embodiments described herein. As previously stated, the preferred communications component associated with the embodiment is ZigBee.

Another version or enhancement for the preceding embodiments may account for an ambient sensor, processor and program or an ambient sensor, program and processor adapted for communications, switching and ambient sensor processing where the embodiment may generate a communication in relation to a remote device command and the lighting condition associated with the command. The embodiment may, for example, communicate to a user or remote control device that a light in the designated area is already on or that a switch associated with a light, such as a lamp, may be in an off position. For example, upon the receipt of a ZigBee transmission that comprises a data packet to turn on a switch, the processor may, upon reading the instruction, activate a value comparison program that compares whether an ambient light sensor is activated, and performs a step or series of steps based upon the value associated with the ambient sensor reading. If the ambient sensor is not activated, the program may generate an electrical current switch that opens the circuit to enable the lamp to turn on. Upon the execution of the switch change, the program may execute another ambient sensor comparison. If the sensor is not activated, the program may proceed to a new instruction code that initializes a transmission back to a designated device indicating that the lamp is not turned on (this condition may be associated with a bulb burn-out or the light switch being in an off position). The latter utility is particularly helpful in a situation where a house may be empty over extended periods of time and a lamp bulb may burn out. The sensor may be comprised in, for example, a present invention security system with a device controller or controller function, such as the present invention multi-utility router, access point or range extender which will be covered further in the narrative, where upon receiving a ZigBee communication from a designated plug associated with a designated lamp, may activate a program that generates the activation of another lamp and reports the ambient sensor activation to a present invention remote server. Another related embodiment to the program functionality is a transmitted instruction to not run an ambient sensor program in association with a power activation command. The use for the program may apply to a day mode command where the individual desires a designated light to be turned on in the middle of the day. In yet another embodiment associated with the activation or non-activation of an electrical circuit, said networked plug may comprise an energy meter and associated processor, program and memory wherein upon the reading and match of an energy meter, associated with said plug's activation, reaching a certain usage level, said plug and housing assembly component configuration may support the communication of said threshold to a present invention main device, wherein said main device may comprise a program that, at minimum, generates an activation for a transmission of a command data packet that accounts for turning off said electrical circuit.

The wireless plug-in switch apparatus described herein may be available in a variety of embodiments where the embodiments are also present inventions either in separate or combination forms, in whole or in part. The embodiments may be, but are not limited to, the following: plug-in night lights (and)/or electric air fresheners (and)/or ambient sensors (and)/or processors (and)/or USB interfaces (for present and future innovations such as improved sensors) (and)/or air ionizers (and)/or LED lights, where the embodiments may be available in a variety of decorative forms or colors. The embodiments may also comprise plug-in sensor and alert system distributed components, as described further in the narrative. The embodiments may also comprise processor and voice messaging functionality where the message may be generated from a program table and voice chip and memory that may comprise a variety of messages where each message is associated with the receipt of a certain type of signal. The functionality is supported where the wireless communications means provides for a data packet message, such as, but not limited to, ZigBee or Bluetooth. The preceding present invention voice messaging apparatus will also be described further in the narrative. The sensor and alert system distributed components may also be available in a variety of embodiments where one apparatus, for example, may comprise a battery and an additional alert means where the alert means may be activated upon the plug-in unit incurring a loss or degradation of electrical current.

Additional present invention embodiments that build upon the preceding wireless plug assembly switch are multiple plug (and)/or apparatus receptacles that may be in the form of an extension cord with a multiple plug receptacle adapter or a plug-in multiple plug receptacle or a plug-in embodiment as noted in the preceding paragraph that may comprise at least one additional plug receptacle, where the forms may be available with a range of circuit switch, processor and program embodiments (and)/or configurations. For example, a plug-in multiple plug receptacle housing and assembly may comprise: an outer portion standard electrical outlet plug which is connected to an inner portion main electrical circuit where the circuit terminates into a main electrical circuit switch or junction and a wireless coded communications processor interface; at least one or more outer portion electrical plug receptacle(s) which are connected to inner portion receptacle electrical contact plates; at least two or more inner electrical circuits where each circuit is connected to a respective plug receptacle electrical plate or an outer portion apparatus housing and assembly (such as, but not limited to, those described in the preceding paragraph) where each circuit receives contact from a main receptacle circuit upon the activation of a main electrical circuit switch being open and where the main receptacle circuit connects with the main switch and each inner associated receptacle electrical circuit; a wireless communications transceiver and processor with the associated standard electrical and electronics components, memory and a software program that controls the circuit switch or junction, and an antenna that is connected to the communications processor where upon the receipt of a communications transmission that contains a designated address for the transceiver, the transceiver sends an acknowledgement upon the receipt of the wireless transmission to the originating transmitter or transceiver address of the transmission, and processes the command associated with the transmission where the command is associated with the control of the electrical circuit switch or junction. As previously stated, the preferred communications component associated with the preceding is ZigBee. Even though the preceding may account for sensor and alert system distributed components in plug-in embodiments, it is preferable that said embodiments be included in the preceding configuration solely if said components are activated in an always-on state. Said networked plug and plug receptacle assembly and housing may also support a range of additional embodiments, such as, but not limited to, from said embodiments comprising rechargeable batteries to embodiments comprising two plugs for optimizing electrical loads and device configurations powered from conventional wall outlets.

Said preceding embodiment may comprise the range of configurations, components and programs associated with the previously described present invention wireless communications plug-in switch apparatus. The distinction with this present invention embodiment and the previously described innovations is that this embodiment may activate more apparatuses, fixtures, devices, etc., because of the additional plug receptacles (and)/or circuits.

The extension cord embodiments related to the preceding may be available in a variety of forms which may be based on the location of the wireless communications component in relation to the following cord and electrical apparatus positions: at or in proximity to the electrical plug end; at some portion along the electrical cord; or at or in proximity to the plug receptacle(s).

The wireless communications electrical plug end placement embodiment may comprise: an outer portion standard outlet electrical plug which is connected to an inner portion main electrical circuit where the circuit terminates into a switch or junction; a wireless communications processor with the associated standard electrical and electronics components, memory and a software program and associated standard configuration that is connected to and controls the electrical circuit switch; an antenna that is connected to the processor; and a standard set of electrical wires that connect from the electrical switch to the standard extension cord plug receptacle(s) and assembly where the wires and receptacles are comprised within their respective standard housings.

The wireless communications electrical cord placement embodiment may comprise: an outer portion standard outlet electrical plug and housing which is connected to a standard set of electrical wires assembly and cord housing; the electrical cord wires connect to an electrical switch or junction at some portion of the cord embodiment; at the portion, a housing comprising a wireless communications processor with the associated standard electrical and electronics components, memory and a software program and associated standard configuration that is connected to and controls the electrical circuit switch; an antenna that is connected to the processor; and a standard set of electrical wires that connect on the other end of the electrical switch and extend to the standard extension cord plug receptacle(s) and assembly where the wires and receptacles are comprised within their respective standard housings.

The wireless communications electrical plug receptacle placement embodiment may comprise: an outer portion standard outlet electrical plug and housing which is connected to a standard set of electrical wires assembly and cord housing; the electrical cord wires and housing may extend out and connect a plug receptacle housing which is adapted to accommodate a wireless communications processor, antenna and associated components; within the modified housing, the electrical cord wires may terminate into an electrical switch or junction; the wireless communications processor is electrically configured with the standard electrical and electronics components, memory and a software program and associated standard configuration that is connected to and controls the electrical circuit switch; the antenna is connected to the processor; and a plug receptacle and housing portion that comprises at least one set of standard electrical circuits and plates that connect to a main receptacle circuit where the circuit terminates at the electrical switch junction.

One of the main purposes for accounting for differing placements of the wireless communications component within the present invention extension cord embodiments is to support optimal communications range for the ZigBee communications components. The utility variety is important for supporting the widespread acceptance of networked homes, especially for the initial household deployments of ZigBee.

The preceding wireless communications extension cord placements may also be associated with present invention power cord embodiments for any electrically powered apparatus such as, but not limited to, lighting fixtures, appliances, and other devices. Even though the wireless capability may also be prevalent within the structure of the device, fixture or appliance, the primary advantage of placing the wireless components outside of the respective preceding device structure applies to minimizing manufacturing, assembly and design costs. This minimal design, manufacture, and assembly cost focus is particular suited for many types of lighting fixtures. The present invention power cord embodiments are, especially, suitable for table or floor lamps.

One of the power cord embodiments for lamps that utilizes most of the preceding innovation components and concepts, yet is adapted for providing greater utility to a lamp or similar electric powered device is a power cord switch that utilizes wireless communications (and)/or manual switching means. The present invention power cord innovation may be in a variety of embodiments.

One embodiment of the preceding accounts for supporting a lamp activation from a remote apparatus regardless of the manual switch setting associated with the lamp. One of the embodiments that may support the functionality may comprise a manual circuit switch which may be comprised in a housing near the proximity of the base of the lamp and has an inner portion that comprises two leads where the leads connect to the manual mechanism and where one of the two the leads is activated at any given point in time and becomes activated as a result of the manual activation of the switch. Each lead may terminate into an interface that is associated with a processor which comprises a program, a clock, and memory and is connected to associated electrical and electronics components. Upon the activation of the manual switch, where the activation changes the active or inactive state of each lead, the newly activated lead sends a signal into the respective interface that terminates into the processor, where the activated interface triggers the processor to generate a program to record the new active lead condition. The program also generates a sequence to call up a switch register record to read the most recent switch activation source and command state, where the source may be, but not limited to, a manual switch, a remote unit, or a timer unit. The source may be identified because the wireless communication protocol, such as, but not limited to, ZigBee, may include the transmitting originating address associated with the unit and the data may be received, processed and stored in memory. The other source means is the manual switch and the record may register the manual switch activation because of the interface leads that terminate into the processor interface that are associated with the manual switch. The program may also generate a sequence to record a voltage sensor reading of the circuit connection that is on the power cord portion between the manual switch and the lamp. The program then may execute a match and IF, THEN sequence, where upon reading, for example, that the voltage sensor detects an on-state condition and the last command received was to turn the lamp on, and the command was generated by a timer activation, then the processor may activate the electrical switch control to position the switch and register the manual switch activation in an off-state condition. The program may also generate a transmission to the communications receiver associated with the timer processor record (and)/or system device controller (which may be the timer processor) that the lamp is in an off-state. The switch and power cord embodiment may comprise the same or similar components associated with the preceding embodiments. The manual switch outer portion may be in a variety of embodiments such as, for example, a dial, toggle or foot bar (pending on a floor vs. table lamp) where the movable portion is connected to an inner electrical circuit plate and wire set where the movable portion, upon moving to a setting, makes contact with one of two the leads, and causes the lead to be activated. The outer portion may be comprised of a durable plastic composite.

The preceding present invention manual and processor-controlled switch embodiment may be adapted for or comprised in or with other apparatuses (and)/or fixtures, such as, for example light switch assemblies. The adaptations are understood by any one skilled in the art to be construed as present invention embodiments.

Another present invention embodiment and associated function that accounts for another level of utility for a wirelessly controlled plug-in apparatus and housing that utilizes most of the preceding components and/or configurations is controlling the current or relay activation of each electrical circuit that is associated with each plug receptacle or apparatus connection on a per circuit or receptacle or apparatus housing basis while utilizing only one electrical plug receptacle or power cord enclosure. This present invention innovation provides the greatest utility and economy and the least expensive means for activating a cluster of fixtures, devices (and)/or appliances in portions, at once and/or at different times by utilizing one electrical outlet and one communications processor. The innovation provides a number of benefits such as, for example, supporting the on-state for present invention sensor and alert system secondary support distributed components (described further in the narrative) while controlling the power for present invention embodiments that provide more use when at least one individual is in the living area—such as, for example, air fresheners. The innovation is also highly suited for power strips for home offices or small business where the communications processor may reside in the power strip component and be connected to the associated power strip receptacles where the receptacles may be controlled by a remote timer and controller that may control other household or office system functions and may also turn certain power strip plugged in devices off at the end of the day and leaves others on continuously such as, for example a fax machine, router, firewall and/or an answering machine.

These innovations may be available in a variety of forms. Three of the forms are plug-in receptacles or extension cords or, as noted, power strip embodiments, as well as embodiments of the preceding forms comprising, as noted two plugs for optimizing electrical and appliance loading.

The plug-in multiple plug receptacle embodiment may comprise: an outer portion electrical outlet plug which is connected to an inner portion main electrical circuit where the circuit terminates into a main electrical circuit switch or junction and a wireless coded communications processor interface; at least one or more outer portion electrical plug receptacle(s) which are connected to inner portion receptacle electrical contact plates; at least two or more inner electrical circuits where each circuit is connected to a respective plug receptacle electrical plate or an outer portion apparatus housing and assembly where each circuit receives contact from a main receptacle circuit upon the activation of a respective receptacle circuit switch being open, where each receptacle inner electrical circuit is connected to a respective receptacle circuit switch and each receptacle circuit switch is connected to a wireless coded communications processor interface, and also upon the activation of a main electrical circuit switch being open and where the main receptacle circuit connects with the main electrical switch; a wireless communications transceiver and processor with the associated standard electrical and electronics components, memory and a software program that controls the main and receptacle circuit switches or junctions through the interfaces; and an antenna that is connected to the communications processor, where upon the receipt of a communications transmission that contains a designated address for the transceiver and a data content packet of an associated address for a respective interface lead for a respective circuit switch, the transceiver sends an acknowledgement upon the receipt of the wireless transmission to the originating transmitter or transceiver address of the transmission, and processes the command associated with the transmission where the command is associated with the control of the electrical circuit switch(es) or junction(s).

The receptacle switches may be activated by a remote device through one communications processor by utilizing a wireless coded means, such as, but not limited to, ZigBee or Bluetooth, where the communications code may comprise data packets that include a sub-address code associated with each receptacle switch which is associated with the main address of the multi-plug receptacle.

The extension cord and power strip embodiments may comprise the multiple plug receptacle component, processor, memory, program, configuration and functionality described in the preceding two paragraphs.

All of the preceding electrical embodiments add more functionality to the present invention system and associated innovations described herein, as well as to previously filed present invention systems, such as, for example, pedestal 22.

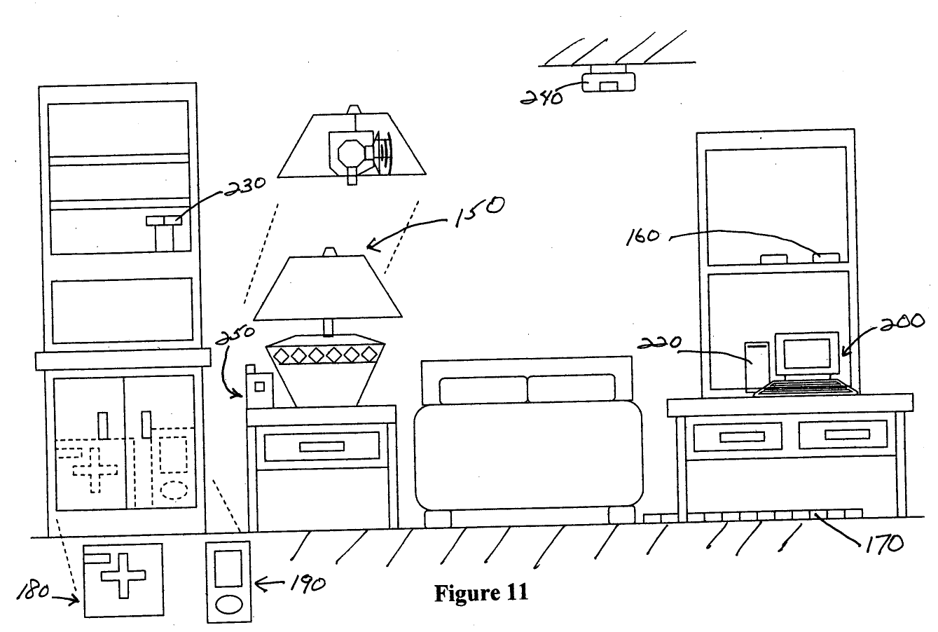

The purpose for illustrating some of the preceding previously filed present invention embodiments in this filing is to account for the versatility of the embodiments while also complementing their interaction with the distributed present invention and multi-utility components which also include the sensor and alert system and apparatus innovations described herein. One example of the complementary use may be in supporting a family with an elderly relative residing in their home who may require certain assistance. The enclosure 22 may reside in a hallway corner where the hallway may connect to the elderly relative's bedroom or bathroom. During the day pedestal 22 may function as an air freshener as previously described. In the evening, the pedestal 22 may activate the hall light and activate a speaker and processor in a fixture, such as lamp alert device 150 (FIGS. 1 and 11), which is described further in the narrative, where the device, upon the receipt and recognition of the transmission from pedestal 22, may play an alert voice message, such as “Activity, gram's hallway”. Another multi-utility enclosure may have a similar motion detector, controller, timer, and communications configuration, in another room, such as a kitchen, whereby, upon the triggering of a motion detector, subsequent module interaction may activate the play of another message in the device 150, such as, “Activity, kitchen”. In yet, another set of present invention embodiments, said pedestal or other multi-utility enclosure or networked plug-in plug receptacle and housing may comprise an RFID reader, where upon the elderly relative, wearing a pendant or other wearable item comprising an RFID tag, entering a hallway or kitchen, said system may track and report said relative's location or location proximity.

System Networking with Application Specific and Multi-Utility Apparatuses:

The present invention system accounts for many components that facilitate user well being and safety. Said present invention embodiments support numerous applications to help achieve this intent. Said present invention embodiments are also comprised of economical and highly reliable components, configurations and deployments to help deliver said intent to targeted users and constituents for widespread acceptance.

Many of these innovations contribute optimal utility when networked and interacting with other present invention components. One of the keys to achieving the widespread acceptance of the present invention embodiments, especially in a networked means, is offering said embodiment in conjunction with an associated apparatus that provides a compelling framework and value that utilizes existing infrastructure. When the associated apparatus is adapted to work with the present invention, the new present invention embodiment offers a new utility and a bridge for more utilities, applications, and a means for widespread acceptance of the present invention system described herein and all of its embodiments.

This present invention apparatus is a networked timer which may be standalone, adapted for, adapted with, or comprised in and/or for a variety of embodiments. One of the key sets of embodiments for the timer is an adaptation for network routers, access points, or range extenders or networked apparatuses or networking equipment that may embody a combination of the preceding which may also, but not necessarily, include other functions, some of which will be disclosed herein. The networked timer may be deployed for and through wired (and)/or wireless networked devices (and)/or devices or apparatuses that may be integrated with the networked devices, including the present invention innovations described herein. The networked timer may be integrated with a router, access point, or range extender or work in conjunction with the preceding or combination embodiment thereof that may be a sole or hybrid network device.

The present invention networked timer may also be a standalone device or apparatus and may comprise a variety of communications, integration, access, and administration means and embodiments. For example, one embodiment may comprise a transceiver or transmitter for transmitting at least one coded communication where the transmission is generated by the execution of a timer processor, program with an associated clock and calendar embodiment, and memory, where the communication comprises at least a receiver or transceiver network (and)/or device address that is associated with an apparatus or apparatus program that is designated to be activated upon receipt of the transmission originating from the timer. In addition, the timer may be programmed to activate and/or turn on and/or off a plurality of devices or apparatuses.

Said timer may be comprised of the preceding processor, program, memory, a communications processor or embodiment with associated software, memory, and antenna (the timer utilizes, preferably, wireless communications which is preferably, but not necessarily, ZigBee), an administration means, and associated electrical and electronics circuitry and means. The preceding components may be comprised in a compact housing (which may be comprised of, but not necessarily, a durable plastic composite) with associated fastening and securing means. The circuitry and housing may accommodate the wireless antenna and a USB (and)/or Ethernet (and)/or modem interface(s). The Ethernet interface may be plugged into a Local Area Network (LAN) port of a router and support administration and access means, where the networked timer may have its own IP address for system administration, settings, (and)/or activation through any browser enabled device within a HAN, LAN or WAN. The benefits of the preceding administration means will be described further in this narrative. The USB interface may be used for PC or PDA-based administration. The modem may be used as another means for remote administration, where the administration may be performed, for example, by a hosting-based remote administration service. Other embodiments of this innovation may also comprise the preceding interface and access means in addition with, but not limited to, dial-up, digital cellular, UWB, Bluetooth, Wi Fi, HomePlug, (and)/or other Ethernet compatible networks.

Another embodiment of the preceding may comprise a display and at least one input button or a touchscreen display for the networked timer administration component. The administration means (including the associated program) may also comprise an administration interface and program similar to what has been described in the pedestal 22 controller and timer module narrative. In addition, any highly reliable wireless coded receiver apparatus or like embodiment, such as, for example, a ZigBee-equipped present invention innovation, may also be adapted to perform with the timer and ZigBee-equipped remote control, such as the personal communicator 250, thus adding greater utility over present timers or timer-equipped devices.

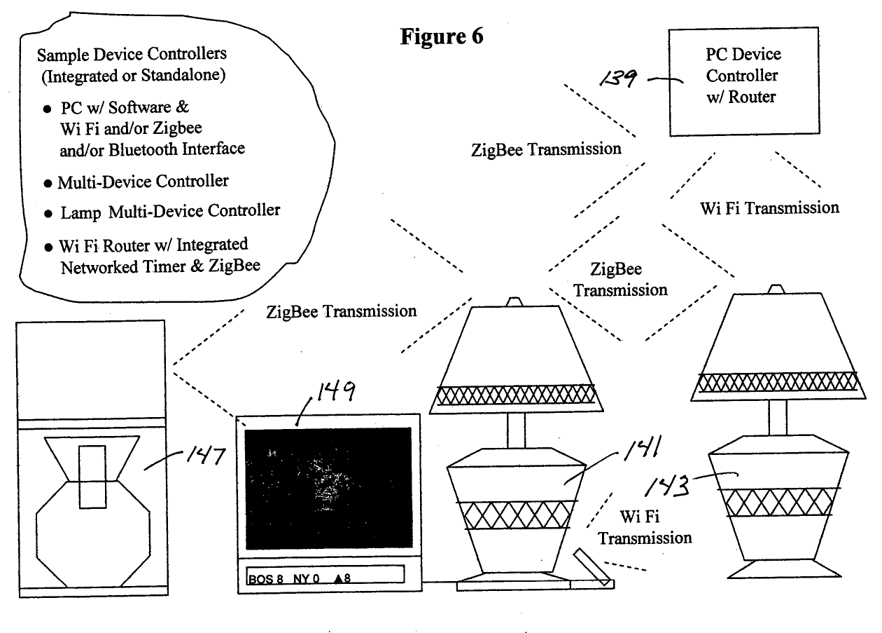

One skilled in the art understands the numerous embodiments that may be adapted with or comprise the networked timer, from lighting fixtures such as a lamp multi-device controller as noted in FIG. 6, to appliances. For example, one present invention embodiment may be a networked refrigerator with a multi-device networked timer, which may also comprise a controller function and interface which may be similar to what was described in the previous narrative associated with pedestal 22. The networked refrigerator may also comprise a Wi Fi communications component. The networked refrigerator may also comprise a Home Area Network (HAN) URL or, for example, intranet or extranet IP or web address where the address may support a PC or pocket PC or PDA or smart phone or other like device that comprises a browser-based network access means (including a present invention personal communicator 250 or remote control means embodiment) for administering the networked timer device (which may also be in a timer and device controller embodiment which will be described further in the narrative). Some of the advantages of the present invention refrigerator embodiment are the power means application or, more specifically, the desire to have the appliance operating and thus powered all of the time; and the trend in home upgrades, particularly kitchen upgrades; the acceptance and popularity of home networks and the interest in home appliance networking. In yet another appliance embodiment of said timer, said timer may be in a television embodiment, wherein the administration interface of said timer system may be a remote control unit adapted for administering said timer embodiment.

In keeping with the focus of adapting the networked timer to an apparatus where the combination creates an embodiment that supports widespread acceptance and use and serves as a means for applying the utilities of the present invention system and innovations described herein and associated embodiments, one of the innovation embodiments that incorporates the focus is a Wi Fi router and ZigBee full function device router/controller with a timer program, processor, and associated features and functions.

The communications router and timer apparatus may be in a variety of additional embodiments. One apparatus may comprise: a Wi Fi router component with the associated processor, memory, software, administration, communications, electronics and timer interface means; a ZigBee full function device component with the associated processor, memory, software, administration, communications, electronics, and interface means; and a timer component with the associated processor, memory, software, administration, electronics and interface and channel means. The preceding may share the same power means, housing and assembly infrastructure, clock, calendar, and administration software or CD component, as well as centralized system administration and reporting communications through the Wi Fi and broadband connections associated with the router. In addition, the preceding may also be manufactured, assembled and shipped as an integrated unit, thus significantly reducing costs in comparison to acquiring three standalone Wi Fi, ZigBee, and networked timer device components.

This present invention timer embodiment in router or standalone form delivers significant utility and economic value to the user that is unavailable in any other timer apparatus or system. The timer embodiment may be utilized in conjunction with ZigBee equipped light switches, lighting (indoor and outdoor—including the various present invention lighting embodiments described herein and in other prior filings), previously described present invention electrical embodiments, networked appliances (a variety, such as, but not limited to, coffee makers, various ovens, etc.), environmental control systems, heating and cooling system controllers (such as, but not limited to, central air and heating system controllers adapted for the present invention system with the wireless communications means and associated processor, software, memory and other associated components), other present invention innovations that will be introduced and described in this narrative section, and other ZigBee equipped apparatuses. The timer embodiment may comprise a program that registers remote device receipt acknowledgement of timer program-initiated ZigBee transmissions as well as errors associated with the transmissions or may generate and transmit the record in a report to a main device 10 or a network or server site, such as a present invention server 300, through the router channel over a Wi Fi or broadband interface connection.

This timer innovation may comprise a program that utilizes a same, similar or enhanced functionality over what was described in the timer program related to the timer and controller module 29, such as, but not limited to, present invention device or device group or feature or feature group (the feature group may comprise, for example, but is not limited to, a random feature or a seasonal setting feature) settings. For example, an enhanced version of a random setting function comprised in this timer embodiment may comprise programming the setting for a designated group of devices at (a) designated day(s) or date(s) or week range. The group of devices may utilize, but not necessarily, the random setting function while another group may maintain a consistent on and off setting. The devices may be grouped by location(s) and/or types. The device groups may be comprised in a larger group. For example a group of the groups may be associated with a seasonal setting grouping. The seasonal feature accounts for setting time modes associated with seasonal daylight variances. The groups may comprise outlets such as outdoor power receptacles for Christmas decorations, or other permanent electrically powered embodiments such as outdoor lighting fixtures, front door lights or sprinkler systems, where the fixtures and systems electrical circuit switches are adapted with a wireless coded communications capability (such as ZigBee) and electrical relay and circuit switch means. The seasonal feature may also apply to all system devices or apparatuses where the components may be categorized having said feature group setting. The present invention seasonal feature innovation is another embodiment of the timer mode function where the mode accounts for a program that may utilize a day or date calendar setting with a time mode equation where the setting may comprise a unit counter such as a minute counter where, for example, the activation start time equates to the preceding day time setting plus one and a half minutes and the stop time may have a same program setting. Additionally, the mode setting may also be in a variety of embodiments where the setting may comprise a week, month, (and)/or calendar year setting. Finally, the mode feature may also be comprised in an embodiment where the timer may comprise a program that generates a series of communications (and)/or commands associated with the receipt of a mode command such as a medical or environmental mode command, as previously described in the narrative associated with pedestal 22.

The preceding example of present invention timer programs and settings provide greater utility than other timer devices and systems which are often non-networked standalone units. This functionality, coupled with the appropriate network configuration or protocol or components or combination of the preceding, provides the means to provide other present invention embodiments, such as robotic indoor and outdoor appliances with integrated wireless communications means that may be coupled to work with said present invention embodiment(s). For example, a robotic or homebot vacuum cleaner may comprise a wireless communications chip set, such as, but not limited to, ZigBee, where the vacuum may be activated to run on a Saturday afternoon. Additionally, a robotic lawn mower with a wireless communications means may be activated to run at the same time. The outdoor device may utilize a ZigBee, UWB or Wi Fi protocol pending on the size of the yard and networking means associated with the outdoor and home network. The wirelessly equipped outdoor device may comprise diagnostics (and)/or sensors that may be associated with a program that, upon receiving or processing a certain set of conditions, may generate and transmit a wireless communication to a present invention router and networked timer and controller embodiment or a main device 10. The preceding may also be integrated with a present invention remote control device. Other out-of home systems such as a remote car starter (and)/or diagnostic system may also be adapted with the present invention system.

Another advantage of this present invention embodiment over any timer device or system is the administration and access means. Given that the timer function or component is integrated within the router or may be connected to a router port, the administration means may have a designated IP address, and, thus accessed with a browser-based device and/or program processor such as, but not limited to, a variety of PCs, PDAs, smartphones with Wi Fi capabilities, servers, and present invention personal communicator embodiments, as well as home entertainment units, such as a variety of monitors that may interface to some of the preceding along with wireless or projected keyboards. This innovation may also comprise a user friendly software interface for timer system administration utilizing click through GUI means. As previously noted, the administration may also be performed through the LAN port of the router via an Ethernet cable that may be directly connected to a compatibly equipped device or device interface where the device may comprise a browser, where the device may be, for example, a personal computer.

Given the preceding, the administration may also be performed away from home with appropriate log-in and password means. This present invention embodiment supports administering a broad range of applications, from activating a generator to turning on a Jacuzzi or hot tub or sauna. The remote administration capability also provides the means to receive help from a family member or third party to support the operation of the system and also support the focus of the present invention system to provide the means and functionality for widespread acceptance for a variety of users.

The ability for the timer function to interact with a myriad of devices may be enabled through a standard, such as ZigBee. As the standard evolves to account for more device and device interaction functionality, as well as additional new devices and associated functionality, the timer and router may be comprised in an embodiment that supports modular interchangeable circuitry and software patch or update downloads to accommodate new functionality. The router or access point integration with the timer provides for this ease of administration, access and support advantage.

As noted, this timer embodiment may also comprise report and reporting capabilities. These capabilities will be addressed in the following narrative covering the router timer and device controller embodiment.

The present invention router timer and device controller offers more functionality to the apparatuses previously covered in the timer narrative. Some of the functionality included in this embodiment was described in the pedestal 22 and associated modules description and illustration text, and comprises, for example, utilizing various day (and)/or security modes as well as medical and environmental alert command modes, interacting with motion detectors, sensors, and personal communicators and transmitting a variety of commands based on the interaction.

The preceding functions may also be enhanced through other functions such as receiving input transmissions comprising a user profile code and the transmitting device address or set of addresses associated with the profile code transmission along with, but not necessarily, specific commands. The information may be received by the ZigBee receiver, processed and forwarded to the controller processor and program for generating table programs for matching the profile code and device addresses where the matching generates an execution or series of executions or transmissions pertaining to the information. The transmissions may range from activating certain lights or certain light settings, to activating drapery settings, to turning on certain entertainment components at specific settings, to turning on car systems at driver and passenger defined settings.

Another enhanced embodiment of the present invention timer and router device controller is activating (and)/or monitoring certain devices (and)/or systems whole away from home. For example, a heating and cooling system, appliance or lights may be activated while a user may be traveling en route or at the office by enabling the embodiment through a browser-equipped device. Continuing with this example illustration, the device may comprise a URL bookmark for a present invention device activation site page associated with the timer router and controller embodiment. The site page may comprise at least one or more programmable button field GUI symbol(s), where the field may represent, for example, a device group and another button may represent a command, such as, “ACTIVATE”. The site page may also display, but not necessarily, real time sensor updates such as, for example, indoor and/or outdoor temperature readings. The readings may be generated from present invention weather instruments that may comprise a processor, program, memory, communications means, such as but not limited to, ZigBee, and associated electronics components. The weather instruments may be in (and)/or integrated or interact with a variety of embodiments, such as the timer and controller embodiment described herein (and)/or the personal communicator 250 (the interaction is described further in the narrative). The instruments may comprise a programmable processor and program for generating at least one ZigBee transmission to at least one present invention controller when a reading or set of readings are outside of a certain range. The timer and/or controller may activate a program to transmit a temperature reading and reporting command on an hourly basis during a rush hour period, where the command may request the weather instrument to record and transmit a reading to the device controller.

The preceding functions may be comprised in a variety of present invention embodiments, including a standalone networked timer and controller embodiment. An apparatus supporting the preceding in an integrated router embodiment may comprise: a Wi Fi router component with the associated processor, memory, software, administration, communications, electronics and timer interface means; a ZigBee full function device component with the associated processor, memory, software, administration, communications, electronics, and interface means; and a timer and controller component with the associated processor, memory, software, administration, electronics and interface and channel means. Again, the preceding may share the same power means, housing and assembly infrastructure, clock, calendar, and administration software or CD component, as well as centralized system administration and reporting communications through the Wi Fi and broadband connections associated with the router. In addition, again, the preceding may also be manufactured, assembled and shipped as an integrated unit, thus significantly reducing the cost in comparison to acquiring four standalone Wi Fi, ZigBee, and networked multi-device controller and timer components. The distinction between the preceding and the router and timer embodiment is the controller and associated software capability. The processor and memory may vary, but not necessarily, based on the desired applications, capabilities and configuration.

In a standalone networked timer and controller embodiment, the innovation may comprise, but not necessarily, similar housing, processor, program, memory, electronics and communications components as described in the standalone timer embodiment narrative. The primary distinction is the program and possibly the processor and memory, pending on the desired configuration, such as a robust security system application.

The report and reporting capabilities may account for received transmission information, such as, but not limited to: originating device type, location and time of receipt; user code or profile received transmission information and time of receipt, sensor transmissions such as originating sensor type and location and receipt time; as well as transmissions associated with the preceding and timer activations. The reporting may be stored in memory for a certain length of time and criteria, as well as transmitted to, but not limited to, a remote server.

The preceding embodiments support a variety of robust applications. The networked controller and timer (and)/or networked timer apparatuses may be adapted to utilize other communications protocols, such as, but not limited to, digital cellular, Bluetooth, UWB, Wi Max, HomePlug™, (and)/or other Ethernet compatible networking means. Additionally, the device may also comprise a dial-up modem capability. The embodiments may also be adapted with other unique capabilities to interact with automobile communications systems that may range from car phones, to car console systems, to hybrid communications and diagnostic systems integrations with satellite systems. The preceding may also be adapted to be in other embodiments, as previously noted, such as servers, personal computers and other appliances. It is preferred that the innovations be utilized in a Wi Fi router (and)/or access point and ZigBee full function router/controller embodiment behind a firewall configuration to optimally deliver the robust utilities and applications at a low incremental cost. Additionally, the standalone embodiment, when connected to a router port may also deliver significant value for the user.

As previously described in this narrative portion, the present invention networked timer (and)/or timer and controller innovations are comprised to support the widespread use and acceptance of the present invention system. Another key means for supporting the acceptance is to account for a variety of embodiment capabilities with the intent to best match the variety of users who may benefit from the present invention system. One of the keys to attaining this focus is to offer a variety of means to administer the respective embodiments to best match the user's abilities, interests, budget, (and)/or existing home network infrastructure.

For example, software applications such as, but not limited to, program settings and/or new prescription regimens and/or reporting programs related to main device 10 may be programmed through three means: 1) by the user and user interface settings menu of main device 10 and/or a PDA with associated software and interface components and/or a personal computer and personal computer with associated software and interface components; 2) through a third party such as a pharmacist or visiting nurse who has direct contact with the main device (which may be in portable form) or a modular interface to the device; or 3) through a service such as, but not limited to a mail-order or pharmacy service via a secure web site with a user profile and a downloadable executable file. The latter two programming options may minimize error in medication regimen administration and/or ordering when input means is in electronic form and is associated with medication regimen dosage that originates in the form from the prescribing source. For example, upon receipt of a doctor's prescription which may be in electronic form, a prescription may be filled and/or prescription instructions may be electronically ported from the physician's original electronic record to the main device 10 via the server 300.

The functionality associated with medical device 20 and/or interface timer, exception parameters, and/or reporting programs (among other programs) may be administered through three means: 1) at the device level through at least one input button and display means of device and/or interface 20 and/or main device 10 and/or a PDA with associated software and interface components and/or personal computer and personal computer administration software; 2) through a third party as described in the preceding paragraph associated with main device 10 programming; or 3) through a service as also described in the preceding paragraph.

The programming of the main device and/or medical devices/interfaces through a PC may be performed by means of another present invention component which may apply not only to this invention, but also to other networked devices, particularly those suited for HANs. The utility of this invention component leverages the growing deployment of Wi Fi networks with the economy of use and power of ZigBee-based wireless devices and networks. The value of this hybrid network is not only a better price and performance match for the associated network, its components and associated applications (such as the previously described router, timer and controller embodiment), it may also facilitate a better and more economical user interface and component deployment for device administration.

The present invention embodiment associated with leveraging Wi Fi and ZigBee functionality and economy is a Wi Fi ZigBee communications device which may be in one or more of the following embodiments: a bridge, access point, router, and/or range extender. It comprises at least one processor, associated software and interface that receives, processes and/or transmits Zigbee protocol device addressing and instruction/coding/information packets/sets to and/or from the following: 1) at least one Zigbee device network controller or fill function device and/or a Zigbee reduced function device; and/or 2) at least one Wi Fi communications device over a Wi Fi communications protocol (the ZigBee protocol resides in the data packet frame of the Wi Fi protocol). It may also receive, process and/or transmit Wi Fi packets in conjunction with the preceding functionality when it is in the embodiment of a Wi Fi ZigBee router. The purpose for the device is to: 1) utilize the transmission range, speed, and packet protocol of the Wi Fi medium as a wireless backbone network for anchoring multi-functional hub devices, such as a present invention main device and a PC; and 2) apply appropriate economy and capability associated with peripheral devices with ZigBee communications chips.

An application of this present invention hybrid network device may be illustrated in the example of changing a parameter of a blood glucose meter. For example, the user may change an analyte range parameter associated with the exception and/or identifier program of blood glucose meter holder/interface 125 by clicking on a drop down menu on a software program residing on a PC (or appropriately networked web server or PDA or other processor equipped component) that is associated with the interface 125 analyte range data points. Upon changing the parameter associated with the preceding, the user may submit the update. The submission of the change may take place through a variety of devices in relation to how the devices are configured on the network. For the purpose of illustration, the PC may be connected to other network devices by a Wi Fi link via the present invention Wi Fi ZigBee device which may be in the embodiment of a router that may be connected and/or powered through main device 10. The router may receive and process the Wi Fi packet(s), and read, process and transmit the ZigBee packet(s) which is received by the associated ZigBee interface to glucose meter interface 125. The ZigBee packet (which may include all or part of the analyte range program update) is processed with the associated update being sent to the interface 125 processor and program. Upon being updated, interface 125 may transmit and/or display a confirmation message.

The preceding present invention hybrid Wi Fi device may be in, or comprise other and/or additional embodiments to support similar network device management and capability utilities, such as, but not limited to, Bluetooth, and/or Ulra Wideband (UWB). For example, Bluetooth and/or UWB protocol packets or packet frames (in whole or in part) may reside in the data or payload packet frame of the Wi Fi protocol transmission. One of the key objects of these present invention embodiments is to support economy of use for embedded technology, applications and communications services in conjunction with present and future applications and services.

The present invention hybrid Wi Fi device may be adapted to support other new utilities such as a multi-utility lighting fixture. In this embodiment, a lighting fixture may serve as a hub device for connecting Wi Fi linked equipment as a repeater, access point, and/or router (which has been cited by this inventor in previous patent filings) as well as utilizing ZigBee-based instruction sets for its own operations and other adjuncts associated with this device in a direct or remote means as described further in this filing under a present invention lamp alert device 150 of FIG. 11.

In addition, the fixture may also utilize other spectrum frequencies and/or communications technologies to accommodate other applications and other present invention embodiments such as serving as an access point and/or receiver for (a) cordless phone(s) and/or intercom and/or comprising cordless telephone, antenna and amplifier components (as well as analog and digital converters pending on the type of transmission medium and end unit phone assembly) to enable, amongst other functions, the operation of a wired telephone without having to terminate the phone in a wall jack. Either phone type (wired and/or cordless) may have associated enclosures and components for operation and termination into the lighting fixture through the associated terminating apparatus.

Another multi-utility enclosure, which may be in the embodiment of a lighting fixture, that may support at least one communications capability is supporting a Wi Fi router or a Wi Fi ZigBee router where the router may comprise at least one telephone component. The present invention lighting fixture may comprise the voice-enabled wireless router where the Wi Fi means may be based on the 802.11g Wi Fi standard.

As previously noted herein and in prior present invention filings, the utilities gained from economy of space, aesthetic design and component sharing produces greater synergy, utility and benefits for the users. The preceding may be comprised in or comprise a variety of communications component, lighting fixture, and multi-utility enclosure embodiments. The variety of embodiments may support a greater acceptance of Voice Over Internet Protocol (VOIP) or internet telephony use. For example, one application for one type of present invention configuration embodiment is for increasing the quantity and utility of phones that may connect (wirelessly) to a base unit which may comprise or be connected to a VOIP converter to extend the functionality and benefits to a number of areas throughout a dwelling.

FIG. 6 depicts a multi-utility fixture that includes such fixtures as lamp 141 with utilities that include functioning as a network hub for Wi Fi and ZigBee networked devices. The hub functionality of the lamps may be comprised in either a combined Wi Fi and ZigBee router embodiment or a lamp embodiment that comprises separate Wi Fi components and/or separate ZigBee components, yet the components may still utilize some or a high level component or program integration. For example, they may utilize the same component housing in lamp 141 to support economy of design, manufacture, assembly and shipping. Thus, lamp 143 has only a ZigBee functionality. Coffee maker 147 is also wirelessly connected to the system and includes a ZigBee reduced function component.

In this FIG. 6 embodiment, lamps may receive and transmit coded wireless command signals for controlling its operation as well as the operation of other appliances and/or fixtures where the operations do not require the transmission of much data. The communications means for the application may be ZigBee-based. The fixtures and appliances associated with this functionality may require ZigBee chip sets, antennas and associated circuitry leads and power means. The ZigBee chip sets may comprise utilities for enabling the devices to function as either full function devices or reduced function devices.

Lamp 141 is also adapted for receiving, transmitting and transferring Wi Fi communications packets. In the FIG. 6 embodiment, it is functioning as a Wi Fi access point by comprising the associated processor, electronics, circuitry, software, power adapters, relays, housing, connectors and antenna to support this high speed utility. It may be designated as an access point address off of a Wi Fi router and utilize an associated channel of the router. A primary means for receiving and transmitting Wi Fi signals is through the lamp 141 high gain antenna which is depicted as a retractable antenna that may fold down and retract into the base pedestal of lamp 141. The intent of the function is to economize desk top space and leverage the power and support means and infrastructure of the lamp. The antennal may be comprised of conventional materials and circuitry and be available in a variety of embodiments, such as, but not limited to, a 2 dbi directional or a 6dbi directional.

As a high speed access point, lamp 141 may function as a communications egress for devices with communications capabilities. The devices may comprise software and connectors that enable communications. The digital picture frame 149 depicted in FIG. 6 is such a device. More specifically it utilizes the present invention functions described in this patent filing for automatically receiving, screening, opening and displaying emailed digital pictures. It may connect to the network via a wired Ethernet connection that terminates from the Ethernet plug interface of the digital frame to an Ethernet plug interface at the base of the lamp 141 which terminates into the lamp 141 Wi Fi access point interface on the associated circuit board.

The top half portion of FIG. 6 accounts for a PC device controller and router 139 that functions as the main hub (main device) for this Home Area Network embodiment. There are other device controllers that may be associated with this network, such as multi-device controllers, which may reside in multi-utility enclosures, such as a present invention lighting fixture, and/or universal remotes (depending on the degree of functionality desired).

Another embodiment of a multi-utility enclosure/fixture is another lamp embodiment with a high-speed communications capability comprising either Wi Fi components such as, but not limited to a router, access point, repeater, and/or a high gain antenna or power line components such as, but not limited to a HomePlug™ converter and/or terminating point.

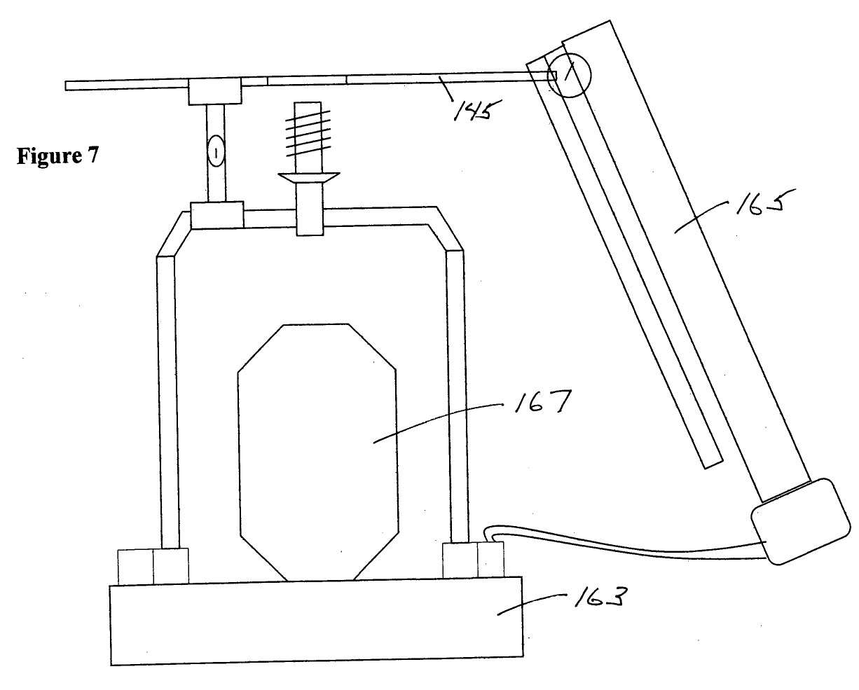

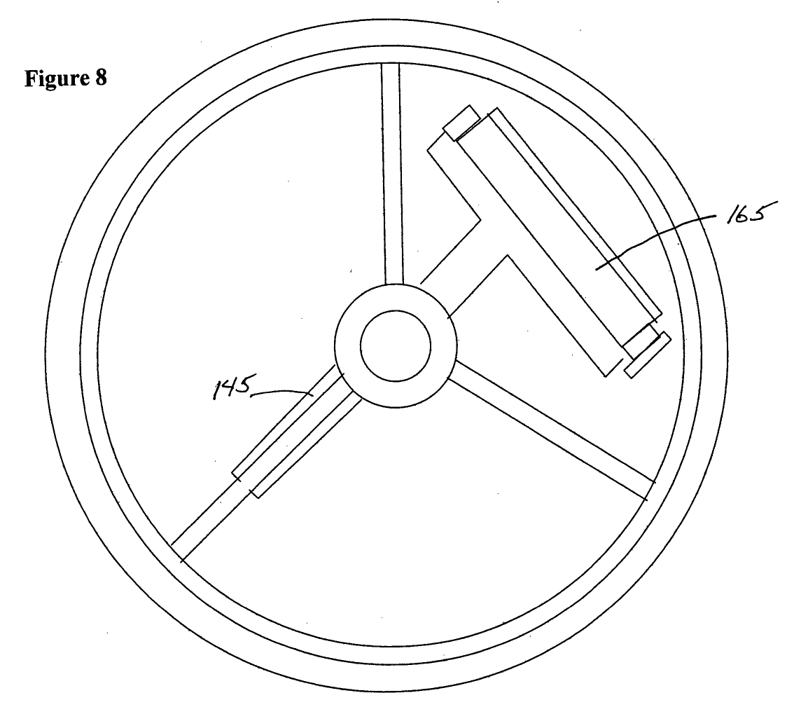

FIGS. 7, 8 and 9 are illustrations of details of present invention basic lamp configurations. In FIGS. 7 and 8, side and top views, respectively, the lamp includes a light 167 and an upper portion 145 that utilizes a high gain Wi Fi device antenna 165 with different mounting embodiments. FIG. 7 illustrates a side view of a lamp 145 antenna mounting embodiment that comprises an upper horizontal planar bar with an aperture near its center to enable a finial shaft and threading to go through it. The right side of the horizontal bar terminates into a fulcrum with a bisecting, primarily, vertical rectangular planar surface. In reference to the FIG. 7 illustration, the left side downward portion of this vertical plane is comprised of a heat deflecting surface. The inner right side is comprised of a durable plastic and smooth surface. This inner right side is alongside an open cavity for enabling an upward or downward movement of this inner portion and its parallel outside portion which is the high gain antenna receptor, thus, enabling the antenna to be positioned above a lamp shade. The bottom portion 163 of the receptor comprises the circuitry and terminating component for the antenna wire. The spherical component in the upper portion that resides between the inner vertical plane and the outside antenna receptor plane is a knob for loosening and tightening the antenna angle and moving the antenna upward outside of the top of the lamp shade or downward in the inner portion side of the lamp shade.

The securing and planar balance means for the antenna mount is the finial shaft and component and an adjustable vertical bar that may connect to the harp bar and the horizontal antenna mount.

The bulb enclosure and bottom harp brace support component comprises additional apertures for upper portion non-lighting components such as an antenna mount or antenna wire aperture. The aperture housing may be connected to a vertical housing component that may reside inside the lamp shaft or piping. The antenna may terminate into a Wi Fi access point housing which may reside in the central, bottom or outer portion of the lamp.

FIG. 8 depicts a top view of the preceding with the antenna residing in the inner portion of the lamp shade.

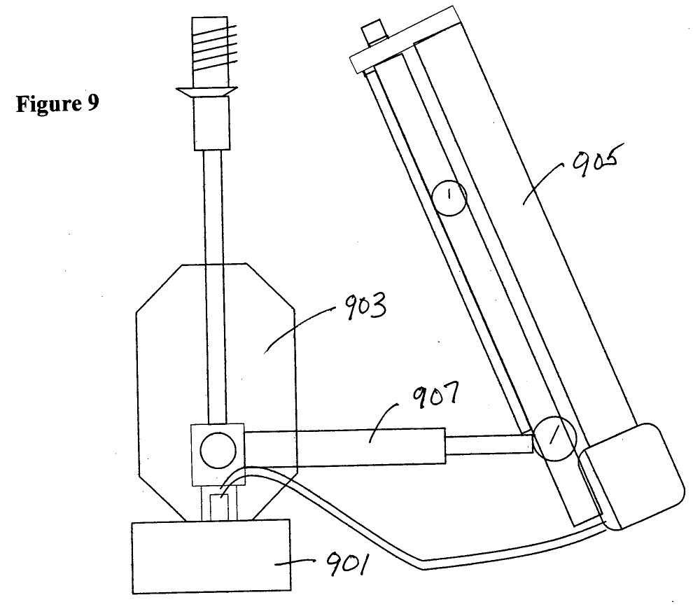

FIG. 9 depicts another embodiment for a lamp 903 with an upper portion mounting frame 907. This embodiment comprises a horizontal portion with harp bar brace apertures for mounting securing means and a fulcrum termination for angling the depicted antenna component 905. The adjustable upward and downward means for antenna positioning is provided by a telescoping vertical brace. The antenna connects to the upper portion of the telescoping unit as depicted. The upper spherical unit on the brace is for turning and thus, securing the appropriate telescoping height adjustment.

Another means for enabling a lamp to serve as a multi-utility high speed communications network hub or access point is through a wired means by utilizing, among a variety of wired mediums, a power line medium such as HomePlug™, as noted elsewhere in this filing. In a sample embodiment, the lamp may serve as an access point, such as lamp 141 in FIG. 6. A device such as, but not limted to, a digital picture frame, a personal computer, and/or a printer may interface to the lamp via, for example, an Ethernet connection or termination adapter at the base of the lamp. The adapter may be connected to a HomePlug M transceiver that may reside within or outside the lamp.

The preceding invention multi-utility fixtures and hybrid network devices and other like devices described herein may also be adapted for connecting with other HAN devices and local area network devices that are and will be utilizing certain protocols compatible with particular deployment areas/configurations and other protocols that are more favorable for other configuration or dwelling area deployments (protocols such as, but not limited to, Bluetooth, UWB, and/or proprietary closed architecture mediums).

Other uses for device to device networking and administration may account for peer to peer Wi Fi communications. For example, the user may change a contact profile on a present invention main device, e.g., main device 10, that may be associated with blood glucose meter interface 125 exception reporting by clicking on a drop down menu on the PC software program associated with the main device 10 contact profile. The contact profile may have a field associated with each device 20/device interface that is integrated and/or networked with main device 10. Upon changing the contact profile associated with the preceding, the user may submit the update. The submission of the change may take place through the transmission of an administration data packet from a PC Wi Fi component to a Wi Fi component on main device 10. Main device 10 Wi Fi component interface may send the packet(s) to the main device 10 processor and associated administration program over the main device 10 circuit connection from the device 10 Wi Fi device to the device 10 processor. Upon the update to the administration program contact profile, main device 10 may send confirmation of the profile update to the main device 10 display and/or the PC administration program and/or a web server system profile or other components.

The contact profile change cited in the preceding paragraph may also take place directly through main device 10 via user interface and software administration program components and functions.

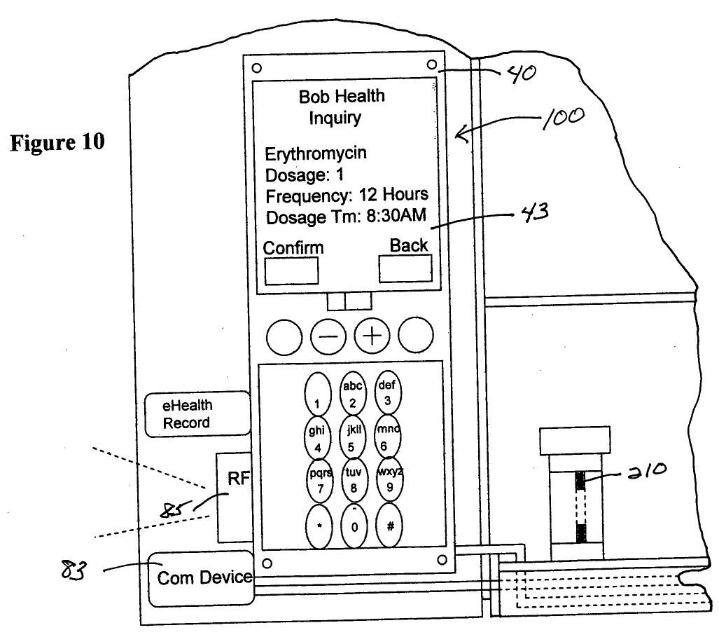

Another means for performing device and/or program administration may also be remotely by the user or an authorized third party through a web server. One of the benefits of this functionality is to support users such as a senior person who may have no interest in performing any administration, yet who is interested in a low cost and user-friendly medication aid system. FIG. 10 illustrates a main device 100 associated with the system.

The main device 100 of FIG. 10 may comprise: a large text screen 43, such as, but not limited to, an LCD or plasma screen; a menu-prompted interactive software program; at least one downloadable software program; a remote access capability; at least one button for menu-prompted user input; at least one button for scrolling; at least one communications device 83; a keypad; at least one speaker (which may be optional); at least one microphone (which may be optional); an optional eHealth record; and an optional wireless (RF) device 85, such as, but not limited to, a Wi Fi or ZigBee-based component A medicine container with a scan guide 210 is also shown.

Main device 100 may operate with the same functionality as main device 10 described herein. The difference from the device is not having drivers and software for an integrated bar code reader and/or digital picture frame. In addition, much of the inquiry, reporting, and program administration may be performed on a web server.

As noted in a variety of embodiments, a key object of this present invention embodiment is to support/match the appropriate user and constituent experience and needs to encourage the widespread adoption of such a system.

The present invention may also comprise a variety of inquiry, historical and trending functions, as well as information presentation profiles either through the main device 10 (certain software and associated components are optional), a personal computer and associated software, a web site, and/or a third party service. The inquiry function may range from, for example, disclosing all medication, device and vitamin regimens, to device readings, to disclosing exceptions. The information may also be accounted for in historical and trending reports and information profiles.

Another preferred embodiment of the present invention system, which may also be an optional though preferred adjunct, is to support rapid patient information retrieval in the event of an emergency through an electronic medical/health record. The information may be available in three forms: through a portable data storage device (such as a 128 MB USB interface device) connected to main device 10 that may be plugged into an EMTs PDA or terminal; through a web site user profile that may be accessible, for example, en route to the patient's residence; or through the main device 10.

The patient information may be accounted for by leveraging the capabilities of the main device applications and functionality along with peripheral medical and medical aid devices and providing the means for supporting an electronic med/health record at an incremental cost (for an on-site at home record) to account for incremental software and storage means. As noted, it may also reside in conjunction with onsite equipment and/or at a web site.

The present invention medical health record may account for vital statistics, allergies, histories, and, of course, current drug regimens. It may be used in conjunction with a vitals medical sheet. The on-site electronic record may reside in a plug-in storage device (such as a USB storage device) that may be connected to a main device 10 that may be on a mount 40 (FIGS. 4 and 10) residing on the inside portion of a cabinet. The record may be accessed through various levels of security.

One example of the use of the record is in the following scenario. EMTs arrive at a home. There is a sticker on the inside of the door (or other predetermined location that the EMT would know as part of a community or service program) signifying that the occupants of the home have a vital stats sheet and electronic record and noting the location of the sheet and electronic record (for example, “insid uppr cabnt lft of rfrdg”). The sheet would contain vital information as well as the importance level for accessing the electronic record, a consent signature to release the record to specified recipients and an access passcode. The electronic record may be on a specially marked, standard interface (such as a USB) storage device that may be connected to a port off of the drug administration console or main device 10. This device may be unplugged from the console and plugged into the USB port of an EMT's portable handheld device. The storage device may contain read-only files with predetermined names in a predetermined order to facilitate rapid access for patient care.

This innovation may be in other forms, such as being part of a hospital care or assisted living care network. One embodiment of this record in such a network is, as previously noted, EMT access via a secure web site, for example, while the EMTs are en route.

The preceding innovations and present invention embodiments noted in this narrative may reside, in whole or in part, in many other standalone, as well as integrated forms. Environmental, Security and Health Sensor and Alert System with Associated and Multi-Utility Apparatuses:

Another key present invention system associated with the present invention components and functions described herein is an environmental, security and health sensor and alert system that comprise a variety of apparatuses supporting the system as well as multi-utility apparatuses that also support the system, as well as other utilities.

This present invention system embodiment may be comprised of a number of deployments and configurations, such as the following: an environmental sensor and alert system; a security sensor and alert system; a health sensor and alert system; an environmental and security sensor and/or alert device and/or system; an environmental and health security sensor and/or alert device and/or system; or a security and health sensor and/or alert device and/or system.

The environmental sensors associated with the present invention may detect, but are not limited to detecting, elements such as smoke, carbon monoxide, natural gas, propane and other toxic gases. The security sensors and components associated with the present invention may comprise, but are not limited to comprising, motion detectors, heat sensors, electrical contacts, vibration detectors, and/or video surveillance and/or video scanning and image processing systems. The preceding systems may account for detectors or circuits with various alerts and/or voice messaging components (as well as voice recording components) with functions that may be associated with the type of environmental and/or security and/or medical/health condition.

The present invention system may also comprise other embodiments to facilitate exception level alert functions. For example, a stove top and/or oven appliance may have a timer and alert function associated with burner settings (such as, a stove right front burner may have an associated timer and alert activation if it is on a “HIGH” setting for more than 20 minutes). The alert component may comprise a ZigBee chip set and program to communicate to a variety of alert devices such as a component with a ZigBee chip set, processor, program, memory, voice chip, and associated equipment which may announce an appliance warning message that the stove burner has been on for more than 20 minutes. The component may be part of an environmental sensor and alert device in a variety of embodiments, such as, but not limited to (a) lighting fixture(s), such as a night stand table lamp, with (a) speaker(s) concealed, for example, under the lamp shade along with other components that may be in or on other portions of the fixture.

As previously noted in the introductory narrative of this patent filing, the present invention system accounts for sensor and alert systems that may comprise one or more of the following: distributed components, in whole or in part, such as, but not limited to, a speaker, processor, software, and communications component that may be standalone or part of other components, such as a lamp, as noted in the example stated in the preceding paragraph; broader integrated programs, applications, functions and capabilities; a means to disseminate information to facilitate appropriate action for a variety of constituents; and/or capability for having the option for being integrated with other alert, notification and intervention systems to deliver the best economy, safety and utility for many constituents.

The present invention embodiments of a standalone environmental, security or health sensor and alert system may utilize one or more of the components stated in the preceding paragraph to provide greater utility over existing sensor and alert systems. The distributed components associated with the present invention system comprise at least one form of communications and/or circuit means in order to operate as part of the present invention sensor and alert system.

FIG. 11 illustrates the following present invention sensor and alert system distributed components: a multi-utility enclosure or fixture such as a lamp 150 with speaker, processor and associated software and memory; a network addressable audio and/or luminary emission battery-powered device 160 with clipping, hooking, mounting or fastening means; a guide light and/or guide light strip 170; an emergency or first aid kit 180 with communications and signaling means; a medical device 190 with communications and signaling means; a device administration component 200; a centralized or hub component system 220 with at least one processor with associated software and memory and wired or wireless receiver and broadcast means and associated amplified wired and/or wireless speaker(s), and a personal communicator 250 (FIGS. 1 and 11). The present invention distributed components are not limited to the embodiments depicted in FIG. 11 and described herein. For example, but not limited to the example, a variety of electrically or battery powered speaker and processor enclosures, from radios and/or radio alarm clocks with modified or adjunct receiver (including ZigBee) and alarm circuits or chip sets (including voice recordable and playable) to vases to stuffed animals; medical devices; medical aids; prescription bottle caps or bottle cap tops or package bands 230 (FIGS. 11, 12 and 13) and pill boxes with communications or connecting means and pill compartment alert lights; as well as a variety of present invention automated and/or networked storage embodiments, shelving, storage slots, storage bins, carousels, conveyors and closet systems (with or without mechanized means) adapted with wireless and/or wired communications and audible and/or visual alert means; and networked embodiments with a variety of vibration means may also be adapted for being present invention distributed component embodiments.

The lamp alert device 150 may comprise the following components:
an input means for alert device programming and voice message recording
a user interface means
a communications means for receiving and/or transmitting wireless (including an antenna and at least one processor) and/or wired command and/or programming and/or instruction sets
an output means for alerting, notifying and/or informing users about an emergency and/or trigger condition and associated action
a processing and memory component with at least one software program, processor and associated memory
a data circuit means for relaying the command and/or instruction set from the communications receiver processor chip to the program processor
a powering means.

The input means may be comprised of a wired and/or wireless communications interface or hardwired or plug/receptacle circuit interface to the device processor, and a microphone for connection to the digital recorder. The input means may be located on either the lower, middle or upper portion of the lamp. The preferred embodiment, but not limited to the embodiment, of the input means for the present invention is a plug/receptacle interface, such as, but not limited to, a USB interface.

The preferred plug/receptacle interface may be utilized for directly connecting with a device administration component 200. One embodiment of administration component 200 is comprised of a planar user interface that may have a LED or LCD display and input means such as at least one input button and at least one input program sequence or step button. The component 200 may be comprised of primarily durable plastic and/or rubber materials with associated screw and adhesive fastening means. The connecting means for component 200 may be a plug or receptacle component.

The lamp alert device 150 may support a prompt-based user input function of programs and sub-programs for each unique alert function and/or voice message and/or instruction communication associated with (a) certain types and locations of trigger conditions. The present invention may account for, but is not limited to, a Sequence and Command program.

An example of the operation of the program consists of the following for setting trigger parameters and recording voice instructions associated with the trigger parameters. The display of component 200 may display the time of day, such as 5:30 P above a step or sequence button that may be located on the bottom left side of the display. On the right side of the display, the characters IN may be displayed above the input button that may be located on the bottom right side of the display. Upon pressing the input button, the left side displays, VOICE. Upon pressing the input button again, the left side displays, SMOKE. The depression of the input button associated with SMOKE displays PRGRM 1 (which establishes the first program for broadcasting a voice message associated with receiving a coded transmission from a smoke sensor device transmitter). The next input button depression displays, GRP 1. GRP 1 represents receiving a coded transmission from a set of smoke detectors identified as GRP 1. Even though the coded transmission may account for a character set that identifies the group number and device address of the transmitting sensor device(s), GRP 1 is sufficient as a trigger value to minimize programming time and memory for this embodiment example. Upon the depression of the input button again, the word, MSSG 1, is displayed. The next depression of the input button causes the word, RECORD, to display. Hitting the input button associated with this prompt allows the user to speak into a microphone speaker residing on the lamp while the RECORD prompt on the left side of the display flashes. In this sequence, the right side of the display emits the word, STOP. Upon depressing the input button, the next display sequence is MSSG 1 and PLAY. Upon hitting the input button again, the next display sequence is MSSG 1 and EDIT. Upon hitting the left side button under the word, MSSG 1, the next display frame states MSSG 1 and SAVE. Upon hitting the input button to save the message, the next display sequence is GRP 1 and IN. If the user desires other functions to take place in association with a transmission from (a) smoke detector(s) belonging to GRP 1, the user may depress the input button and scroll through other function sequences (such as, but not limited to, enabling the recording and playing of other messages, flashing sequences of the lamp, changing color patterns of the lamp if the lamp utilizes LED technology and/or transmitting coded messages to other devices in proximity to the lamp) by depressing the associated left sequence or step and right command or input buttons. If the user desires to enable functions associated with other smoke sensors or other sensors, the user may depress the left side button and right side button as appropriate.

The voice record, storage and play components that support the preceding, as well as other present invention voice messaging embodiments described herein, in whole or in part, may comprise a variety of embodiments. For example, one embodiment may comprise the analog to digital recording and conversion, storage, digital signal processor, storage and digital to analog playing and conversion functions on a generally available single chip and/or device, such as those provided by Texas Instruments, Sanyo or Winbond Electronics. The single chip device may reproduce telephone-quality voice. The voice messaging embodiment may also comprise alternate chips and associated components for reproducing higher quality voice transmission.

An application for the preceding programming illustration, may be a user programming voice instructions in association with two groups of smoke detectors. In this application, a first group of detectors may reside in the basement and front side of the house. The lamp alert device 150 may reside on a night stand beside the child's bed in his/her second floor bedroom residing in the back of the house. The voice instructions may include addressing the child's name, alerting that there's a fire, and instructing to open the window, and use a nearby escape ladder. The window and escape ladder may also have alert audio and/or visual alert means such as, but not limited to those associated with device 160, with addressable receiver chip sets or DIP switches, a circuit and a power source for triggering the alert means. These alert devices may be triggered by a wireless code set such as, but not limited to, a ZigBee frame that may be transmitted from other ZigBee transceivers and/or transmitter chip sets and/or repeaters residing on other devices such as, but not limited to, a lamp alert device 150 or other sensor transmitters, such as but not limited to, those associated with (a) smoke detector(s) or carbon monoxide detector or an integrated unit comprising a smoke detector and a carbon monoxide detector adapted for the present invention system or a main device 10. A second group of, for example, present invention system smoke detectors may reside below the child's room or near the exit window. The voice message associated with this second group may alert and instruct the child to utilize an alternative exit.

The applications and utility of this lamp alert device 150, other present invention distributed voice messaging components that may be embodied in the device 150 as well as other embodiments, and other devices that may be used in conjunction with the alert means of device 150 and other invention embodiments are broad in context with the present invention system. For example, a biosensor transmitter associated with a biosensor that detects an enzyme associated with a stroke, may transmit a coded message to a main device 10 or a present invention timer and controller router embodiment which may cause a series of actions which may include the transmission of a coded message to lamp alert device 150 residing on the spouses night table that may be associated with a program, identified as BIO DAD, which causes a voice message that alerts and notifies the spouse of the heart condition and instructs the spouse of actions such as getting appropriate medication (which may be associated with a prescription bottle cap top or package band 230 which may be emitting an audio and/or visual alert triggered by the receipt of a signal, where the signal may be, but not limited to, a wireless transmission where the transmission may include a ZigBee frame received over a ZigBee chip set associated with cap top 230—all to facilitate the ease of finding/getting the right medication in the event of an emergency) or even finding/getting and properly using a defibrillator (such as a medical device 190 which may also have the present invention components associated with cap top 230 or device 160). In this emergency condition, main device 10, which may be located beside or within the medicine cabinet with the heart medicine, which, again, may have also received a coded transmission, which upon receipt and processing may also broadcast a voice message instructing the user on the amount of dosage associated with the activated prescription container 230, such as “Take one heart tablet”.

Another present invention apparatus that supports the means to provide corrective action in the event of an emergency which may complement the apparatuses noted in the preceding example, as well as many other examples described herein, is a cell phone or smart phone or PDA embodiment that is adapted for receiving, processing (and)/or transmitting messages associated with a Bluetooth or ZigBee or other secondary wireless communications protocol, where upon the receipt of the (a) message(s), the embodiment activates a program for processing the received wireless message communication where the processing may at least comprise the memory retrieval and activation of at least one message lookup table and program, where the processed message data content is matched against the lookup table entries, where the entries may at least comprise a contact number and message script associated with the received processed message data, where upon the completion of the lookup table match, the at least one program activates the transmission and message session program. If used in the preceding example, upon receiving a ZigBee transmission associated with the biosensor enzyme detection, the present invention apparatus may perform the preceding functions where the text communication may be transmitted, for example, to a pager, cell phone, or server associated with a health care service provider or doctor or other constituent where the receiving apparatus may alert and display the text message which may include at least the patient's name and triggered condition.

Another present invention detector, transmitter and programmable voice messaging utility, but not limited to the utility, is a self diagnostic sensor device and/or system where upon the detection of an exception condition, a detector or system controller may communicate a message via a wireless transmission, such as ZigBee or UWB, to, at least, a present invention receiver, processor and voice messaging device, where upon the receipt of the transmission, processes the message that comprises a data set identifying the detector and/or system and the trouble or exception code, and plays a message associated with a program identifying the defective device, defect and corrective action taken or required.

Given the variety of applications associated with the present invention sensor and alert system, the administration of the system components such as the distributed components described herein may also be accommodated through other embodiments of device 200 such as the communications means described herein and PC-based and/or PDA-based and/or PDA/cell phone-based administration software and associated communications components.

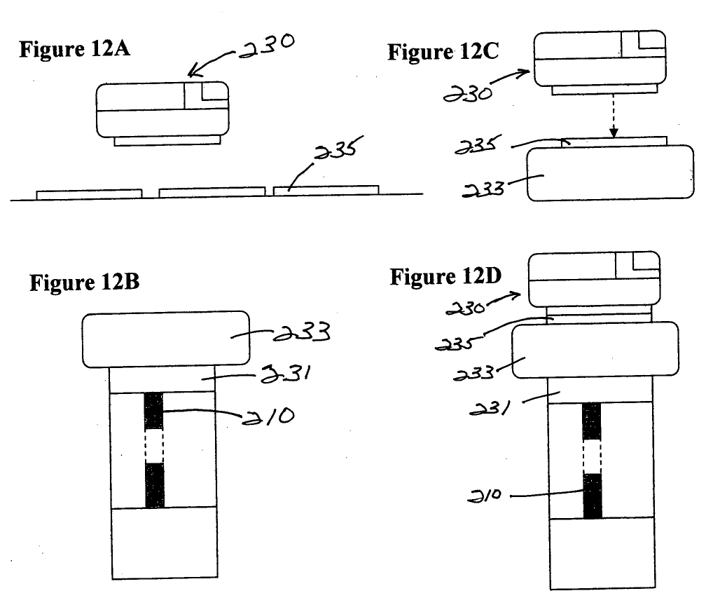

In a PDA administration embodiment, a personal communicator 250 may comprise the administration embodiment function and the embodiment may work in conjunction with PC-based software and associated communications components. The personal computer software may comprise a ZigBee network administrator menu function where each ZigBee equipped present invention embodiment may have a unique network device address and each address may comprise a name field where the user may input a respective name, for example the cap top 230 of FIGS. 12A forward, may be named “HEART MEDICINE”. Upon the completion of this address and name administration sequence, the user may save and transmit the program update to the personal communicator 250 PDA through a standard device communications capability, such as, but not limited to IR, ZigBee, Bluetooth, Ethernet, and/or USB.

The user may access the “HEART MEDICINE” on a names list through a menu-prompted directory function or an icon-based directory on the PDA 250. The “HEART MEDICINE” entry may comprise a menu embodiment sequence likened to what is depicted in FIG. 2. The entry may also comprise a communications sequence where upon moving a cursor over the “HEART MEDICINE” entry, a cursor may appear in a lower portion of the PDA screen entitled, for example, “ALERT” where upon the depression of a button below the prompt, a ZigBee transmission will be generated from device 250 and received by the cap top 230 ZigBee receiver. Upon the receipt of the transmission, the ZigBee processor will process and activate the alarm circuit lead. One of the uses for the functionality described in the preceding is to locate the medicine.

This functionality may also apply to other present invention embodiments such as medicine shelves or bins or slots or a broad variety of present invention storage means, from DVD enclosure slots to a variety of filing or conveyor systems (mechanized and non-mechanized for residential, industrial, commercial and governmental use). For example, but not limited to the example, a mechanized storage carousel with slots for DVDs, CDs and/or other storage compartments may comprise columns of the slots and compartments all along its sides and may comprise a lighting component on at least one side of the slot or compartment on each column. The light component may have a separate circuit coupling that may terminate in a processor where the processor comprises a storage program that identifies each coupling with a unique address. The processor may have a data circuit connection to a communications processor such as, for example, a ZigBee processor. Each column may comprise an address, whereas, for example, in a configuration comprising a carousel that may have an outer portion of slots whereas the top view portion of the carousel perimeter portion may depict an octagonal shape, the column addressing scheme may be 1 through 8 or A through H. Each column may comprise, for example, fifty (50) slots and each slot may have a respective lighting component.

Given the preceding example parameters, the present invention storage system embodiment may comprise a number of embodiment configurations where, for example, each column may comprise a processor with fifty addressable circuit lead terminations, where the processor may connect with a data circuit which terminates into a central processor or a communications processor such as ZigBee (pending on the efficiency and cost of design, the ZigBee chip set may comprise the appropriate program to account for eight unique circuit addresses for each respective column processor or the ZigBee chip set may comprise one data circuit termination to a central processor). The ZigBee processor may also comprise a ninth data circuit termination where the data circuit is connected with a processor that, with the associated components, may govern the turning mechanism of the carousel.

The turning mechanism processor may comprise an IR component with a scanning means, a code recognition program (such as, but not limited to, bar code) and a code table.

A personal communicator 250 embodiment associated with the preceding mechanized storage carousel may comprise a menu category in, for example, a menu-prompt program, such as, for example, “DVDs”, where upon depressing a button below a “SELECT” prompt when the “DVD” category is highlighted by the communicator 250 cursor, a list of DVD categories may appear, where the categories may be, for example, “CLASSICS, “DRAMA”, “ACTION”, “HORROR”, and “COMEDY”. Upon depressing the button below the “SELECT” prompt under the cursor covering the “CLASSICS” category, the first entry may be, “PREDATOR”. Upon the placement of the cursor over the entry, a lower screen prompt, such as, but not limited to, “GET”, may appear. Upon depressing the button below the “GET” prompt, the communicator 250 may transmit (a) coded wireless packet(s), such as, but not limited to, a ZigBee or Bluetooth packet, where the transmission contains the ZigBee processor address of the present invention storage system embodiment and a data packet that comprises the column processor address and the address of the light circuit termination associated with the column processor.

Upon the receipt of the ZigBee transmission the storage system ZigBee processor processes the transmission and transmits the preceding data packet content to the appropriate column processor. Upon the receipt of the data packet, the column processor may activate a program that activates the light circuit lead associated with the lighting component that terminates adjacent to the slot storage location for the movie classic, “PREDATOR”, which causes the lighting component to illuminate.

In addition to the column processor transmission, the ZigBee processor may also transmit the data packet to the turning mechanism processor. Upon the receipt of the data packet, the turning mechanism processor may read the column address portion, generate a reference table program, pull the table entry character and/or code set associated with the column address, run an IR scan associated with a column alignment mark on a portion of the carousel plane that is aligned with the IR scanner, and run a match or IF, THEN program associated with the data packet column address code and the address code of the column alignment mark. If there is a match, the turning mechanism is not activated. If there is a match, the turning mechanism and the IR scanner is activated. The turning mechanism is shut off when the IR scanner and program matches the column alignment mark with the column address comprised in the transmitted data packet. Upon the match alignment, the mechanism processor generates a match acknowledgement signal to the storage system ZigBee processor, where upon the signal receipt, the ZigBee processor transmits acknowledgement to the communicator 250 ZigBee chip set. Upon receipt of the signal, the communicator 250 may generate a new display sequence such as, “PREDATOR FOUND”. The bottom of the display sequence may have a “CONFIRM” prompt. Upon the depression of the button associated with the prompt, the communicator 250 may transmit a signal to the storage system ZigBee processor, where the signal contains a data packet that includes a command set addressed to the column processor to shut off the lighting circuit lead associated with the slot that includes the Predator DVD.

The individual may find the appropriate slot for returning the DVD by depressing a communicator 250 command key associated with the “PREDATOR” entry which causes a transmission which activates the light associated with the storage slot.

The communicator 250 program may comprise various menu and prompt sequences for accessing desired subject entries. For example, a FIND function may be associated with a names category such as, “ARNOLD”, which may prompt the user to the desired entry.

The programming of the communicator 250 in relation to the preceding storage system may be accomplished in various means. One embodiment of the means may be comprised of two methods: 1) in conjunction with a PC-based software program associated with the device 250 and present invention storage system in a similar administration manner to what has been previously described, with menus which may include a name entry list by carousel column and menu category naming; and 2) by downloading the completed program from the PC to the communicator 250.

In addition to ZigBee, the communicator 250 and the associated storage system may also utilize other wireless communications means such as, but not limited to, Bluetooth.

The preceding configuration and associated components may comprise other embodiments, components and functions and may be comprised in other present invention retrieval and storage systems, as stated herein and other present invention patent filings. The systems and components should be construed broadly, to include other variants and embodiments of the invention which may be made by those skilled in the art without departing from the scope and range of equivalents of the invention. For example, a shelving system may comprise at least one RFID scanner in a certain shelf or stocking area, where the scanner may capture all RFID tag information associated with the items stocked in the shelf area. The scanner may be associated with a processor that captures and transmits the information to a web server which may comprise RFID tag code tables, the server may compile a listing of all of the scanned information according to a pre-defined user or company category profile. The information may be compiled and downloaded to a variety of devices, such as, but not limited to, a personal communicator 250, where the communicator 250 may function in a manner similar to the preceding paragraphs and utilize additional utilities such as receiving, for example, ZigBee transmissions from a ZigBee transceiver configured with the RFID processor where the transmissions may occur when a shelf stocking quantity reaches, for example, a certain threshold level.

The interactivity of the communicator 250 with other adapted devices supports a variety of other present invention embodiments with more utility and convenience for the end user. For example, the communicator 250 may comprise a program and display sequence for accessing and displaying weather readings or receiving weather readings when the readings may be outside of a certain parameter.

One embodiment of the preceding may comprise weather instruments with wireless transmitters or transceivers, where the wireless components may be, but not limited to, preferably ZigBee chip sets and associated means. The instruments may comprise a programmable processor and program for generating at least one ZigBee transmission to at least one personal communicator 250 when a reading or set of readings are outside of a certain range. The instruments may also receive ZigBee transmissions and device commands from the communicator 250 that may activate generating a program to capture, for example, at least one weather reading and transmit the reading to the communicator 250.

The personal communicator 250 program and menu sequence may compromise functionality similar to what was described in the preceding DVD retrieval example, where upon depressing a button below a menu prompt of, for example, “GET” under a menu entry that may be entitled, “WEATHER”, the preceding ZigBee transmission may be generated to access the weather readings.

The present invention communicator 250 may also be utilized to control other present invention embodiments such as activating a previously described wireless controlled electrical switch in an extension cord or a wall plug embodiment or consumer electronics entertainment system devices.

The communicator 250 may have an embodiment which may be programmed to control the activation and settings of devices, such as, for example, consumer electronics devices, by depressing one button or one entry (if utilizing a touch screen embodiment) that may be associated with the entry on the communicator 250 display. The embodiment may comprise a processor where the processor may operate with a program and memory that enables transmitting at least one or more transmission(s) where the transmission(s) comprise(s) at least (a) device address packet(s) and (a) command or data load packet(s) where the transmission(s) is(are) designated for at least one or more device(s) where the device(s) comprise(s), or is(are) connected with, (a) compatible transceiver(s). Upon the completion of each communicator 250 transmission and the receipt of receipt acknowledgement from the device (for example, a consumer electronics device), the communicator 250 program may execute another or series of transmission and receive receipt acknowledgement sequence(s), where, again, the program and the respective interactions may be executed by the initial activation of the one entry.

Another level of functionality associated with the preceding, and other applications, associated with this present invention innovation is accounting for a user code or user group code in the communicator 250 program and transmission, where upon the receipt of the code a receiver and associated device processor may process and generate a program to activate a device, for example, at a certain setting, such as a volume level, based on the user profile associated with the code.

The personal communicator 250 may also control a variety of lighting fixtures and associated settings utilizing, but not necessarily, the preceding functionality, as well as lighting fixture non-lighting operations, such as those associated with the lamp alert device 150 and other present invention multi-utility embodiments.

The personal communicator 250 is, yet, another present invention embodiment that facilitates the widespread acceptance of the innovations described herein by offering a variety of value and utilities, especially when used with the other present invention embodiments., such as, but not limited to the lamp alert device 150.

With respect to referring and concluding the narrative associated with the lamp device 150, the communications means associated with lamp alert device 150 may be wireless and/or wired. The wireless means, which is the preferred embodiment of this present invention component, may utilize open protocols such as, but not limited to, ZigBee, Bluetooth, and/or UWB or be adapted for closed proprietary protocols. The wired means may utilize power line-based means such as, but not limited to HomePlug TM or other wire-based communications mediums.

The preferred embodiment of this present invention component 150 is utilizing a ZigBee based wireless protocol, because of its operating characteristics with other detectors, sensors, and transmitters or communicators where the characteristic are, but not limited to, utilizing low power, low cost, information transfer and acknowledged transmission receipt.

The economies gained from utilizing a ZigBee protocol for lamp alert device 150 may also support another present invention embodiment of a ZigBee router where the router may receive and process ZigBee packets that may control the following: lamp lighting operations, from timer activations to dimmer functions; various voice messages based on the type, location and quantity of sensor transmissions; and ZigBee full function device functions for serving as a mesh network hub for other ZigBee networked devices.

The power means for lamp alert device 150 may be sourced through one standard AC outlet. Device 150 components may also utilize battery power or backup (such as the ZigBee chip set and certain alert components) and/or DC components with the appropriate converter, resistor and capacitor elements.

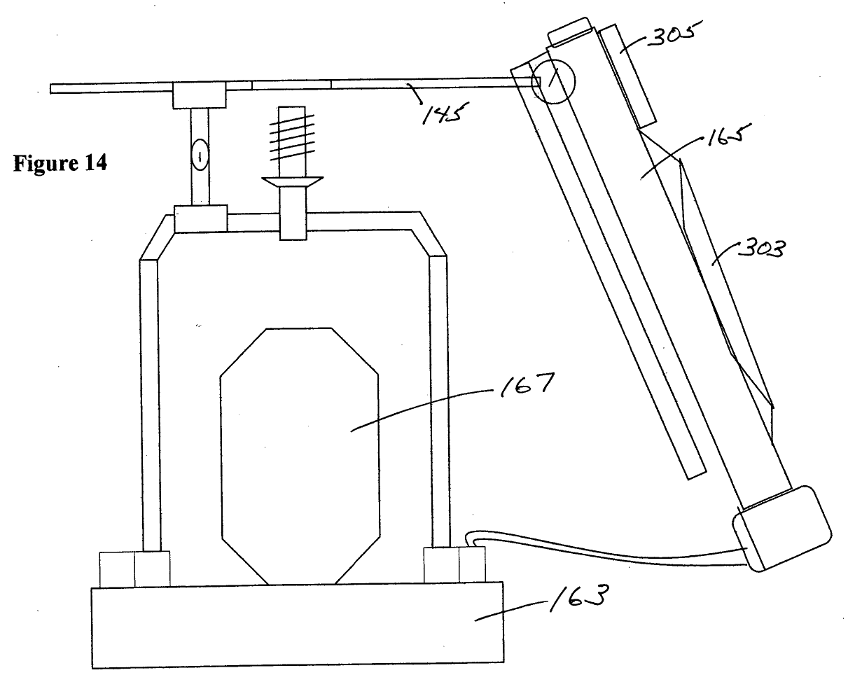

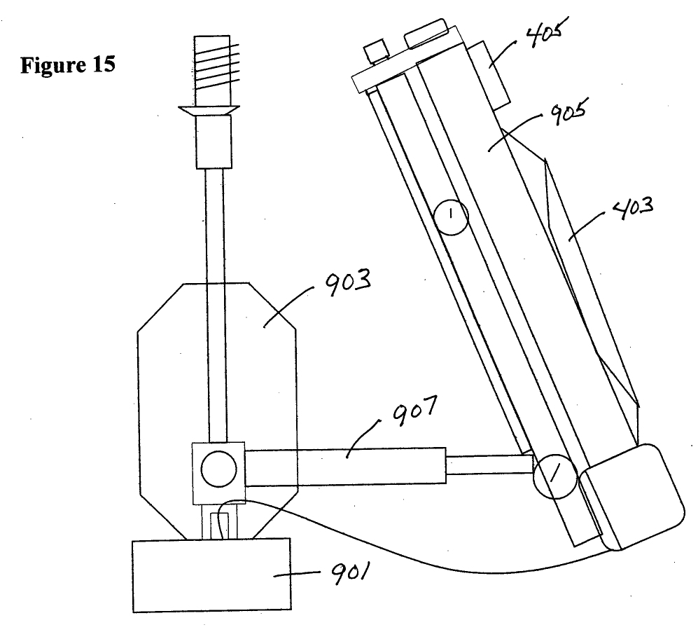

Another embodiment utilizing the present invention functionality of the lamp alert device 150 is a programmable voice recording, messaging and communications adjunct which may utilize the mounting means depicted in FIGS. 7, 8, and 9, among other forms of mountings (including standalone). A sample embodiment of the means and messaging speaker component is depicted in FIGS. 14 and 15. These figures account for utilizing the present invention antenna and/or power apertures in the bulb enclosure, harp and finial support component and other present invention lamp infrastructure components. Thus, in FIG. 14, the elements identical to those shown in FIG. 7 are identically numbered and their functions are already described. In addition, there is a speaker 303 and a communications component 305, to provide a programmable speaker voice recording, messaging and communications subsystem. Likewise, in FIG. 15, the elements identical to those shown in FIG. 9 are identically numbered here and their functions are already described. There is a speaker 403 and a communications component 405, to provide a programmable speaker voice recording, messaging and communications subsystem.

Another present invention distributed component embodiment is a network addressable audio and/or light emitting battery-powered device 160 with clipping, hooking, mounting or fastening means. The device 160 may be comprised of the following components:
an input means for alert device programming (processor and program may be optional) or settings
a communications means for receiving wireless (including an antenna and at least one processor) and/or wired command and/or programming and/or instruction sets
an output means for alerting, notifying and/or informing users about an emergency and/or trigger condition
a circuit means for relaying an electrical signal from the communications receiver processor chip to a relay to activate the appropriate alert component(s)
an optional data circuit means for relaying the command and/or instruction set from the communications receiver processor chip to the optional program processor
a powering means

Device 160 may be available in a variety of embodiments which may range from being a self-contained alert unit without the requirement for an input means, to having DIP and/or toggle switches as input means to activate a variety and/or range (volume, tonal and/or luminescent patterns) of audio and/or visual emissions, to having a device programming interface to utilize similar functionality as noted with the lamp alert device 150. The primary utility of device 160 is that it may exist as a standalone unit in portable or stationary (mounted) form.

The preferred communications means of device 160 may be comprised of the same components associated with lamp alert device 150. Given the standalone and portable characteristics of device 160, the preferred embodiment of device 160 is utilizing a ZigBee based wireless protocol, because of the operating characteristics with other detectors and sensors, such as, but not limited to, utilizing low power, low cost and acknowledged transmission receipt. An example for the use of device 160 is placing it on fire extinguisher (the present invention also accounts for a device 160 or like device to be integrated on a fire extinguisher to create a new present invention embodiment of a fire extinguisher) to support the use of locating it in the event of an emergency or being in a smoke filled area. The preferred power means for device 160 is a standard alkaline battery, although the device may be adapted for other low power battery and power means.

A guide light 170 may also be another embodiment of device 160 by utilizing a luminary visual alert or guide function. The guide light strip 170 is also another embodiment of the present invention distributed components. The strip 170 may comprise a planar surface with (an) illuminating component(s) and may have other alert means (such as, but not limited to, vibrating, audio and transmission which may be optional or inclusive) that become(s) activated upon the receipt of an electrical current which is originated by at least one trigger event. It may be in a variety of dimensions, preferably with a narrow width. It may be placed on the floor (preferably), ceiling or wall with associated fastening or mounting means as appropriate. A base embodiment of strip 170 may be comprised of the following components:
a communications means for receiving wireless (including an antenna and at least one processor) signals
an output means for alerting, notifying and/or guiding users about an emergency and/or trigger condition
a circuit means for relaying an electrical signal from either a hardwired terminating point on strip 170 or a wireless communications receiver processor chip to a relay to activate the appropriate alert component(s)
a powering means.

The preferred means for activating strip 170 alert components is via a wireless communications connection. Given the standalone characteristics of strip 170, the preferred embodiment of this invention component is utilizing a ZigBee based wireless protocol, because of the operating characteristics with other present invention detector and sensor devices, such as, but not limited to, utilizing low power, low cost and acknowledged transmission receipt. It may also utilize a hardwired means where the strip may reside alongside a floor edge and/or baseboard and the wiring may reside in a narrow housing that runs from in proximity to an electrical receptacle or outlet to a terminating junction on strip 170.

The terminating junction on strip 170 for receiving a signal (via a wired or wireless transmission) is comprised of electrically conducting materials and is connected to a circuit for relaying the signal to the strip 170 output means. The strip 170 terminating junction associated with receiving wireless transmissions is an antenna which is connected to a circuit which terminates in a wireless chipset which is connected to the strip 170 relay circuit and power means.

The output means for strip 170 may be comprised of primarily illuminating components and associated circuitry that reside in (a) durable translucent housing(s), such as, but not limited to, (a) durable plastic housing(s). Another embodiment of strip 170 may comprise additional alert means such as, but not limited to, vibrating component assemblies, audio components and devices for coded wireless transmissions.

The preferred power means for device 170 is standard alkaline batteries (battery quantities differ based on the amount of illuminating components), although the device may be adapted for standard AC power.

Guide light strip 170 may be available in other embodiments that may utilize a higher level of functionality and associated programming as lamp alert device 150 for transmitting commands to other devices. The potential size and proximity of strip 170 in relation to other alert and emergency devices may support the benefit of utilizing device 170 as a transmission source.

One of the purposes for giving a consumer a variety of functionality and power options for guide light strip 170 and other distributed components is to account for redundant or backup functions in the event that other sensor and alert system devices become damaged and/or inoperable in an emergency.

The emergency or first aid kit 180 distributed component is for facilitating a user on its whereabouts and, optionally, on the use of its components in the event of an emergency. It may be available in a variety of embodiments, from comprising solely a signaling means for alerting the user of its location to having voice messaging to facilitate the user of appropriate emergency treatment pending on the type of originating sensor activation and transmission or user button activation associated with (a) kit 180 component(s). Given the range of embodiments, the kit 180 may comprise essentially the same components associated with device 160 or those associated with lamp alert device 150 as described herein:
an input means for alert device programming and voice message recording
a user interface means
a communications means for receiving and/or transmitting wireless (including an antenna and at least one processor) and/or wired command and/or programming and/or instruction sets
an output means for alerting, notifying and/or informing users about an emergency and/or trigger condition and associated action
(a) processing and memory component(s) with at least one software program, processor and associated memory
a data circuit means for relaying the command and/or instruction set from the communications receiver processor chip to the program processor
a powering means.

The primary distinction associated with kit 180 in relation to the preceding distributed components, aside from having a beacon means for an emergency kit, is having one form of embodiment that features at least one button, speaker and voice message apparatus for facilitating the user on proper use of (an) emergency or first aid kit component(s). For example, a kit may comprise a compartment for a tourniquet, whereas the compartment may be in proximity to at least one button with a speaker, and upon the depression of the button, a voice message (which may be factory pre-recorded and multi-lingual) may instruct the user on the proper use of the tourniquet. The kit 180 may have a display or set of buttons to facilitate optimal means of prompting and instruction or pausing and/or replaying portions of a voice message/instruction in the event of an emergency. The messaging functions may be supported with generally available voice chip sets.

It is preferable that the kit 180 is battery powered, but the present invention may be adapted for a variety of power means, such as having a charger system or cartridge and/or a portable power cord.

The medical device 190 distributed component may have essentially the same types of embodiments and functions associated with emergency kit 180. It may comprise a beacon functionality to alert the user of its location and use in the event of an emergency or be available in other embodiments with other added levels of functionality similar to those described in the preceding narrative associated with kit 180. It is accounted for as a medical device 190, because its functionality may be incorporated or be an adjunct to a variety of medical devices. Given the range of embodiments, the device 190 may comprise essentially the same present invention sensor and alert system components associated with devices 160 or those associated with lamp alert device 150 as described herein:
an input means for alert device programming and voice message recording
a user interface means
a communications means for receiving and/or transmitting wireless (including an antenna and at least one processor) and/or wired command and/or programming and/or instruction sets
an output means for alerting, notifying and/or informing users about an emergency and/or trigger condition and associated action
(a) processing and memory component(s) with at least one software program, processor and associated memory
a data circuit means for relaying the command and/or instruction set from the communications receiver processor chip to the program processor
a powering means.

Examples of the medical devices 190 may range from a blood pressure monitor and/or gauge to a defibrillator, as noted in one of the emergency applications of this narrative.

The power means for medical device 190 may vary based on the wide variety of medical devices associated with the present invention. It may also comprise a hybrid battery and directly connected electrical power cord, whereas the wireless receiver, beacon and alert apparatus may be battery powered and the primary device components may be directly electrically powered.

The centralized or hub component system 220 is considered a present invention distributed component, because its primary purpose is to alert users of an emergency and instruct users on appropriate actions associated with the emergency. It may be adapted to operate in conjunction with a main sensor and alert system as well as a Wi Fi or HomePlug™ network or other network that supports voice transmissions (with the appropriate equipment) to provide verbal instruction associated with a respective emergency or trigger condition. It may utilize the same primary functions associated with lamp alert device 150, and, thus, be comprised of the following components:
an input means for alert device programming and voice message recording
a user interface means
a communications means (including an antenna and at least one processor) for receiving and/or transmitting wireless and/or wired command and/or programming and/or instruction sets
an output means for alerting, notifying and/or informing users about an emergency and/or trigger condition and associated action
(a) processing and memory component(s) with at least one software program, processor and associated memory
a data circuit means for relaying the command and/or instruction set from the communications receiver processor chip to the program processor
a powering means.

The primary distinction associated with hub device 220, in relation to the preceding distributed components, is its distributed or networked speaker component(s). Specifically, the hub component 220 may comprise essentially the same elements and functions as the other present invention distributed components, including a voice recording and play apparatus; however, the means for playing the voice message over speakers and the proximity of the speakers to the other device 220 components differs in that these speakers may be remote and connected to device 220 by either wireless or wired means.

The hub device 220 may be in a variety of embodiments for supporting a variety of means and/or embodiments for transmitting a voice message from the device 220 to (a) wired speaker(s) and/or (a) remote wireless speaker(s), utilizing a variety of means such as an AM or FM band, and/or Bluetooth and/or a Wi Fi signal. The remote speakers may comprise the associated components for receiving, processing and converting the signal over an amplified speaker component. The speakers may be part of a radio or stereo receiver with a wireless receiver such as a ZigBee chip set that triggers the activation of the radio or stereo to turn on at the FM band setting associated with receiving the transmitting hub 220 FM signal. The speakers may also be part of a home speaker system, in a variety of embodiments such as being recessed in (a) ceiling(s), where the amplified circuit is connected to a receiver (wireless) or via a hardwired circuit to the hub device 220.

It is preferable that the hub device 220 is electrically powered with a battery backup means.

Another distributed component which may be available in a number of embodiments is a cap top adjunct, cap top or package band (FIGS. 11, 12A through D and 13A through D). The cap top/adjunct/package band is preferably the lowest cost present invention distributed component. This present invention device is preferably a wireless addressable audio and/or luminary emission battery-powered device with clipping, hooking, mounting, fastening, banding or adhesive means (though it may be in the form of other embodiments adapted for wired contact and electrically powered means). The device, such as cap 230, may be comprised of the following components:
an input means for device addressing
a communications means for receiving wireless (including an antenna and at least one processor) signals
an output means for alerting the user to facilitate user action regarding a trigger condition
a circuit means for relaying an electrical signal from the communications receiver processor chip to a relay to activate the appropriate alert component(s)
a fastening means for securing the device to the bottle, bottle cap or package
a powering means.

The input means for device (e.g. cap 230) addressing may be a manual DIP switch or downloadable software or other inexpensive addressing component(s) or means. The purpose for the device addressing is for defining the device in conjunction with the present invention medication administration and aid system and sensor and alert systems to facilitate medication compliance as well as appropriate actions in the event of an emergency. It is preferred that the device addressing be utilized as part of a ZigBee based system. In keeping with a low cost component, a ZigBee-based chip set may cost around $2.50 or less pending on quantity and scale. Thus, the preferred communications medium utilizes a wireless ZigBee chip set.

The device cap or band, such as cap 230, output means may comprise a small bulb or LED component and/or audio component that emits a chirp.

The preferred power means for the cap or band device is a standard alkaline battery, although the device may be adapted for other low power battery and power means.

The fastening means may comprise, but is not limited to comprising, the embodiments depicted in FIGS. 12A through FIG. 12D and 13A through 13D.

FIGS. 12A through 12D illustrate a cap top adjunct device 230 that comprises the previously described components and a securing means for fastening the adjunct 230 to a bottle cap 233. The fastening means for this embodiment may comprise a thin planar element that may be available on a strip of the elements where the element 235 (FIG. 12A) may be removed or peeled from the strip and the removabling facing side may comprise a bonding or adhesive component that enables the element, when placed on the top of a bottle cap 233 (FIG. 12C) or package, to adhere to the bottle cap or package. The opposite or top side of the planar element may also comprise a fastening element. The element may be part of a magnetic component or comprise multiple fine anchoring or bonding materials. The other fastening means for the device adjunct 230 resides on the underside bottom of the adjunct 230. This fastening means may comprise the other magnetic component or multiple fine anchoring or bonding materials that when connected to the top of the thin planar element, adheres to the planar element.

FIGS. 13A through 13D depict a present invention cap top 253. It comprises the components described herein with a fastening means that may comprise a variety of threading, gripping and/or alignment means that complement the threading, gripping and/or alignment grooves that are associated with the bottle top portion. The container 251 includes scan guides 257, and cap 253 includes the alert and communications components 259, as described above.

A primary utility associated with the present invention sensor and alarm system and its distributed components is complementing National Fire Protection Association (NFPA) and Underwriters Laboratories (UL) regulations by providing a more informational and desired actionable construct to sensor and alert systems (which may or may not include voice messaging) which require a 1.5 second interval in between tonal alarm patterns.

In addition, as noted in the introductory statement of this narrative, in the distributed component text and other sections described herein, another key utility of the present invention system is its broader scope of integrated program, applications and functions in comparison with existing sensor and/or alert systems and devices. For example, there are environmental sensor and alert systems that account for playing voice messages regarding the type and location of a detected element such as smoke or carbon monoxide in, for example, a kitchen. Said systems support the intention of providing a desired actionable outcome, such as, for example, closing versus opening windows pending on the emergency condition. The present invention accounts for a variety of means, methods, apparatus, options, backup and redundant configurations and deployments to support a greater likelihood that the desired actions take place for the victims and a variety of constituents. The present invention embodiments associated with enabling the integration of a variety of sensor, alert and notification embodiments into a more encompassing and useful system for all constituents may comprise the following components:
a first detection sensor and/or circuit
a second (or more) detection sensor(s) and/or circuit(s)
at least one communications circuit
a communications processor
a control processor
a control circuit junction
a control circuit
a first alarm circuit
an alert and notification circuit
voice recording and messaging components
a communications means
an interface means
a power means.

The preceding components support the means for the detection, receipt, alert, notification, and communication of conditions and associated information within an environment or dwelling(s) for providing appropriate action(s) and intervention(s). The components may support a variety of embodiments, some of which are disclosed herein, that are apparent to one skilled in the art. In a more encompassing context, any of the components and functions described throughout this filing may be combined with any other functions and associated embodiments presented herein.

A first detection sensor and/or circuit may comprise, for example, a smoke detector element. A second detector sensor and/or circuit may comprise, for example, a carbon monoxide detector element. The preceding sensors/circuits may reside in one enclosure or in separate enclosures.

Either enclosure or a separate enclosure may house a communications circuit which may function as a communications path for the receipt of information associated with (an)other type(s) of sensor(s) and/or (an) additional sensor(s) or sensor testing and administration. The circuit may be connected to a wired and/or wireless communications interface and terminate in a control circuit and/or processor. The processor may be a control processor or a communications processor.

The communications circuit may be associated with a present invention system standalone sensor, such as, but not limited to, a monoxide detector unit with a wall plug and a communications component. The communications component may be wired and/or wireless and capable of transmitting and/or receiving data packets. An example, but not limited to the example, of the wired component may be a HomePlug™ compatible powerline unit with the associated communications means. An example, but not limited to the example of a wireless component may be a ZigBee unit with the associated communications means.

The present invention detection sensor and/or circuits and other detection sensors and circuits may be comprised in a variety of embodiments for a variety of uses—environmental, security and/or medical/health sensor and alert functions; and deployments—pending on the type, quantity and level of critical and redundant function points. This narrative section will account for the preceding embodiments in some of the following constructs: a detection circuit coupled with an alarm circuit and a communications processor circuit; a detection circuit coupled with an alarm circuit, a communications processor circuit and a control processor circuit; a detection circuit coupled with an alarm circuit and a control processor circuit; a detection circuit coupled with a communications processor circuit (for use, for example, for security applications); a detection circuit coupled with a control processor circuit (for example, a security application); and a detection circuit coupled with a control processor circuit and a communications processor circuit.

In addition, as noted, the present invention provides the means for supporting a variety of communications circuit and circuit coupling configurations as well as voice messaging configurations and sequences.

A present invention system component comprising a detection circuit coupled with an alarm circuit and a communications processor circuit may be associated with the previously described present invention system monoxide detector unit with a wall plug and a communications component. In one embodiment, the monoxide detector may comprise a ZigBee communications component, where upon the detection of a monoxide level, the detection circuit may generate an electrical current that may transmit to both an alarm circuit and a communications processor circuit. The unit may emit at least an audible alarm and at least one wireless transmission. The wireless transmission may include the destination device address, the originating device address and/or location and/or the type of monoxide level. In another embodiment of the present invention monoxide detector, the sensor may be calibrated to read two or more monoxide levels and generate signals associated with said levels, the signal generations may originate from a sensor processor and travel over a communications circuit path to a ZigBee processor and transmitter and/or the signal generation may originate from a relay that will produce a certain level of current based on the monoxide level reading. The current level may be transmitted over the alarm circuit and produce a certain type of audible alert based on the associated current level. The current level may also be transmitted to the ZigBee communications processor which may encode a level reading associated with the current level. It is preferable that the sensor processor terminate in a communications circuit, among other terminations, to support the communication of specific level readings.

In one embodiment, the present invention standalone monoxide unit may operate in conjunction with other system components through the interaction of the communications component and circuit with the alarm circuit based on the transmission and receipt of the ZigBee transmission acknowledgement and other instruction sets. For example, upon the detection of a monoxide level, an initial signal may be relayed from the monoxide sensor processor or lead to the communications processor or circuit lead. Upon the receipt of the initial signal, the ZigBee communications processor may transmit a data packet to a ZigBee processor on a central communications circuit and/or other system embodiment(s). The circuit(s) may carry the information data packet(s) to a central system control processor and/or other processor, where the processor may activate one and/or a series of circuit relays and/or data transmissions associated with the information. One of the transmissions may be sent back to the originating activated present invention system monoxide detector with an instruction set to emit (a) certain type(s) and/or set of, or no alarm(s) that complement(s) the tone and/or messaging and/or priority sequence(s) of other central system alarms, alerts messages, transmissions and/or components.

In addition to transmissions between a present invention detector and central or system processors, as noted in the previous example, transmissions may also take place between the present invention system components with other present invention embodiments of remote control devices, personal communicator devices and/or remote servers. For example, the present invention components may not only be adapted for IR communications capability for alarm testing, nuisance alarm silencing, or the temporary silencing of low-battery chirping, a present invention ZigBee personal communicator device may comprise a device list menu for activating the testing and silencing of any present invention sensor from one location, even though the sensors may be in other rooms, by utilizing the appropriate ZigBee network address topology, such as a mesh network. Present sensor and alarm systems, such as smoke detector systems with remote control capabilities are limted by IR functionality that typically requires the IR remote and the sensor to be located in the same room.

The interactive functions and means of the preceding embodiments may apply to other present invention embodiments, such as, but not limited to, other environmental, security and medical/health sensors and alarm apparatus, including present invention distributed components, and critical medical devices such as pacemakers that may be coupled with preventative diagnostic or testing functions that may be adapted with the wireless transceivers described herein, biosensors and biosensor transmitters and transceivers.

A present invention embodiment comprising a detection circuit coupled with an alarm circuit, a communications processor circuit and a control processor circuit may be a hardwired smoke detector configuration. The preferred embodiment of this configuration comprises a detection circuit terminating into a control processor circuit connection or junction where such junction is in on-state and the on-state condition is governed by the control processor being in an on-state, and the on-state condition allows a signal from the detector to initially transmit to the control processor and bypass the alarm and communications processor circuits. The on-state junction condition, being governed by an electrical signal originating from the control processor, remains in said condition until a circuit lead that terminates from the processor to the junction has a loss of power condition. The circuit junction also is coupled with an alarm circuit and a communications processor circuit. The purpose for the junction is to support the primary function of providing the user(s) and constituents, such as emergency response personnel, a sensor, alarm and notification system that comprises the optimum means for desired actions. To support this primary function, it is desired to utilize the control processor as the initial receipt point for generating alarm and notification activations. In the event that there is a problem with the processor, the processor, having a diagnosis capability, would activate a shut off function associated with the circuit junction lead, which would cause an off-state condition in the circuit junction. The off-state control processor condition would cause the relay of the detection signal to bypass the control processor circuit and connect with the alarm circuit and the communications circuit. Given the critical nature associated with the activation of a smoke alarm, biosensor or lethal gas, the junction component provides for optimal and alternative means to support many utilities and desired actions.

In an on-state the processor, upon the receipt of the smoke detector signal, may run a program supporting a variety of functions associated with the smoke detector activation. For example, one function may be to activate the alarm circuit lead under a certain interval and/or pattern. Another function may be to activate a communications function or series of communications functions. The processor may also comprise another circuit or additional circuits for receiving other sensor, remote device and/or server transmissions and/or generating other transmissions or commands such as activating voice messages and/or present invention distributed components and/or server to facilitate appropriate action such as firemen dispatching functions. In the event that the processor malfunctions, the communications circuit in the preceding configuration may also comprise a communications component (wired and/or wireless) where the component and circuit, coupled with an alarm circuit connection, may receive remote control device, remote sensor or server transmissions that may govern the operation of the alarm.

In the embodiment of comprising other circuit terminations, the control processor may comprise a software program hierarchy that supports certain functions and circuit activations, as well as control configurations, pending on the degree, type and quantity of received inputs or signals. A present invention system that may comprise wired and/or wireless data communications protocols such as ZigBee along with the distributed components described herein may support a variety of desired actions associated with a variety of adverse conditions. This will be illustrated further in the narrative when the system comprises an embodiment that may support programmable and/or remote control circuit settings and downloadable software.

Another embodiment of the present invention may comprise a detection circuit coupled with an alarm circuit and a control processor circuit. This circuit configuration may support a variety of environmental sensor configurations that may be comprised under one system that may utilize a control processor and other present invention components as described herein. In addition, it may also support a security sensor and alert configuration which may also be integrated with the present invention control processor and other present invention components. For example, a sliding door contact sensor, may be hardwired to an alarm circuit and a control processor circuit. The circuit configuration may comprise a variety of embodiments such as comprising a control processor circuit junction. The configuration control processor may comprise a variety of programs to account for input from the respective door sensor along with input from other sensors.

Another security embodiment of the present invention system may comprise a detection circuit coupled with a communications processor circuit. An application associated with this embodiment may be a glass window or door with an electrical contact or membrane sensor and circuit that may terminate in a communications circuit. The circuit may terminate into or comprise a communications processor such as, but not limited to, a ZigBee processor that may transmit a message accounting for a code that identifies the respective window, a destination address for, for example the control processor ZigBee component, and its originating ZigBee address.

An embodiment of the present invention system that may provide additional utility to the users and constituents of the system is a configuration that comprises a detection circuit coupled with a control processor circuit. In this embodiment the circuit configuration may be leveraged with a security alarm access panel which may reside, for example, near an entry way door. In this embodiment and application, the present invention sensor and alert system may be adapted to accommodate a door access code and a user code, where the user code may not only apply to alarm deactivation but also to provide input to generate other present invention utilities. The user code may be entered into the system through a variety of means, such as but not limited to, from keypunch to smart card to RFID scanned to biometric input to input from a present invention personal communicator system component. The access panel may function as a user interface. Other embodiments of a user interface may be the remote control device or personal communicator described herein.

One of the other present invention utilities may be for the control processor, upon the receipt of the user code, to transmit data packets to multi-utility enclosures for activating a variety of fixtures and/or appliances such as, but not limited to, lights, a stereo, electric room fresheners, appliances, and/or a main device 10, where some or all of the packets may include the user code, and upon the receipt of the communication and user code, the associated fixtures and/or appliances may operate at settings associated with the user code, where for example, main device 10 may generate a program that may activate an email scan function for new messages addressed to the user name associated with the user code or alert the user of (a) new phone message(s) addressed to the user through a variety of alert and/or announcement means, from playing a voice synthesized message through a text/voice chip through a speaker on device 10 to transmitting a ZigBee packet to a ZigBee chip set associated with control processor to activate a voice messaging component that may comprise a circuit termination to an amplifier where the amplifier may be connected to a speaker system zone that is located in proximity to the entry way the user entered. In this invention voice message alert embodiment, a voice mail or message recorder apparatus may comprise a processor output that transmits a data communication, such as a ZigBee transmission (given it comprises the associated ZigBee chip set and communications means), that includes a voice mailbox number, a destination address for main device 10, and an originating address associated with the mailbox, where upon the receipt of the message, main device 10 stores the pertinent content of the message or activates a counter in the appropriate program associated with the pertinent user code associated with the mail box number. One of the other program sequences associated with main device 10's receipt and processing of the user code may also be generating a medication regimen reminder and inquiry sequence program through a variety of means.

An embodiment that may comprise a detection circuit coupled with a control processor circuit and a communications processor circuit may apply to an environmental or security or medical aid sensor and alert function or both, as with most of the embodiments described herein. For example, an environmental sensor and alert configuration example utilizing the preceding may be a toxic gas sensor that is hardwired to a control processor circuit that terminates in a control processor that has a series of programs that may initially activate a counter agent to contain or neutralize the gas and subsequently activate an alarm. The toxic gas sensor may also be hardwired to a communications component that transmits a preset message associated with the condition. A security sensor embodiment utilizing the preceding circuit configuration may be a video scanning and imaging sensor and processor that may transmit a wired data signal over a control processor circuit and a communications processor circuit upon the matching of a scanned image with an image in a security breach profile table. Though these applications are quite different, the control processor functions associated with receiving the toxic gas activation signal and the security breach data transmission may originate from the same control processor, further, the processor may utilize the same alarm and notification circuitry, control circuitry and voice messaging components and circuitry in a programmable predetermined sequence associated with each respective condition or set of conditions, including the same backup components and their associated sequence, to support a higher probability that appropriate actions are executed. This control processor and control circuit functionality supports optimal means of instruction and alert in a predetermined and temporally phased sequence, because of the circuitry and processor terminations, wiring, processor, programmability and program means described herein. Thus reducing confusion in an emergency or multiple emergency condition. Pending on the degree, type and quantity of emergency conditions, the sequencing and activations of alarms and notifications may be automatically modified through a hierarchical processor software program or through an operator intervention where the sequences and activations are programmed through remote device, remote server or personal communicator administration. The administration may also account for downloading software to account for revising alarm and/or messaging configurations based on changes or additions of sensors to the present invention sensor and alert system.

In addition, pending on the degree, type and/or quantity of emergency conditions, the control processor may be associated with a hierarchical control program where the program may account for threshold and distributed control activation functionality. The functionality may support a backup or alternate master controller configuration where, upon reaching a certain parameter of emergency conditions, the control may cede from the preceding configuration control processor to a, for example, remote master server, either in an automatic switch or operator alert and intervention function.

The key constructs for supporting the broad and integrated functions associated with this present invention system are the control processor, control circuit, software, the voice messaging component(s), the variety of distributed components, and other components and peripherals (including main device 10 and the various medical embodiments).

The preceding components have been described in a variety of embodiments throughout this narrative and may be utilized not only in the specified embodiments but also in like embodiments.

These components, as previously noted, may also be adapted for a variety of system integration levels. For example, present invention embodiments may support the preceding components as available as an integrated system or as separate standalone configurations that comprise the means to be subsequently integrated into a larger system, be integrated with other present invention configurations, or be integrated with a present invention remote master control server. The server component supports added utility and backup to the present invention system described herein

Another primary utility associated with the present invention environmental, security and health system is its means to disseminate information to facilitate appropriate action for a variety of constituents. This utility not only helps the user and/or dwelling member as noted in many applications of this narrative, it also helps a variety of third party constituents.

One example of a present invention embodiment helping a third party constituent is associated with emergency response personnel, such as, for example, firemen, policemen and/or EMTs. Given a present invention sensor, such as a smoke detector, may transmit its device address while activating its audible alarm, the transmission of the device address may be communicated to a main device 10. This communication may take place via a wired and/or wireless connection. In the embodiment of a wireless transmission, the transmission may take place over a ZigBee based wireless network. Upon main device 10's receipt of the ZigBee 104 byte information frame from the respective smoke alarm, main device 10 may process the information and execute a series of actions which may include dialing out to the present invention web server, which, that upon receiving the information, processes and executes a series of call outs and user profile information updates. One of the call outs may be to an alarm service or, pending on the threshold level associated with the smoke detector or detectors, call out to the associated fire department. The fire department may receive or access web information associated with the home or dwelling emergency and rescue which may reside on the present invention web server program. The information may include, but is not limited to, the fire origin area and other affected locations, occupant information (age, disability), dwelling layout, etc.

Server Component, Services and Pricing Method:

As noted throughout this filing, and the paragraphs preceding this narrative heading, the present invention devices and systems described herein may deliver greater utility when their functionality accounts for operating, either directly or indirectly, with (the) present invention server(s) 300 (FIG. 1) and associated services/operational embodiment(s) described herein. In addition, the present invention may be adapted for a variety of marketing and advertising mediums, such as, but not limited to, banners, pop-ups, messaging, search engine services, electronic and/or direct mail coupons, games, interactive and/or direct mail questionnaires, and/or electronic and/or direct mail messaging and newsletters, as well as, under appropriate consent and federal and state guidelines, an information source for a variety of constituents to support affordability and widespread use. The preceding mediums and services may also be adapted for the present invention embodiments described herein, where the adaptations may be construed as present invention embodiments. Another embodiment associated with the present invention server utilities and services is a pricing method for present invention components, devices and/or systems when they are integrated with the server and services embodiment(s).

The present invention server(s) and associated software, memory, hardware and peripheral(s) component may be adapted for one or more of the following:
information receipt, processing, inquiry, presentation and/or dissemination
alert, notification, and intervention
interactive functions and programs
uploadable and downloadable data, information, programs, and programming
scalable architecture and infrastructure and economy of network medium(s) and facilities
redundant and/or backup configuration
a variety of advertising, marketing-based and/or information/news-based services and mediums
networked and distributed architecture and deployment associated with the preceding.

This present invention server system, in whole or in part, may function for a variety of constituent communities as intra, inter, and/or extranet embodiments. The constituents and entities may comprise, but are not limited to comprising, the following: health and medical communities—patients; middle aged through elderly individuals; families; parents; the sandwich generation; assisted living facilities; health services providers; insurance providers; third party administrators; out-patient facilities; hospitals; managed care providers; health, medical and psychiatric facilities and/or institutions; anyone with a disability, disease, chronic condition or injury requiring medication regimens or assistance; doctors; nurses; pharmaceutical industry; medical device industry; market research entities; emergency response personnel—EMTs, policemen, and firemen; many government entities and personnel; military entities and personnel; dwelling environmental safety and security services companies; and industrial, commercial, and/or residential property owners and/or managers.

The preceding constituents and entities may utilize one or more of the following present invention embodiments: medical and health; environmental safety; and/or security.

### Medical and Health Embodiment

The information receipt, processing, inquiry, presentation, and/or dissemination capabilities of the present invention system medical and health server embodiment may comprise a variety of functions and information content, reporting, dissemination and templates based on the constituent group utilizing the server system.

For example, the information and report presentation for a doctor's inquiry may have more specific or solely scientific terms in comparison to a report generated from a family member user inquiry. In another example, a visiting nurse practitioner may access the web site with appropriate login permissions to confirm or close out a patient visit regimen. The site page associated with this type of patient profile may be only accessible by authorized parties. Other profiles, such as a patient profile and vitals record, as described in a previous section, may only be accessed by authorized personnel under certain conditions such as an emergency with appropriate patient and/or family consent.

A present invention server program information profile (associated with the uploading of metrics from present invention devices to the server) may comprise various historical and trending functions. It may be presented on a server program site page with a search engine link associated with a patient's condition. For example, if a diabetic may have been incurring a consistent sugar level reading over a certain period, then he/she or his/her family member may want to utilize a search function to obtain more information about practices or products that support reducing the reading. In addition, the site page may also offer emailing capabilities associated with various types of diabetic information sources, from, but not limited to, treatment news to association news or meetings.

The dissemination of patient information, as well as alert, notification and intervention information and means may be best utilized through the present invention server system.

Though a number of present invention system devices described herein may communicate to other devices and/or serve as hub devices to support economy of resources, functionality and infrastructure and first level alert and intervention, the server component utilizes the best means for effective, comprehensive and economical communication. The information dissemination, alert, notification and intervention may be delivered to portable devices such as, but not limited to, PDAs, cell phones, integrated cell phone/PDA devices, various portable PCs, watches, eyewear, and/or ear phones/headphones; and non-portable devices such as PCs, and/or receipt and dispatch stations or centers.

The present invention interactive functions and programs may range from, but is not limited to, accommodating visiting nurse practitioner patient visit/regimen confirmation, where the confirmation may generate a confirmation number to secure a compliance record of the confirmation, to drug trial user feedback sessions.

The up loadable functions associated with the present invention may range from, but is not limited to, reporting medication and/or physical therapy regimen compliance to insurance providers and/or third party administrators, to reordering prescriptions based on a main device 10 and/or various pill enclosures (such as, but not limited to, with weight scales) and/or dispensers and/or server prescription and dosage record program triggering the ordering activity. Another key present invention utility is the downloading of a prescription program to main device 10 upon the transmission of the program from the originating physician and/or pharmacist. Another helpful present invention downloadable function is changing device threshold/exception parameters, which is especially helpful for users who are not accustomed to administering any type of device or who may have an aversion or uneasiness to performing the function. In this example, an authorized family member, who may live remotely, may access the present invention web site profile (with appropriate login permissions) and change a medical device parameter. It is important to note that certain device administration functions may only be permissible by authorized medical professionals, such as changing a drug regimen. The ability to perform the administration remotely greatly supports efficient resource time.

The server component of the present invention system also supports economy of scale for supporting widespread acceptance. The component is accounted for under a scalable architecture that may utilize a bundling of network mediums from high portal throughput to volume pricing calling/messaging plans over various mediums such as, but not limited to, a variety of cellular and/or IP and/or other communications networks (LAN, WLAN, WAN, digital, UWB, Wi Max, basic dialed, etc.).

The system may comprise redundant and/or backup configuration deployments to support uptime for critical retrieval and functions such as emergency receipt, alert, notification and intervention.

Another means to support economical and widespread system use is utilizing a variety of advertising, marketing-based and/or information/news-based services and mediums.

As noted in the filing narrative, there are a variety of advertising and marketing mediums that may be adapted for the present invention. For example, the present invention server program may account for an ordering/reordering function for a certain brand of analyte strips and may receive acknowledgement from a shipping center when the quantity may have been shipped (as well as the shipping interval selected). The information may be recorded and be utilized in a reminder function program. Additionally, the analyte strip order may be transmitted to a marketing database program which may generate a direct mail or email coupon and informational offer to incent the purchase of the same and/or other products.

The preceding example accounts for a marketing database which, with appropriate consent and in accordance with federal and state guidelines, may be utilized for capturing highly valuable market intelligence such as, for example, a wealth of drug and demographic information based on the information generated from the present invention server system.

Another valuable information source for users and constituents associated with patient users is the present invention's linkage with advertising and information/news-based services. The services, which include search engine and related advertising embodiments, may be highly targeted to the patient user and, for example, families of the patient user desiring more knowledge and/or products/services related to the patient's condition(s).

The server site and associated information may be accessed by a variety of devices with various access means such as, but not limited to, browser-based and/or thin client portable and non-portable devices.

The access and operations efficiency of the server system may be supported by a distributed architecture.

### Environmental and Security Embodiment

The present invention server component associated with environment and security systems may be comprised of most of the functions and architectural characteristics covered in the preceding passage associated with the medical and health embodiment.

This embodiment also comprises utilities which are unique from the medical and health component that facilitate appropriate action for environmental and security safety. Utilities such as a dwelling and/or facility software blueprint which may include rooms, room dimensions, entry and access ways, windows, and sensor addresses and locations in enough detail to familiarize emergency response personnel with the dwelling and effective routes for access and deployment are components of the present invention. The information may also be complemented with occupant information (number of family members, ages, disability(ies) etc.).

Another present invention utility that facilitates effective rescue is a means to prioritize the delivery of emergency and rescue information. One embodiment of the means is a downloadable program for changing the priority, delivery and content enunciated over an alarm system. For example, a current system with a circuit and associated circuit overlay(s) may emit a tone/chirp and/or patterned tone/chirp which may be interleaved with a (synthesized and/or recorded) verbal message regarding the type and/or location of the environmental emergency, the present invention may comprise a sensor and/or associated sensors that may detect more element metrics or other elements that may facilitate appropriate response such as gas emissions and/or temperatures or safer access and exit points. The organization of the information and the prioritized dispatching of the information or actions associated with the information may be facilitated by the ability to distribute the information over a variety of present invention components or components adapted for working with the present invention at the emergency location as well as to other constituents.

In addition, another embodiment of the present invention system programmability utility is a programmable circuit overlay or system of programmable circuit overlays which may be utilized with a hardwire circuit and circuit overlay alar/alert system or subsystem and processor embodiment. A hardwire circuit and circuit overlay system is most effective for accounting for an emergency condition, such as, for example, a fire, and emitting a tone/chirp signal and/or signal pattern associated with a smoke alarm, and even enunciating the type of detected analyte/element and possible location of the trigger element in, as previously noted, a temporal phase sequence for minimizing confusion and facilitating desired focus and action for such an emergency. This coordinated and temporal phased sequence may be leveraged in the present invention programmable circuit overlay system where one or more circuits and associated overlays may be programmed and updated in real time to facilitate the desired actions in the event of an emergency. The programmable circuit overlay system may be accessed through a device interface and/or panel that may be wired to a processor comprising the programmable circuit administration. It may also be administered wirelessly through a remote control device, personal communicator, and/or server and a communications transceiver, communications circuit, and communications circuit and processor.

The present invention server is a preferable embodiment for supporting the remote functionality of a programmable circuit overlay system in an emergency condition. The server may function as a remote component for receiving transmitted sensor information. The sensor transmission may take place over a main device 10 or backup devices pending on the degree of backup and type of dwelling/facility. The main device may have primary and secondary backup communications means such as a dial up, digital cellular, ultra wide band, or emergency communications band spectrum. The server, upon receiving the information may automatically process and download or display a prioritized alert and instruction program to a central command agent for review, edit and transmission. The program may account for a four phase temporal circuit activation where the first circuit activation may be a recognizable patterned smoke tone alert, the second phase may be the enunciation of the words, “smoke basement, first floor corner of Smith and Jones Streets”, the third phase may be repeat of the second circuit message, and the fourth phase may be an occupant exit message such as, “all fire exits are safe, primary exit is Court St” (where Court St. may be on opposite corner of Smith St.). In the event that the fire engulfs a certain area, the information may be transmitted to the server for a program and real time messaging dispatch update.

In the midst of the program function, the server may also dispatch other information to other devices (including receiving, processing and disseminating patient medical or medical device information or security breach information) to facilitate effective safety and rescue.

The value of the present invention remote web server receiving, processing and disseminating effective information, coupled with the value of the same web server containing medical and security breach information, could be instrumental in achieving rapid care response success for a variety of third party constituents—from firemen to policemen, to EMTs to a hospital.

The utilities gained from the present invention embodiments of having an integrated system for delivering the best economy, safety and utility for many constituents will be numerous.

Most of the present invention embodiments may be manufactured of commonly available materials. The electrical, processor and communications device circuitry and electrical elements employed are commonly available (with the exception of certain biosensors undergoing development, yet me be adaptable to the present invention system) known to one skilled in the art, although not in the configuration and arrangement of the present invention.

Pricing Method:

The present invention may comprise a pricing method that supports purchasing system components at an affordable price through the use of paying for a variety of monthly subscription services.

The subscription service may be payed by users, family members and constituents who may subscribe to tiered package services. The services may comprise a medical/health information access service where, for example, a family member, with appropriate permissions may follow up on medication regimen compliance or health metrics associated with a loved one. Another subscription service may comprise an alert, notification, and/or intervention embodiment where, for example, a family member may be a primary recipient of an alert message upon a trigger event. Another service may comprise both of the preceding embodiments. Another present invention pricing method service may comprise the preceding with a monthly subscription to a home security and alert/messaging service comprising the embodiments described herein. The preceding may also be bundled with a home environmental information and service offering.

The subscriber service may deliver discounts off of certain equipment and/or subscription packages pending on the amount of family/constituent member subscribers and/or amount of services associated with the subscribers.

The subscription service and/or associated equipment may also be discounted for the end user by offering it to the end user as part of a package service bundle with communications and/or cable provider offerings. The subscription service and/or associated equipment may also provide and promote a certain amount of proceeds for charitable causes such as, but not limited to, medical research, non-profit hospitals and safety or local safety and rescue organizations.

As previously noted, many of the present invention system embodiments may be sold separately; however, they may also be priced as part of other service bundles. For example, a present invention multi-utility enclosure in a certain lighting fixture embodiment which may serve as a communications hub for a variety of, for example, home networked products be available at a variety of pricing points based on the type and/or quantity of subscription services a user may purchase. The linkage of the lighting and communications fixture to the services may be where the services may comprise, for example, broadband and internet telephony packages where the fixture may comprise the embodiments described herein that complement the package offerings.

The present invention embodiments may also utilize pricing, discounting and credit methods based on present invention services that may utilize a marketing database in conjunction with ordering activity and stocking, for example, but not limited to the example, medication or health product reorder activity as previously described herein, where the methods and practices are supported by user consent and within federal and state guidelines.

The present invention may comprise other pricing methods, such as, but not limited to, paid subscription information and/or database services for industry, academic and government entities who desire various pharmaceutical, safety, security and/or demographic data under appropriate individual consent and state and federal guidelines.

Another preferable pricing embodiment method is charging for a variety of advertising and marketing mediums and services targeted at user and constituent segments and use of the present invention system where the mediums may be or be comprised of, but not limited to the following: search engine services, banners, pop-ups, messaging, electronic and/or direct mail coupons, games, interactive and/or direct mail questionnaires, and/or electronic and/or direct mail messaging and newsletters. The search engine services, in conjunction with the present invention web site embodiment, provide a compelling value, because the user of the embodiment is likely to be a targeted and focused prospect. For example, a family member of a system user who may be a diabetic, who may be designated to inquire about the user's health metrics and regimen compliance, and thus, utilize the present invention web site, may also desire more information about the disease or products or services, and thus likely perform a search regarding the preceding. Upon performing the search, the family member may support a higher response rate to advertising tailored to the topic, because of the family member's focus regarding this topic and desire to help the diabetic family member.

The preceding search engine utility in conjunction with the present invention system is another example of the many applications and utilities the present invention offers by comprising adaptations and means to link critical (and)/or valuable information to appropriate sources for a desired action(s) from and for a variety of constituents. The present invention provides the means for the following to take place that may produce a broad range of results, including the search engine utility: an abnormal blood glucose reading is recognized from a meter 120 and/or device 125 program that generates a highly reliable transmission that at least includes the abnormal reading to a main device 10 or backup present invention timer and device controller, where the main device 10 (or backup controller may engage in a medical mode program upon receipt of the coded transmission that may comprise the command and perform accordingly) may receive the input, process the information and execute at least one output where the output may comprise the metric information, the user, and the time and date associated with the reading where the preceding information may be communicated to a server 300 which may also time and date stamp the receipt of the message, where the server may generate a text message and alert to a designated family member and/or other parties, where the family member and/or other party may be engaged for appropriate action and confirm the receipt and/or action with the server. The family member, upon performing the actions, may be spurred to utilize the server 300 web site embodiment to perform the previously described activity where the activity may result in utilizing the search engine. As noted throughout the narrative, the present invention system comprises many economical and highly reliable innovations, means and deployments to support the widespread acceptance of the system to allow for many users, family members, and a variety of constituents to benefit from its many utilities.

The sensors, processors, memory, circuitry, electrical components, housings, fittings and bonding and securing means for the components described herein are comprised of conventional materials, designs and configurations, except for the designs associated with the present invention embodiments described herein.

It is understood, as illustrated in this filing, that any of the embodiments described herein may be combined with any other embodiment (and)/or feature presented herein. In addition, one skilled in the art understands that many of the innovations may comprise a variety, or combination, of separate components as well as customized integrated circuitry and/or software/firmware and/or processor and memory embodiments as alternative configurations and programs for providing the present invention utilities described herein. For example, a memory means for digitized voice commands may be stored on a variety of storage mediums, such as, but not limited to, random access memory chips, read only memory chips, flash memory apparatuses, optical storage media, magnetic storage media, or magneto-optical storage media.

It is also understood that the network protocols and means described herein may evolve or be modified where the modification may support other like protocol standards that may also be adapted with the present invention system and be construed as present invention embodiments when utilized, integrated or comprised with or in the present invention apparatuses, devices and/or systems. Protocols such as, but not limited to, ZigBee, Wi Fi, Bluetooth, UWB, HomePlug™ and Ethernet compatible network protocols, and respective offshoots of the protocols apply to the preceding statement related to said present invention embodiments. In addition, the Wi Fi standards associated with or supporting at least one or more of the present invention embodiments described herein are, but not limited to, the following: 802.11g; 802.11b; 802.11a; or 802.1 in. Portions of the present invention system, such as, for example a main device 10 or timer, controller and router embodiment may comprise Wide Area Network communications interfaces to interact with Wi Max, broadband, DSL, high-speed cable, (and)/or dial-up networks.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A monitoring, control and alert system selected from the group consisting of medical and healthcare, environmental, security, entertainment, and web-sourced content which comprises:
at least one apparatus having:
(a) at least one input means for receiving at least one of a reporting communication and an exception communication from at least one other apparatus;
(b) at least one output means for transmitting at least one communication associated with said at least one of a reporting communication and an exception communication where said transmission is selected from the group consisting of at least one of the following: audible, visual, vibratory, wireless data, and wire data; and,
(c) at least one processor functionally connected to said at least one input means and said at least one output means, said at least one processor having sufficient components, hardware and software for supporting at least one wireless communications interface, said at least one processor further having sufficient components, hardware and software to provide at least one function selected from the group consisting of tracking patient progress, creating a reminder alert, monitoring medication dosage, presenting information inquiry for response, and alert receipt and alert transmission.

2. The system of claim 1 wherein said at least one processor further has sufficient components, hardware and software to provide at least one function selected from the group consisting of notification, ordering, device programming and administration, device control, intervention, and non-medical functions that support user well being.

3. The system of claim 1 that includes a main device that is selected from the group consisting of a portable device, a stationary device, a mounted fixed device, and a hybrid device having portable components and mounted components, said device including:
(a) at least one program and processor for performing at least one system function associated with an instrument wherein said instrument may be at least one of the following: a medical device, a biosensor, a medication device, a medical device interface and housing, and a medication aid device interface and housing;
(b) wireless communications components for transmitting or receiving at least one function selected from the group consisting of device metrics, device programming, medication regimen information, device information, and patient information;
(c) at least one display;
(d) at least one function selected from the group consisting of an alert function and an information function, said at least one function being selected from the group consisting of audible, visual, vibratory, wireless data communication and wire data communication;
(e) at least one button to interface with at least one program on at least one main device processor; and.
(f) at least one connected circuit interface or wireless communications interface between at least one said main device circuit and at least one of separate device processor, separate device circuit, and combination thereof.

4. The system of claim 3 wherein said at least separate device processor and circuit is associated with at least one of the following: a medical device, a biosensor, a medication device, a medical device interface and housing, and a medication aid device interface and housing.

5. The system of claim 3 that further includes communications means to a storage apparatus for storing digital patient records.

6. The system of claim 5 wherein said patient record that may include at least one component selected from the group consisting of: vital statistics; medication and allergy information; medication regimen; medication history; and body metrics and associated history.

7. The system of claim 3 wherein said main device includes at least one amplifier and speaker.

8. The system of claim 3 that includes a device interface and housing for at least one of the following: a medical device adaptable to said device interface and housing, a medication aid device adaptable to said device interface and housing, and combinations thereof, wherein said device interface and housing comprises:
(a) at least one processor for processing information associated at least with said medical device, medication aid device, and combination thereof;
(b) at least one data interface for supporting the transfer of information of information between said associated medical device, medication aid device, and combination thereof and at least one said device interface and housing processor;
(c) at least one visual indicator means where said visual indicator means is selected from the group consisting of a display, a LED, and a bulb and bulb enclosure;
(d) at least one button to interact with said processor;
(e) and at least one communications interface for connecting said device interface and housing to a communications device or circuit of said main device of the system of claim 3.

9. The device interface and housing of claim 8 that includes at least one switch interface or processor setting to support the option for enabling said device interface and housing to function as a standalone system when coupled with a medical device or medication aid device adaptable to said device interface and housing, or as an integrated component when coupled with said device interface and housing and main device communications interface of claim 8.

10. The system of claim 3 wherein said main device includes at least one of the following: a bar code reader and a bar code reader supporting software program, an RFID reader and supporting software program, and combinations thereof.

11. A communications apparatus that comprises at least one interface that supports at least one of the following networks: Wi Fi, cellular, Wi Max, broadband, Digital Subscriber Loop, Ethernet, Ethernet compatible, dial-up, a proprietary protocol wire network, a proprietary protocol wireless network, a powerline network, a digital satellite network, and combinations thereof, and at least one processor and interface selected from the group consisting of:
(a) an apparatus that receives and transmits ZigBee protocol device addressing and instruction/coding/information packets/sets to or from at least one selected from the group consisting of a ZigBee device controller, a full function device and a ZigBee reduced function device;
(b) an apparatus that receives and transmits UWB device addressing and instruction/coding/information packets/sets to or from at least one device utilizing a UWB platform;
(c) an apparatus that receives and transmits mesh network device-addressing and instruction/coding/information packets/sets to or from at least one device utilizing a mesh network platform;
(d) an apparatus that receives or transmits one-way coded wireless communications device addressing and instruction/coding/information packets/sets to or from at least one device utilizing a one-way coded wireless platform;
(e) an apparatus that receives and transmits two-way coded wireless communications device addressing and instruction/coding/information packets/sets to or from at least one device utilizing a two-way coded wireless platform.

12. The system of claim 1 that further includes a communications apparatus that comprises at least one interface that supports at least one of the following networks: Wi Fi, cellular, Wi Max, broadband, Digital Subscriber Loop, Ethernet, Ethernet compatible, dial-up, a proprietary protocol wire network, a proprietary protocol wireless network, a powerline network, a digital satellite network, and combinations thereof, and
at least one processor and interface selected from the group consisting of:
(a) an apparatus that receives and transmits ZigBee protocol device addressing and instruction/coding/information packets/sets to or from at least one selected from the group consisting of a ZigBee device controller, a full function device and a ZigBee reduced function device;
(b) an apparatus that receives and transmits UWB device addressing and instruction/coding/information packets/sets to or from at least one device utilizing a UWB platform;
(c) an apparatus that receives and transmits mesh network device addressing and instruction/coding/information packets/sets to or from at least one device utilizing a mesh network platform;
(d) an apparatus that receives or transmits one-way coded wireless communications device addressing and instruction/coding/information packets/sets to or from at least one device utilizing a one-way coded wireless platform;
(e) an apparatus that receives and transmits two-way coded wireless communications device addressing and instruction/coding/information packets/sets to or from at least one device utilizing a two-way coded wireless platform.

13. The system of claim 2 that further includes a communications apparatus that comprises at least one interface that supports at least one of the following networks: Wi Fi, cellular, Wi Max, broadband, Digital Subscriber Loop, Ethernet, Ethernet compatible, dial-up, a proprietary protocol wire network, a proprietary protocol wireless network, a powerline network, a digital satellite network, and combinations thereof, and
at least one processor and interface selected from the group consisting of:
(a) an apparatus that receives and transmits ZigBee protocol device addressing and instruction/coding/information packets/sets to or from at least one selected from the group consisting of a ZigBee device controller, a full function device and a ZigBee reduced function device;
(b) an apparatus that receives and transmits UWB device addressing and instruction/coding/information packets/sets to or from at least one device utilizing a UWB platform;
(c) an apparatus that receives and transmits mesh network device addressing and instruction/coding/information packets/sets to or from at least one device utilizing a mesh network platform;
(d) an apparatus that receives or transmits one-way coded wireless communications device addressing and instruction/coding/information packets/sets to or from at least one device utilizing a one-way coded wireless platform;
(e) an apparatus that receives and transmits two-way coded wireless communications device addressing and instruction/coding/information packets/sets to or from at least one device utilizing a two-way coded wireless platform.

14. The system of claim 3 wherein said main device includes a communications apparatus that comprises at least one interface that supports at least one of the following networks: Wi Fi, cellular, Wi Max, broadband, Digital Subscriber Loop, Ethernet, Ethernet compatible, dial-up, a proprietary protocol wire network, a proprietary protocol wireless network, a powerline network, a digital satellite network, and combinations thereof, and at least one processor and interface selected from the group consisting of:
(a) an apparatus that receives and transmits ZigBee protocol device addressing and instruction/coding/information packets/sets to or from at least one selected from the group consisting of a ZigBee device controller, a full function device and a ZigBee reduced function device;
(b) an apparatus that receives and transmits UWB device addressing and instruction/coding/information packets/sets to or from at least one device utilizing a UWB platform;
(c) an apparatus that receives and transmits mesh network device addressing and instruction/coding/information packets/sets to or from at least one device utilizing a mesh network platform;
(d) an apparatus that receives or transmits one-way coded wireless communications device addressing and instruction/coding/information packets/sets to or from at least one device utilizing a one-way coded wireless platform;
(e) an apparatus that receives and transmits two-way coded wireless communications device addressing and instruction/coding/information packets/sets to or from at least one device utilizing a two-way coded wireless platform.

15. A biosensor and a biosensor communications apparatus that interfaces with a ZigBee protocol apparatus.

16. The system of claim 1 that further includes a biosensor and a biosensor communications apparatus that interfaces with a ZigBee protocol apparatus.

17. The system of claim 2 that further includes a biosensor and a biosensor communications apparatus that interfaces with a ZigBee protocol apparatus.

18. The system of claim 3 that further includes a biosensor and a biosensor communications apparatus that interfaces with a ZigBee protocol apparatus.

19. The system of claim 1 that includes a wired communications interface associated with one component of said system wherein said interface is a HomePlug™ interface for power line communications.

20. The system of claim 1 that includes a wired communications interface associated with one component of said system wherein said interface is Ethernet compatible.

21. A HomePlug™ communications device that comprises at least one processor and interface that receives and transmits ZigBee protocol device addressing and instruction/coding/information packets/sets to or from at least one ZigBee device controller or full function device or a ZigBee reduced function device.

22. The system of claim 1 that includes a HomePlug™ communications device that comprises at least one processor and interface that receives and transmits ZigBee protocol device addressing and instruction/coding/information packets/sets to or from at least one ZigBee device controller or full function device or a ZigBee reduced function device.

23. The system of claim 1 wherein said system includes a device with a processor and components for performing at least one of the following functions: voice recording and playing said recorded voice messages associated with said information, receiving and processing information and playing pre-recorded messages, and receiving and processing information and playing voice synthesized messages associated with said information, wherein said device includes at least one circuit that is activated by at least one of an integrated source and a remote source, and activation includes playing at least one voice message associated with at least one trigger condition selected from the group consisting of: an environmental sensor, a sensor diagnostic activation, a security sensor or breach, a personal communicator transmission, and a transmission originating from at least one component of said system.

24. The system of claim 23 wherein said system includes a device with a processor and components for performing at least one of the following functions:
(a) a transmission activated from a reader scanner associated with at least one of the following: a bar code, RFID, Optical Character Recognition, a Line of Sight receiver, and combinations thereof;
(b) a transmission activated by a communications transmission or a telephone call or telephone call session utilizing touch-tone signaling; and
(c) combinations thereof.

25. The system of claim 23 that further includes at least one speaker having an interface with said device through a component selected from the group consisting of a wired component, a wireless component, a wide area network component, a local area network component and combinations thereof.

26. The system of claim 24 that further includes at least one speaker having an interface with said device through a component selected from the group consisting of a wired component, a wireless component, a wide area network component, a local area network component and combinations thereof.

27. The system of claim 23 wherein said device is integrated with at least one environmental sensor or said device is a component of at least one environmental sensor and alert system.

28. The system of claim 24 wherein said device is integrated with at least one environmental sensor or said device is a component of at least one environmental sensor and alert system.

29. The system of claim 27 wherein said device has sufficient software and hardware to receive a circuit activation or coded transmission from at least one environmental sensor or sensor transmitter and said transmission contains information that at least identifies the type of detected element or said circuit activation terminates in a circuit relay where said relay or transmission is associated with playing a message associated with the type of detected element.

30. The system of claim 28 wherein said device has sufficient software and hardware to receive a circuit activation or coded transmission from at least one environmental sensor or sensor transmitter and said transmission contains information that at least identifies the type of detected element or said circuit activation terminates in a circuit relay where said relay or transmission is associated with playing a message associated with the type of detected element.

31. The system of claim 27 wherein said device may receive a circuit activation or coded transmission from at least one environmental sensor or sensor transmitter and said transmission contains information that at least identifies the type of detected element and the location or address of said activated sensor or said circuit activation terminates in a circuit relay where said relay or transmission is associated with playing a message associated with at least one of the type of the detected element and location of said activated sensor.

32. The system of claim 28 wherein said device may receive a circuit activation or coded transmission from at least one environmental sensor or sensor transmitter and said transmission contains information that at least identifies the type of detected element and the location or address of said activated sensor or said circuit activation terminates in a circuit relay where said relay or transmission is associated with playing a message associated with at least one of the type of the detected element and location of said activated sensor.

33. The system of claim 23 wherein said device is integrated with at least one security sensor or said device is a component of at least one security system.

34. The system of claim 24 wherein said device is integrated with at least one security sensor or said device is a component of at least one security system.

35. The system of claim 33 wherein said device has sufficient software and hardware to receive a circuit activation or coded transmission from at least one security sensor or sensor transmitter and said transmission contains information that at least identifies the type of detected security condition or said circuit activation terminates in a circuit relay where said relay or transmission is associated with playing a message associated with the type of detected security condition.

36. The system of claim 34 wherein said device has sufficient software and hardware to receive a circuit activation or coded transmission from at least one security sensor or sensor transmitter and said transmission contains information that at least identifies the type of detected security condition or said circuit activation terminates in a circuit relay where said relay or transmission is associated with playing a message associated with the type of detected security condition.

37. The system of claim 33 wherein said device may receive a circuit activation or coded transmission from at least one security sensor or sensor transmitter and said transmission contains information that at least identifies the type of detected security condition and the location or address of said activated sensor or said circuit activation terminates in a circuit relay where said relay or transmission is associated with playing a message associated with at least one of the type of the detected element and location of said activated sensor.

38. The system of claim 34 wherein said device may receive a circuit activation or coded transmission from at least one security sensor or sensor transmitter and said transmission contains information that at least identifies the type of detected security condition and the location or address of said activated sensor or said circuit activation terminates in a circuit relay where said relay or transmission is associated with playing a message associated with at least one of the type of the detected element and location of said activated sensor.

39. The system of claim 1 which further includes an ancillary electronic device selected from the group consisting of a lighting fixture, an appliance, an entertainment system component, an alarm, and a speaker, and wherein at least a portion of the components of said system that are set forth in claim 1 are located within said ancillary electronic device.

40. The system of claim 39 wherein said ancillary electronic device includes communications components selected from the group consisting of wire, wireless and combinations thereof wherein said wireless communications components are selected from the group consisting of at least a ZigBee network component, a Wi Fi network component, a mesh network communications component, a one-way coded wireless network component, and a two-way coded wireless communications network component.

41. The system of claim 39 wherein said ancillary electronic device includes a Wi Fi router or access point and associated components to support at least communication from the group consisting of internet telephony, instant messaging, digital picture transport, streaming audio, and streaming video, wherein said router or access point may be utilizing at least one Wi Fi standard selected from the group consisting of: 802.11g; 802.11b; 802.11a; and 802.11n.

42. A digital picture display apparatus, said apparatus comprising:
(a) at least one display; and
(b) at least one processor, software and communications components for at least receiving and displaying digital pictures through at least one access and program means selected from the group consisting of an electronic mail program, a browser-based program, a timer-based program, a push-based web server program, and combinations thereof.

43. The digital picture display apparatus of claim 42 wherein said apparatus comprises at least one program and associated memory for enabling at least the following functions:
(1) access to an email server;
(2) email logging on to said server;
(3) receipt of email that is pertinent to said email logging on and download of said email to said at least one processor;
(4) reading and capturing of an email originating identifying name;
(5) comparing of said originating identifying name with names from a name table;
(6) opening of email when said originating identifying name matches with a name from said name table, said opening of email includes opening of email attachment when said email is associated with a file containing a digital picture and said file is associated with application software supporting the opening and display of said file; and,
(7) displaying the digital picture content of said email attachement file on said display of said digital picture display apparatus.

44. The digital picture display apparatus of claim 43, wherein said email program is supported by a timer program where said timer program may be configurable by means selected from the group consisting of user interface administration, factory-set administration, remote server administration, communications means administration, and combinations thereof.

45. The digital picture display apparatus of claim 42 wherein said browser-based program is supported by a timer program wherein said browser and timer programs may be configurable by means selected from the group consisting of user interface administration, factory-set administration, remote server administration, communications means administration, and combinations thereof.

46. The digital picture display apparatus of claim 42 wherein said at least one processor, software and communications components support receiving a communication selected from the group consisting of wire communications, wireless communications, audible communications, user interface input communications, and combinations thereof, wherein said processing of said communication produces an output that at least comprises the display of information associated with said communication over said digital picture display apparatus display.

47. The digital picture display apparatus of claim 46 being a component of a medical and health care monitoring, alert and intervention system which comprises:
at least one apparatus having:
(a) at least one input means for receiving at least one of a reporting communication and an exception communication from at least one other apparatus;
(b) at least one output means for transmitting at least one communication associated with said at least one of a reporting communication and an exception communication where said transmission is selected from the group consisting of at least one of the following: audible, visual, vibratory, wireless data, and wire data; and,
(c) at least one processor functionally connected to said at least one input means and said at least one output means, said at least one processor having sufficient components, hardware and software for supporting at least one wireless communications interface associated with at least one of the following: Wi Fi, ultra wideband (UWB), ZigBee, Blue Tooth, mesh networks, cellular, one-way wireless coded communications, two-way wireless coded communications, proprietary wireless network protocols and systems, and combinations thereof, wherein,said at least one processor further having sufficient components, hardware and software to provide at least one function selected from the group consisting of tracking patient progress, creating a reminder alert, monitoring medication dosage, presenting information inquiry for response, and alert receipt and alert transmission.

48. The digital picture display apparatus of claim 47 wherein said at least one processor further has sufficient components, hardware and software to provide at least one function selected from the group consisting of notification, ordering, device programming and administration, device control, intervention, and non-medical functions that support user well being.

49. The system of claim 3 wherein said at least one display of said main device is comprised in the digital picture display apparatus of claim 47.

50. The digital picture display apparatus of claim 42 that which further includes an ancillary electronic device selected from the group consisting of a lighting fixture, an appliance, a radio, an entertainment system audio or video component, an alarm, and a speaker, and wherein at least a portion of the components of said system that are set forth in claim 42 are located within said ancillary electronic device.

51. The digital picture display apparatus of claim 50 wherein said ancillary electronic device includes communications components selected from the group consisting of wire, wireless and combinations thereof wherein said wireless communications components are selected from the group consisting of at least a ZigBee network component, a Wi Fi network component, a mesh network component, a two-way coded wireless communications network component, and a one-way coded wireless communications network component.

52. A support device system which comprises, in combination:
(a) a support device selected from at least one of the following: a fixture, enclosure, pedestal, base and mounting, and combinations thereof that at least partially is supporting a functional device selected from at least one of the following: a lighting fixture, an air purifier, an air ionizer, an electrical appliance, a medical device, a medical device interface, a medical device holder, a medical device docking station, an oxygen concentrator, an oxygen tank, a sharps container, a label reader, a tag reader, dispenser, urn, vase and plant receptacle, and combinations thereof;
(b) a second functional device selected from at least one of the following: a motion detector, an electrical connection, a processor, a processor with software components, a processor with a display, an electrical component, a device with at least one communications component, a device with at least one data interface, a chemical agent holder and dispensing device, an electrical component timer, a controller, a collapsible device, and combinations thereof.

53. The support device system of claim 52 wherein at least one of the components of claim 52 also includes communications components selected from the group consisting of wire, wireless and combinations thereof wherein said wireless communications components are selected from the group consisting of at least a ZigBee network component, a Wi Fi network component, a two-way coded wireless communications network component, a one-way coded wireless communications network component, a mesh network component and a hybrid communications network component or component set.

54. The support device system of claim 52 wherein at least one of the components of claim 52 also includes wireless communications components selected from the group consisting of UWB, Bluetooth, RFID, infra-red and cellular.

55. The support device system of claim 52 wherein at least one of the components of claim 52 includes an additional component selected from the group consisting of a programmable software component, a wireless communications component, a wire communications component, a combination of wire and wireless communications components, and a power line-based communications component.

56. The system of claim 1 which further includes a support device system which comprises, in combination:
(a) a support device selected from at least one of the following: a fixture, enclosure, pedestal, base and mounting, and combinations thereof that at least partially is supporting a functional device selected from at least one of the following: a lighting fixture, an air purifier, an air ionizer, an electrical appliance, a medical device, a medical device interface or holder or docking station, an oxygen concentrator, an oxygen tank, a sharps container, a label reader, a tag reader, dispenser, urn, vase and plant receptacle, and combinations thereof;
(b) a second functional device selected from at least one of the following: a motion detector, an electrical connection, a processor, a processor with software components, a processor with a display, an electrical component, a device with at least one communications component, a device with at least one data interface, a chemical agent holder and dispensing device, an electrical component timer, a controller, a collapsible device, and combinations thereof.

57. The system of claim 1 that further includes at least one personal communicator selected from at least one of the following embodiments: a cell phone, a PDA, a smart phone, a remote control unit, a personal pendant, a personal computer, a wireless key, a smart card, a wearable item said as a piece of jewelry, ring, watch or pendant with a wireless data or coded communications means and a power means, and combinations thereof, wherein said personal communicator has at least one communications component that supports at least one of the following mediums: Bluetooth, infra-red, RFID, ZigBee, UWB, cellular network, Wi Fi, a mesh network, a one-way coded wireless, a two-way wireless coded communications apparatus, and combinations thereof.

58. The system of claim 2 that further includes at least one personal communicator selected from at least one of the following embodiments: a cell phone, a PDA, a smart phone, a remote control unit, a personal pendant, a personal computer, a wireless key, a smart card, a wearable item said as a piece of jewelry, ring, watch or pendant with a wireless data or coded communications means and a power means, and combinations thereof, wherein said personal communicator has at least one communications component that supports at least one of the following mediums: Bluetooth, infra-red, RFID, ZigBee, UWB, cellular, Wi Fi, a mesh network, a one-way coded wireless network, a two-way wireless coded wireless network, and combinations thereof.

59. The system of claim 3 that further includes at least one personal communicator selected from at least one of the following embodiments: a cell phone, a PDA, a smart phone, a remote control unit, a personal pendant, a personal computer, a wireless key, a smart card, a wearable item said as a piece of jewelry, ring, watch or pendant with a wireless data or coded communications means and a power means, and combinations thereof, wherein said personal communicator has at least one communications component that supports at least one of the following mediums: Bluetooth, infra-red, RFID, ZigBee, UWB, cellular, Wi Fi, a mesh network, a one-way coded wireless network, a two-way coded wireless network, and combinations thereof.

60. The support device system of claim 52 that further includes at least one personal communicator selected from at least one of the following embodiments: a cell phone, a PDA, a smart phone, a remote control unit, a personal pendant, a personal computer, a wireless key, a smart card, a wearable item said as a piece of jewelry, ring, watch or pendant with a wireless data or coded communications means and a power means, and combinations thereof, wherein said personal communicator has at least one communications component that supports at least one of the following mediums: Bluetooth, infra-red, RFID, ZigBee, UWB, cellular, Wi Fi, a mesh network, a one-way coded wireless network, a two-way coded wireless network, and combinations thereof.

61. A storage apparatus system which comprises:
(a) a storage apparatus; and
(b) a communication means connected to said storage apparatus that interacts with at least a wireless communications or remote control device, said communication means connected to a processor that controls a mechanized or non-mechanized apparatus to support a moving component assembly, and said communications means having at least one communication component selected from the group consisting of; a communications transceiver; a communications transmitter; a communications receiver; a visual confirmation or alert component; an audio confirmation or alert component; a processor; and an IR component.

62. The system of claim 61 wherein said at least one communications component is at least one of the following: a ZigBee network component, a Wi Fi network component, a two-way coded wireless communications network component, a one-way coded wireless communications network component, a mesh network communications component, a proprietary wireless controls communications network communications component, a hybrid communications network component, and a network component supporting combinations thereof.

63. The system of claim 61 wherein at least one communications component is selected from the group consisting of UWB, Bluetooth, RFID, infra-red and cellular.

64. The system of claim 61 wherein at least one of the components of claim 61 includes a component selected from the group consisting of a programmable software component, a wireless communications component, a wire communications component, a combination of wire and wireless communications components, and a power line-based communications component.

65. The system of claim 1 which further includes a storage apparatus system which comprises:
(a) a storage apparatus; and
(b) a communication means connected to said storage apparatus that interacts with at least a wireless communications or remote control device, said communication means connected to a processor that controls a mechanized or non-mechanized apparatus to support a moving component assembly, and said communications means having at least one communication component selected from the group consisting of; a communications transceiver; a communications transmitter; a communications receiver; a visual confirmation or alert component; an audio confirmation or alert component; a processor; and an IR component.

66. A wireless monitoring and intervention system, comprising:
(a) at least one biosensor; and
(b) a ZigBee biosensor transmitter functionally to said at least one biosensor, wherein said transmitter is connected to said biosensor wherein said connection is selected from the group consisting of a circuit connection, a wire connection, and a wireless connection, wherein said transmitter includes sufficient hardware, software and power means adapted to receive at least one detected health condition of a user and its associated corresponding health condition reading, wherein said reading is converted by said ZigBee biosensor transmitter to a ZigBee packet that at least includes said biosensor reading and information associated with identifying said biosensor transmitter, and said packet is transmitted by said transmitter;
(c) at least one ZigBee receiver adapted to and in receiving proximity to receive said ZigBee biosensor packet, wherein said receiver receives and converts said packet to provide information for an action selected from the group consisting of creation of a report, generation of an alert, administration or release of medication, a device function activation, a generation of a device communication, and combinations thereof, wherein said action includes a medium selected from the group consisting of readable, audible, displayable, printable, data transportable output(s) and processing input(s) that include(s) at least said health condition of the user detected by said biosensor.

67. The system of claim 66 wherein said at least one biosensor and biosensor transmitter(s) are comprised in a configuration selected from the group consisting of: said biosensor and biosensor transmitter(s) adapted to function in at least one user's body to generate said health condition reading and transmission; and said biosensor and a coded wireless radio frequency transmitter adapted to function in at least one user's body to generate said health condition reading and transmission to a coded wireless radio frequency component that is located in functional proximity to said coded wireless radio frequency transmitter wherein said component is connected to said ZigBee biosensor transmitter wherein said ZigBee biosensor transmitter is located outside of said at least one user's body.

68. The system of claim 66 wherein said at least one biosensor and biosensor transmitter(s) are adapted to function on and are adapted to be placed on materials selected from the group consisting of contact and wearable material(s) wherein said wearable material is in contact with said at least one user's body wherein said biosensor transmitter may be placed on said wearable material and be connected to said biosensor through at least one circuit connection that are adapted to generate said health condition reading and transmission.

69. The system of claim 68 wherein said wearable material is an absorbent article selected from at least one of the following embodiments: a diaper, undergarment, panty finer, training pants, bed pad, training pad, sanitary napkin, tampon, colostomy bag, undergarment pad, briefs, brief pad, interlabial apparatus, intralabial apparatus, incontinence pad, breast pad, bandage, bandage wrap, cast, sling, garment swab, and combinations thereof.

70. The system of claim 68 wherein said contact material is adapted to support at least one item selected from at least one of the following embodiments: a cotton swab, a garment swab, a bandage, a bandage wrap, a cast, a sling, an interlabial apparatus, an intralabial apparatus, and combinations thereof.

71. A wireless monitoring, alert and intervention system, comprising:
(a) an oxygen device selected from the group consisting of an oxygen tank and an oxygen concentrator; and, connected thereto,
(b) at least one ZigBee transmitter selected from the group consisting of a ZigBee oxygen tank transmitter and a ZigBee oxygen concentrator transmitter, wherein said transmitter is associated with a gauge detector adapted to detect at least one parameter relating to a condition, gas mix or level of said oxygen tank or concentrator and to generate a corresponding reading, wherein said reading is converted by said ZigBee transmitter to a ZigBee packet which includes at least said reading and information associated with identifying said transmitter, and said packet is transmitted by said transmitter;
(c) at least one ZigBee receiver adapted and in proximity to receive said ZigBee packet, wherein said receiver receives and converts said packet to provide information for at least one action selected from the group consisting of creation of a report, generation of an alert, administration and adjustment of at least one of said tank and concentrator, a device function activation, a generation of a device communication, a reorder, and combinations thereof, wherein said action includes a medium selected from the group consisting of readable, audible, displayable, printable, data transportable output(s) and processing input(s) that include(s) at least data associated with said reading.

72. A wireless monitoring, alert and intervention system, comprising:
(a) a medical device selected from the at least one of the following embodiments: a blood analyte sensor, a fingertip analyte sensor, a urine analyte sensor, a biometric sensor, a sharp container, a medication dispenser meter, a scale sensor, and combinations thereof;
(b) at least one ZigBee transmitter connected to said medical device, wherein said transmitter is associated with said medical device and is adapted to detect at least one parameter relating to a condition of said medical device to generate a corresponding reading, wherein said reading is converted by said ZigBee transmitter to a ZigBee packet which includes at least said condition and information associated with identifying said transmitter and said packet is transmitted by said transmitter;
(c) at least one ZigBee receiver adapted and in proximity to receive said ZigBee packet, wherein said receiver receives and converts said packet to provide information for an action selected from the group consisting of creation of a report, generation of an alert, administration or release of medication, a device function activation, a generation of a device communication, and combinations thereof, wherein said action includes a medium selected from the group consisting of readable, audible, displayable, printable, data transportable output(s) and processing input(s) that include(s) at least data associated with said condition.

73. The system selected from the group consisting of the system of claim 66 wherein said system is a component of a medical and health care monitoring, alert and intervention system which comprises:
at least one apparatus having:
(a) at least one input means for receiving at least one of a reporting communication and an exception communication from at least one other apparatus;
(b) at least one output means for transmitting at least one communication associated with said at least one of a reporting communication and an exception communication where said transmission is selected from the group consisting of at least one of the following: audible, visual, vibratory, wireless data, and wire data; and,
(c) at least one processor functionally connected to said at least one input means and said at least one output means, said at least one processor having sufficient components, hardware and software for supporting at least one wireless communications interface associated with at least one of the following mediums: Wi Fi, ultra wideband (UWB), ZigBee, Blue Tooth, mesh networks, cellular, one-way wireless coded communications, two-way wireless coded communications, proprietary wireless network protocols and systems, and combinations thereof, wherein said at least one processor further having sufficient components, hardware and software to provide at least one function selected from the group consisting of tracking patient progress, creating a reminder alert, monitoring medication dosage, presenting information inquiry for response, and alert receipt and alert transmission.

74. The system of claim 73 wherein said at least one processor further has sufficient components, hardware and software to provide at least one function selected from the group consisting of notification, ordering, device programming and administration, device control, intervention, or non-medical functions that support user well being.

75. The system of claim 73 that which further includes an ancillary electronic device selected from the group consisting of a lighting fixture, an appliance, an entertainment system component, an alarm, and a speaker, and wherein at least a portion of the components of said system that are set forth in claim 73 are located within said ancillary electronic device.

76. The system of claim 75 wherein said ancillary electronic device includes wireless communications components selected from the group consisting of wire, wireless and combinations thereof wherein said wireless communications components are selected from the group consisting of at least a ZigBee network component, a Wi Fi network component, a mesh network component, a two-way coded wireless communications network component, and a one-way coded wireless communications network component.

77. An environmental monitoring and alert system comprising:
(a) at least one transmitter selected from the group consisting of an environmental sensor transmitter and an environmental system circuit transmitter, wherein said transmitter is connected to a detector adapted to detect at least one type of environmental element and generate a corresponding signal, where said signal is converted and appended by said transmitter to create at least one data packet which contains, at minimum, information being selected from the group consisting of the identification of said environmental element, the location or address of said detecting sensor, the location or address of said sensor transmitter, and combinations thereof, which data pack is transmitted by said transmitter;
(b) a receiver adapted to and in functional proximity to receive said signal, wherein said receiver receives and converts said data packet;
(c) a processor in communication with said signal receiver for processing, wherein said receiver receives and converts said signal to provide information for an action selected from the group consisting of creation of a report, generation of an alert, administration of said system, a device function activation, a generation of a device communication, and combinations thereof, wherein said action includes a medium selected from the group consisting of readable, audible, displayable, printable, data transportable output(s) and processing input(s) that include(s) at least said environmental element detected by said sensor; and
(d) a system embodiment selected from the group consisting of an embodiment of claim 29, claim 30, claim 31, and claim 32.

78. The system of claim 77 wherein said transmitter and receiver components are selected from the group consisting of ZigBee network components, mesh network components, one-way coded wireless communications components, two-way coded wireless communications components, and wire communications components.

79. The system of claim 77 wherein said system further includes a receiving device and said receiver is connected to said device to signal to said device and said device is selected from the group consisting of a fire extinguisher, an escape ladder, a guide light, a guide light strip, and an emergency medical kit.

80. The system of claim 77 wherein said system further includes a receiving device and said receiver is connected to said device to signal to said device and said device is selected from the group consisting of a mounting component, an enclosure component, a fastening component, an adhesive component, and a first aid kit.

81. The system of claim 77 wherein said system further includes a receiving device and said receiver is connected to said device to signal to said device and said device is selected from the group consisting of a product package, a product bottle, a bottle cap, a medical device, a medication aid device, a medication compliance device, and a medication scale device.

82. The system of claim 77 wherein said environmental sensor is selected from the group consisting of a sensor with means for detecting, at least, elements and, preferably, levels of said elements, wherein said elements are associated with, at least, smoke, carbon monoxide, natural gas, propane, other toxic gases, and ambient temperature.

83. The system of claim 77 wherein said environmental sensor is in at least one of the following embodiments: a motion detector, heat sensor, electrical contacts, membrane contacts, vibration detector, diagnostics sensor, video surveillance, video scanning and image processing, and combinations thereof.

84. The system of claim 77 wherein one of said transmitter and said receiver is included in a personal communicator selected from at least one of the following embodiments: a cell phone, a PDA, a smart phone, a remote control unit, a personal pendant, a personal computer, a wireless key, a smart card, a wearable item said as a piece of jewelry, ring, watch or pendant with a wireless data or coded communications means and a power means, and combinations thereof, wherein said personal communicator has at least one communications component that supports at least one of the following mediums: Bluetooth, infra-red, RFID, ZigBee, UWB, cellular network, Wi Fi, a mesh network, a one-way coded wireless, a two-way wireless coded communications apparatus, and combinations thereof.

85. A programmable timer device, comprising:
(a) a timing unit having a timer processor, timer program and memory;
(b) at least one input means;
(c) at least one sending device selected from the group consisting of a transceiver and a transmitter, for transmitting at least one coded communication wherein said transmission is generated by the execution of said timing unit and wherein said communication comprises at least a receiver or transceiver address that is associated with an apparatus or apparatus program that is designated to be activated, controlled, adjusted or altered to at least one setting or position through coded communications transmissions on at least one designated time by said timer program.

86. The programmable timer device of claim 85 wherein said program and memory comprise a plurality of distinct addresses where said addresses are associated with devices that are designated to be activated, controlled, adjusted or altered to at least one setting or position through coded communications transmissions on at least one designated time by said timer program.

87. The programmable timer device of claim 85 wherein said program and memory include at least one feature wherein said feature is selected from the group consisting of a random on and off command transmission, a seasonal transmission activation that utilizes a clock and calendar function program wherein said transmissions are generated at designated times to account for seasonal daylight variances, and combinations thereof.

88. The programmable timer device of claim 85 wherein said device further includes a support device and said timer unit is at least partially contained within said support device, and said support device is selected from at least one of the following embodiments: a personal computer, a networked appliance, a networked appliance with a display, a router, a router adapted with a display, a server, a network controller, a lamp, a television, a refrigerator, and combinations thereof.

89. The programmable timer device of claim 85 wherein said device further includes a support device and said timer unit is at least partially contained within said support device, and said support device is selected from the group consisting of a multi-device controller, a browser, a display, a standalone apparatus with at least one administration and administration interface means, and combinations thereof.

90. The programmable timer device of claim 89 wherein said browser device further includes a support function selected from the group consisting of an accessible Wide Area Network, a Local Area Network, a Home Area Network, and a combination thereof, wherein said support function includes an internet protocol (IP) address for timer program and settings administration and at least one administration interface that is selected from the group consisting of an Ethernet or Ethernet compatible connector which may at least connect to a router or access point, a USB chipset and socket, at least one input button on said device, a touchscreen display, and a combination thereof.

91. The programmable timer device of claim 85 wherein said device further includes a controller with a mode program wherein the activation, alteration, adjustment or control of a designated device is performed under a program feature wherein said feature is a mode condition, mode sequence, mode range or mode formula based on at least one of the following measures: second, minute, hour, day, date, week, month, year, and at least one pre-defined trigger condition.

92. The programmable timer device of claim 91 wherein said feature is a mode alert, mode condition, mode sequence, mode range or mode formula where said mode program is generated upon the timer or timer and device controller embodiment's receipt of a mode command wherein said command is a security or medical or environmental or safety or entertainment mode command and said program executes a series of outputs to support action(s) associated with the condition related to said mode command receipt.

93. The programmable timer device of claim 92 wherein said security or medical or environmental or safety or entertainment mode activation may comprise at least one or more different transmissions wherein said transmission destination device address and transmission content varies from a non-security or non-medical or non-environmental mode or non-safety or non-entertainment transmission.

94. The programmable timer device of claim 85 wherein said system operates to control, activate, alter, adjust or interact with at least one of the following: lights, light switches, electrical outlets, electrical switches, appliances, coffee makers, outdoor lighting, sprinkler systems, automobile systems, heating and air conditioning controls or systems, weather instruments, curtain settings, Jacuzzis, hot tubs, saunas, electronic entertainment components, systems or settings, a robotic apparatus or system, and combinations thereof.

95. The programmable timer device being selected from the group consisting of claim 85, claim 86, claim 87, claim 88, and claim 89 wherein said device utilizes at least one communications network being selected from the group consisting of a wireless network, ZigBee, a mesh network, a wire network, and combinations thereof.

96. The programmable timer device being selected from the group consisting of claim 90, claim 91, claim 92, claim 93, and claim 94 wherein said device utilizes at least one communications network being selected from the group consisting of a wireless network, ZigBee, a mesh network, a wire network, and combinations thereof.

97. An electrical assembly and enclosure system, comprising:
(a) at least one electrical outlet plug and housing that is one side of its outer portion which is connected to a main electrical circuit on its inner portion wherein said circuit terminates into a switch or junction and a wireless coded communications processor interface;
(b) at least one electrical plug receptacle on at least one side of its outer housing wherein said receptacle comprises an electrical contact plate;
(c) an inner electrical circuit connected to the at least one receptacle electrical contact plate and the electrical circuit switch;
(d) a wireless communications transceiver and processor with memory and a software program that controls said circuit switch or junction, wherein upon the receipt of a communications transmission that contains a designated address for said transceiver, said transceiver sends an acknowledgement upon the receipt of said wireless transmission to the originating transmitter or transceiver address of said transmission, and processes said command associated with said transmission wherein said command is associated with at least the control of said electrical circuit switch or junction.

98. The system of claim 97 wherein said electrical assembly and enclosure system is selected from the group consisting of a plug-in wall outlet plug receptacle assembly and housing, an extension cord, an appliance configuration plug receptacle receptacle assembly and housing, a plug-in wall outlet plug receptacle assembly and housing adapted with a two plug electrical outlet termination, and an extension cord adapted with a two plug electrical outlet termination.

99. The system of claim 97 which includes a timer apparatus selected from the group consisting of a timer apparatus inclusive in the housing and assembly and a timer apparatus that is external to said housing and assembly wherein said timer apparatus controls said electrical circuit switch and a wireless communications processor, program and memory configuration.

100. The system of claim 97 which includes an additional inner electrical circuit wherein said circuit connects to said electrical circuit switch and an electrically powered apparatus that is integrated with and an extension of said assembly and housing.

101. The system of claim 100 which includes at least one apparatus selected from the group consisting of night lights, electric air fresheners, ambient sensors, ambient processors, and air ionizers.

102. The system of claim 100 which includes at least one apparatus selected from the group consisting of RFID readers, energy meters, LED lights, LED processors, and speaker and associated audio chipsets and components.

103. The system of claim 97 which includes a multiple plug receptacle housing and assembly that includes the following: at least an outer portion electrical outlet plug which is connected to an inner portion main electrical circuit where said circuit terminates into a main electrical circuit switch or junction and a wireless coded communications processor interface; at least one outer portion electrical plug receptacle which is connected to inner portion receptacle electrical contact plates; at least two inner electrical circuits where each circuit is connected to a respective plug receptacle electrical plate or an outer portion apparatus housing and assembly where each circuit receives contact from a main receptacle circuit upon the activation of a main electrical circuit switch being open and where said main receptacle circuit connects with said main switch and each inner associated receptacle electrical circuit; a wireless communications transceiver and processor with memory and a software program that controls said circuit switch or junction, where upon the receipt of a communications transmission that contains a designated address for said transceiver, said transceiver sends an acknowledgement upon the receipt of said wireless transmission to the originating transmitter or transceiver address of said transmission, and processes said command associated with said transmission where said command is associated with at least the control of said electrical circuit switch or junction.

104. The system of claim 97 which includes a multiple plug receptacle housing and assembly that may comprise the following: at least an outer portion electrical outlet plug which is connected to an inner portion main electrical circuit where said circuit terminates into a main electrical circuit switch or junction and a wireless coded communications processor interface; at least one outer portion electrical plug receptacle which is connected to inner portion receptacle electrical contact plates; at least two inner electrical circuits where each circuit is connected to a respective plug receptacle electrical plate or an outer portion apparatus housing and assembly where each circuit receives contact from a main receptacle circuit upon the activation of a respective receptacle circuit switch being open, where each receptacle inner electrical circuit is connected to a respective receptacle circuit switch and each receptacle circuit switch is connected to a wireless coded communications processor interface, and also upon the activation of a main electrical circuit switch being open and wherein said main receptacle circuit connects with said main electrical switch; a wireless communications transceiver and processor with memory and a software program that controls said circuit switches or junctions through said interfaces, where upon the receipt of a communications transmission that contains a designated address for said transceiver and a data content packet of an associated address for a respective interface lead for a respective circuit switch, said transceiver sends an acknowledgement upon the receipt of said wireless transmission to the originating transmitter or transceiver address of said transmission, and processes said command associated with said transmission wherein said command is associated with at least the control of said electrical circuit switch or junction.

105. The system of claim 104 wherein said electrical assembly and enclosure system is selected from the group consisting of a plug-in wall outlet plug receptacle assembly and housing, an extension cord, an appliance configuration plug receptacle receptacle assembly and housing, a plug-in wall outlet plug receptacle assembly and housing adapted with a two plug electrical outlet termination, and an extension cord adapted with a two plug electrical outlet termination.

106. The system of claim 104 which includes a timer apparatus selected from the group consisting of a timer apparatus inclusive in the housing and assembly and a timer apparatus that is external to said housing and assembly wherein said timer apparatus controls said electrical circuit switch and a wireless communications processor, program and memory configuration.

107. The system of claim 104 which includes an inner electrical circuit wherein said circuit connects to said electrical circuit switch and an electrically powered apparatus that is integrated with and an extension of said assembly and housing.

108. The system of claim 107 which includes at least one apparatus selected from the group consisting of night lights, electric air fresheners, ambient sensors, ambient processors, and air ionizers.

109. The system of claim 107 which includes at least one apparatus selected from the group consisting of RFID readers, energy meters, LED lights and associated components, rechargeable batteries, and speakers and associated audio chipsets and components.

110. A portable light bulb receptacle and socket enclosure, comprising:
(a) an outer portion standard-sized grooved bulb socket and electrical contact, fitting and housing that comprises heat dissipating elements; said socket and electrical contact and fitting being connected to an inner portion main electrical circuit where said circuit terminates into a switch or junction; said housing comprises a bulb socket receptacle wherein said receptacle with a contact to said electrical switch circuit;
(b) an inner electrical circuit connected to the at least one receptacle contact and the circuit switch or junction;
(c) a wireless communications transceiver and processor with memory and a software program that controls said circuit switch or junction, wherein upon the receipt of a communications transmission that contains a designated address for said transceiver, said transceiver sends an acknowledgement upon the receipt of said wireless transmission to the originating transmitter or transceiver address of said transmission, and processes said command associated with said transmission where said command is associated with the control of said electrical circuit switch or junction wherein said control comprises, at least, the opening and closing of said circuit switch.

111. The portable light bulb receptacle and socket enclosure of claim 110 wherein the transmissions are selected from the group consisting of wireless, ZigBee, mesh network, Zensys, and proprietary wireless control network communications.

112. The system of claim 1 which further includes an information device consisting of at least one sensor, a communications processor and a program means for receiving at least one coded communication where said coded communication is at least a request to activate a program that captures at least one sensor reading and transmits said at least one sensor reading to at least one pre-designated address.

113. The system of claim 112 that includes a program means to generate a coded transmission associated with at least one condition wherein said condition is selected from the group consisting of at least one out-of-range sensor reading, a time interval-based sensor reading, a remotely transmitted system reading request, a time-set sensor reading, and a device to device sensor reading request wherein said transmission accounts for said information, the originating sensor address, the originating transmitter address and the device address or addresses designated to receive said information.

114. The system of claim 113 wherein said information device is selected from the group consisting of a weather instrument, an environmental sensor apparatus, a heating and air conditioning controls apparatus, an electricity meter apparatus, and a water level gauge.

115. The system of claim 113 wherein said information device is selected from the group consisting of a weather instrument, an environmental sensor apparatus, a heating and air conditioning controls apparatus, an electricity meter apparatus, and a water level gauge.

116. The system of claim 1 that includes a program means to generate a coded communications transmission when at least one trigger condition occurs wherein said transmission accounts for said trigger condition information and at least one device address designated to receive said information.

117. The system of claim 116 wherein said system includes an apparatus component being selected from the group consisting of an answering machine, a telephone caller identification device, a RSS reader software program, an electronic mail reader software program, and an instant messaging reader software program and at least one said trigger condition corresponding to said apparatus component that is selected from the group consisting of at least one message left on said answering machine, a telephone number associated with an incoming telephone call, at least one word or character string associated with at least one RSS data feed, at least one word or character string associated with at least one electronic mail message, and at least word or character string associated with at least one instant message.

118. The system of claim 117 wherein said apparatus component is in communication with devices being selected from the group consisting of said main device, a cell phone, a PDA, a personal communicator, and a remote control unit.

119. The system of claim 117 wherein said apparatus component is in communication with devices being selected from the group consisting of at least one web server, a server, a timer device, a television, and an electronic entertainment system component.

120. The system of claim 94 which includes a remote control functionally connected to said system for controlling at least one function thereof wherein said remote control is communicated over a network that is selected from the group consisting of a wireless network, a wire network, a wide area network (WAN), a local area network, and combinations thereof wherein said wireless network is selected from the group consisting of a one-way coded communications network, a two-way coded communications network, a ZigBee network, a mesh network, and combinations thereof.

121. The system of claim 97 which includes a remote control functionally connected to said system for controlling at least one function thereof wherein said remote control is communicated over a network that is selected from the group consisting of a wireless network, a wire network, a wide area network (WAN), a local area network, and combinations thereof wherein said wireless network is selected from the group consisting of a one-way coded communications network, a two-way coded communications network, a ZigBee network, a mesh network, and combinations thereof.

122. The system of claim 104 which includes a remote control functionally connected to said system for controlling at least one function thereof wherein said remote control is communicated over a network that is selected from the group consisting of a wireless network, a wire network, a wide area network (WAN), a local area network, and combinations thereof wherein said wireless network is selected from the group consisting of a one-way coded communications network, a two-way coded communications network, a ZigBee network, a mesh network, and combinations thereof.

123. The system of claim 110 which includes a remote control functionally connected to said system for controlling at least one function thereof wherein said remote control is communicated over a network that is selected from the group consisting of a wireless network, a wire network, a wide area network (WAN), a local area network, and combinations thereof wherein said wireless network is selected from the group consisting of a one-way coded communications network, a two-way coded communications network, a ZigBee network, a mesh network, and combinations thereof.

124. The system of claim 120 wherein said remote control operates to control, activate, alter, adjust or interact with at least one of the following: lights, light switches, electrical outlets, electrical switches, appliances, coffee makers, outdoor lighting, sprinkler systems, automobile systems, heating and air conditioning controls or systems, weather instruments, curtain settings, Jacuzzis, hot tubs, saunas, electronic entertainment components, settings or systems, a robotic apparatus or systems, and combinations thereof.

125. The system of claim 121 wherein said remote control operates to control, activate, alter, adjust or interact with at least one of the following: lights, light switches, electrical outlets, electrical switches, appliances, coffee makers, outdoor lighting, sprinkler systems, automobile systems, heating and air conditioning controls or systems, weather instruments, curtain settings, Jacuzzis, hot tubs, saunas, electronic entertainment components, settings or systems, a robotic apparatus or systems, and combinations thereof.

126. The system of claim 122 wherein said remote control operates to control, activate, alter, adjust or interact with at least one of the following: lights, light switches, electrical outlets, electrical switches, appliances, coffee makers, outdoor lighting, sprinkler systems, automobile systems, heating and air conditioning controls or systems, weather instruments, curtain settings, Jacuzzis, hot tubs, saunas, electronic entertainment components, settings or systems, a robotic apparatus or systems, and combinations thereof.

127. The system of claim 123 wherein said remote control operates to control, activate, alter, adjust or interact with at least one of the following: lights, light switches, electrical outlets, electrical switches, appliances, coffee makers, outdoor lighting, sprinkler systems, automobile systems, heating and air conditioning controls or systems, weather instruments, curtain settings, Jacuzzis, hot tubs, saunas, electronic entertainment components or systems, a robotic apparatus or system, and combinations thereof.

128. The system of claim 1 wherein said system includes at least one server that supports at least one web site that comprises information and software associated with at least the communications and interactive content of at least one component of said system, and of said at least one web site.

129. The system of claim 2 wherein said system includes at least one server that supports at least one web site that comprises information and software associated with the communications and interactive content of at least one component of said system, and of said at least one web site,
said web site being adapted to display information, wherein said information is adapted in different content and presentation means for at least one or more types of users or constituents.

130. The system of claim 3 wherein said system includes at least one server that supports at least one web site that comprises information and software associated with the communications and interactive content of at least one component of said system, and of said at least one web site,
said at least one web site being adapted to display information, wherein said information is adapted in different content and presentation means for at least one or more types of users or constituents.

131. The system of claim 130 wherein said information may at least comprise a digital patient record.

132. The system of claim 1 wherein said system includes at least one server that supports a web site that comprises information associated with the communications and interaction content of at least one component of said system, and said web site, wherein said web site supports at least one of the following mediums or services: advertising, marketing, games, information services and combinations thereof.

133. The system of claim 132 wherein said advertising mediums are selected from the group consisting of banners, pop-ups, messaging, search engine services, and electronic mail coupons.

134. The system of claim 132 wherein said marketing mediums are selected from the group consisting of direct mail coupons, interactive and direct mail questionnaires, electronic and direct mail messaging; ordering and reordering services, and coupons.

135. The system of claim 132 wherein said mediums or services relate to information selected from the group consisting of drug, demographic, household, dwelling and facility information.

136. The system of claim 135 wherein said dwelling and facility information includes at least one of the following: a dwelling and facility software blueprint; a dwelling and facility summary; and combinations thereof, wherein said information includes at least one of the following: room types and quantities; room dimensions; room locations; entry and access ways; windows; sensor types, addresses and locations; activated sensors; occupant information; and combinations thereof, .

137. The system of claim 132 wherein said mediums or services require financial support provided by at least one of the following: users; user constituents; advertising industry entities; charitable organizations; non-profit organizations; government entities; municipal entities; insurance industry entities; pharmaceutical industry industries; health services industry entities; assisted living industry entities; medical device industry entities; information technology industry entities; academic entities; research entities; telecommunications industry entities; media industry entities; digital media industry entities; and combinations thereof.

138. The system of claim 1 wherein said at least one wireless interface is selected from the group consisting of Wi Fi, ultra wideband (UWB), ZigBee, Blue Tooth, and mesh networks.

139. The system of claim 1 wherein said at least one wireless interface is further selected from the group consisting of one-way coded wireless communications, two-way wireless coded communications, paging networks, messaging networks, and combinations thereof.

140. The system of claim 3 wherein said medical device is selected from the group consisting of at least one of the following: implantable medical devices, subcutaneous medical devices, external medical devices, medical monitoring devices, and oxygen devices.

141. The system of claim 3 wherein said medical device is selected from the group consisting of at least one of the following: medical devices comprised of electro-active polymers, valvular prosthesis, dialysis devices, pacemakers, and stents.

142. The system of claim 3 wherein said medication device is selected from the group consisting of at least one of the following: medication aid devices, medication compliance devices, medication containers, medication devices comprising at least one scale, and sharps containers.

143. The system of claim 3 wherein said medication device is selected from the group consisting of at least one of the following: medication dispensers, medicine container tops that are adapted with networked components, medicine container tops that are adapted with networked and user interactive components, medicine packaging that is adapted with networked components, and medicine packaging that is adapted with networked and interactive components.

144. The system of claim 4 wherein said medical device is selected from the group consisting of at least one of the following: implantable medical devices, subcutaneous medical devices, external medical devices, medical monitoring devices, and oxygen devices.

145. The system of claim 4 wherein said medical device is selected from the group consisting of at least one of the following: medical devices comprised of electro-active polymers, valvular prosthesis, dialysis devices, pacemakers, and stents.

146. The system of claim 4 wherein said medication device is selected from the group consisting of at least one of the following: medication aid devices, medication compliance devices, medication containers, medication devices comprising at least one scale, and sharps containers.

147. The system of claim 4 wherein said medication device is selected from the group consisting of at least one of the following: medication dispensers, medicine container tops that are adapted with networked components, medicine container tops that are adapted with networked and user interactive components, medicine packaging that is adapted with networked components, and medicine packaging that is adapted with networked and interactive components.

148. The system selected from the group consisting of the system of claim 71 wherein said system is a component of a medical and health care monitoring, alert and intervention system which comprises:
at least one apparatus having:
(a) at least one input means for receiving at least one of a reporting communication and an exception communication from at least one other apparatus;
(b) at least one output means for transmitting at least one communication associated with said at least one of a reporting communication and an exception communication where said transmission is selected from the group consisting of at least one of the following: audible, visual, vibratory, wireless data, and wire data; and,
(c) at least one processor functionally connected to said at least one input means and said at least one output means, said at least one processor having sufficient components, hardware and software for supporting at least one wireless communications interface associated with at least one of the following mediums: Wi Fi, ultra wideband (UWB), ZigBee, Blue Tooth, mesh networks, cellular, one-way wireless coded communications, two-way wireless coded communications, proprietary wireless network protocols and systems, and combinations thereof, wherein said at least one processor further having sufficient components, hardware and software to provide at least one function selected from the group consisting of tracking patient progress, creating a reminder alert, monitoring medication dosage, presenting information inquiry for response, and alert receipt and alert transmission.

149. The system of claim 148 wherein said at least one processor further has sufficient components, hardware and software to provide at least one function selected from the group consisting of notification, ordering, device programming and administration, device control, intervention, or non-medical functions that support user well being.

150. The system of claim 148 that which further includes an ancillary electronic device selected from the group consisting of a lighting fixture, an appliance, an entertainment system component, an alarm, and a speaker, and wherein at least a portion of the components of said system that are set forth in claim 73 are located within said ancillary electronic device.

151. The system of claim 150 wherein said ancillary electronic device includes wireless communications components selected from the group consisting of wire, wireless and combinations thereof wherein said wireless communications components are selected from the group consisting of at least a ZigBee network component, a Wi Fi network component, a mesh network component, a two-way coded wireless communications network component, and a one-way coded wireless communications network component.

152. The system selected from the group consisting of the system of claim 72 wherein said system is a component of a medical and health care monitoring, alert and intervention system which comprises:
at least one apparatus having:
(a) at least one input means for receiving at least one of a reporting communication and an exception communication from at least one other apparatus;
(b) at least one output means for transmitting at least one communication associated with said at least one of a reporting communication and an exception communication where said transmission is selected from the group consisting of at least one of the following: audible, visual, vibratory, wireless data, and wire data; and,
(c) at least one processor functionally connected to said at least one input means and said at least one output means, said at least one processor having sufficient components, hardware and software for supporting at least one wireless communications interface associated with at least one of the following mediums: Wi Fi, ultra wideband (UWB), ZigBee, Blue Tooth, mesh networks, cellular, one-way wireless coded communications, two-way wireless coded communications, proprietary wireless network protocols and systems, and combinations thereof, wherein said at least one processor further having sufficient components, hardware and software to provide at least one function selected from the group consisting of tracking patient progress, creating a reminder alert, monitoring medication dosage, presenting information inquiry for response, and alert receipt and alert transmission.

153. The system of claim 152 wherein said at least one processor further has sufficient components, hardware and software to provide at least one function selected from the group consisting of notification, ordering, device programming and administration, device control, intervention, or non-medical functions that support user well being.

154. The system of claim 152 that which further includes an ancillary electronic device selected from the group consisting of a lighting fixture, an appliance, an entertainment system component, an alarm, and a speaker, and wherein at least a portion of the components of said system that are set forth in claim 73 are located within said ancillary electronic device.

155. The system of claim 154 wherein said ancillary electronic device includes wireless communications components selected from the group consisting of wire, wireless and combinations thereof wherein said wireless communications components are selected from the group consisting of at least a ZigBee network component, a Wi Fi network component, a mesh network component, a two-way coded wireless communications network component, and a one-way coded wireless communications network component.
